(19) United States
(12) Patent Application Publication
(10) Pub. No.: US 2012/0155349 A1
(43) Pub. Date: Jun. 21, 2012

(54) RFID APPLICATIONS

(76) Inventors: Zeljko BAJIC, San Jose, CA (US); Nikola Cargonja, San Carlos, CA (US); Albert Nardelli, Mountain View, CA (US); Joseph S.M. Ho, Sunnyvale, CA (US); Ryad Semichi, Menlo Park, CA (US)

(21) Appl. No.: 13/297,094

(22) Filed: Nov. 15, 2011

Related U.S. Application Data
(60) Provisional application No. 61/414,095, filed on Nov. 16, 2010.
(60) Provisional application No. 61/483,260, filed on May 6, 2011.

(51) Int. Cl. H04W 84/12; H04W 52/02

(52) U.S. Cl. 370/311; 370/310; 370/338

(57) ABSTRACT

An RFID device is disclosed. The RFID device can include a transceiver; and a processor coupled to the transceiver. The processor can operate a Physical (PHY) layer with the transceiver, a Media Access Control (MAC) layer over the PHY layer, and an RFID application layer over the MAC layer. The MAC layer and the PHY layer can operate according to a non-RFID wireless protocol.

### RELATED APPLICATIONS

The present disclosure claims priority to U.S. Provisional Application 61/414,095, entitled “Next Generation RFID”, filed on Nov. 16, 2010, and to U.S. Provisional Application 61/483,260, entitled “ISO18000-7 Application Layer over IEEE802.15.4 MAC/PHY”, filed on May 6, 2011, both of which are herein incorporated by reference in their entireties.

### BACKGROUND

1. Field of the Invention

Embodiments of the present invention are directed towards secured communications in RFID technologies.

2. Description of Related Art

Low-power wireless devices such as, for example, radio frequency (RF) tags have been in use for some time. Radio-frequency identification (RFID) systems typically include interrogators that communicate with tags. Tags are typically attached to an article such as a shipping container or a package that is being shipped. The interrogator, then, can inventory the articles that are within its range.

Generally, an RFID tag system will include a number of tags that are attached to an asset such as a piece of inventory or a shipping asset. RFID tags include a transceiver to transmit and receive signals as well as a processor to process incoming signals from an interrogator and provide responses to the interrogator. As such, an interrogator can poll the tags that are within its range. The interrogator, then, can monitor tags as they arrive or leave an area of interest. The interrogator periodically polls the tags within its range. Alternatively, tags can be monitored as they transit a particular area, for example by an interrogator device. The bandwidth of the interrogator and its range limits the number of tags that can be monitored by any given interrogator.

Tags have limited power sources. Active tags are typically powered by a battery, which may be depleted with frequent use. To solve this problem, tags can have active and inactive modes of operation (referred to as asleep or awake modes). Therefore, tags need to operate in a power efficient and power saving mode. Some current interrogator and tag systems conform to ISO 18000-7, referred to as Mode 1 tags. However, there is a limit to the capabilities of such a system to conserve power in the tags.

Therefore, what is needed is a communication system that utilizes the capabilities of the systems available.

### SUMMARY

In some embodiments, an RFID device includes a transceiver; and a processor coupled to the transceiver, the processor operating a Physical (PHY) layer with the transceiver, a Media Access Control (MAC) layer over the PHY layer, and an RFID application layer over the MAC layer, the MAC layer and the PHY layer operating according to a non-RFID wireless protocol.

A method of operating an RFID device includes generating an RFID application packet with an application header and an application payload consistent with an RFID standard; generating a MAC packet with a MAC header and a MAC payload, the MAC payload including the RFID application packet; generating a PHY packet with a PHY header and a PHY payload, the PHY payload including the MAC packet; and transmitting the PHY packet.

These and other embodiments of the present invention are further described below.

### FIGURES

FIG. 1A illustrates an RFID environment in which embodiments of the present invention may operate.

FIG. 1B illustrates a gateway device in communication with an RFID device.

FIGS. 1C and 1D illustrate example dialogs that occur between RFID devices.

FIG. 1E illustrates a global environment for RFID device environments such as that shown in FIG. 1A.

FIG. 2A illustrates a protocol stack according to some embodiments of the present invention.

FIG. 2B illustrates a reduced version of the protocol stack illustrated in FIG. 1.

FIG. 3A illustrates a device protocol stack according to some embodiments of the present invention.

FIG. 3B illustrates a device protocol stack according to some embodiments of the present invention.

FIG. 4 illustrates a split MAC layer utilized in a device protocol stack according to some embodiments of the present invention.

FIG. 5 illustrates a state machine for an RFID device working with the protocol stack illustrated in FIG. 1.

FIG. 6 illustrates a device protocol stack utilizing IEEE 802.15.4 or IEEE 802.11 MAC and PHY layers.

FIG. 7A illustrates a packet format that can be utilized in the protocol stack layers.

FIGS. 7B through 7E illustrate layered protocol formats in the packet format illustrated in FIG. 7A.

FIGS. 8A, 8B, and 8C illustrate a physical layer packet according to some embodiments of the present invention.

FIG. 9 illustrates a carrier sense multiple access (CSMA) process according to the ISO 18000-7 mode 2 standard.

FIG. 10 illustrates PN9 encoding according to the ISO 18000-7 mode 2 standard.

FIG. 11 illustrates Forward Error Correction (FEC) encoding according to the ISO 18000-7 mode 2 standard.

FIG. 12 illustrates a superframe structure according to some aspects of the ISO 18000-7 mode 2 standard.

FIG. 13 illustrates communications between a device and a gateway device or network coordinator in a beacon-enabled network according to some aspects of the ISO 18000-7 mode 2 standard.

FIG. 14 illustrates communications between a device and a gateway device or network coordinator in a non-beacon enabled network according to some aspects of the ISO 18000-7 mode-2 standard.

FIG. 15 illustrates data transfer from a coordinator in a beacon enabled network according to some aspects of the ISO 18000-7 mode-2 standard.

FIG. 16 illustrates data transfer from a coordinator in a non-beacon enabled network according to some aspects of the ISO 18000-7 mode-2 standard.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other element that, although not specifically described here, is within the scope and the spirit of this disclosure.

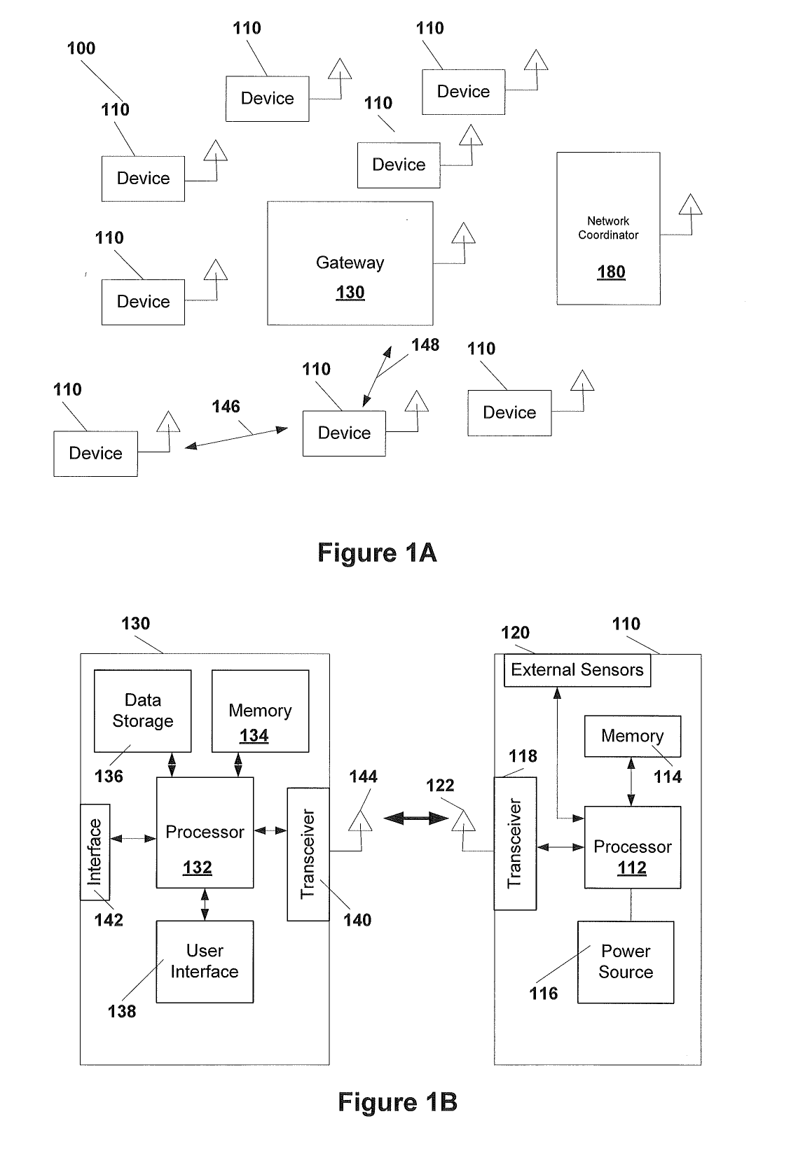

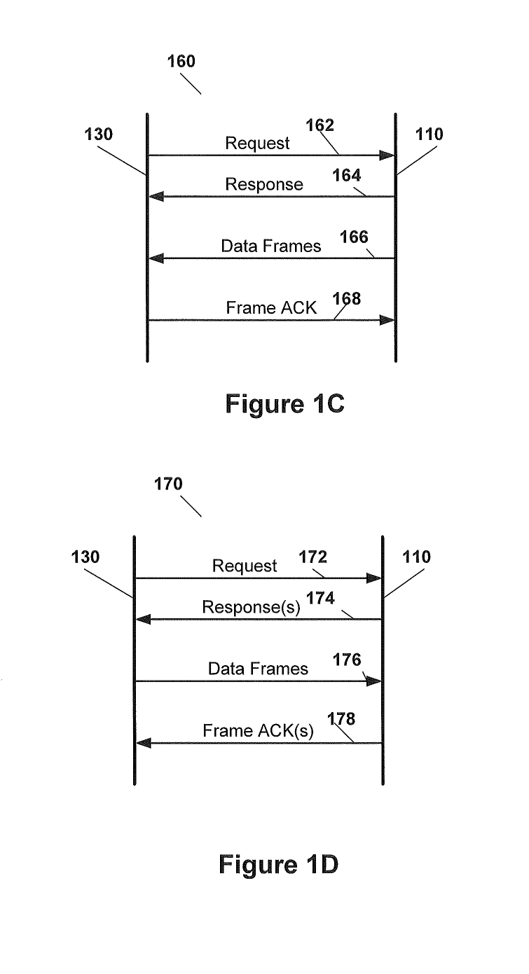

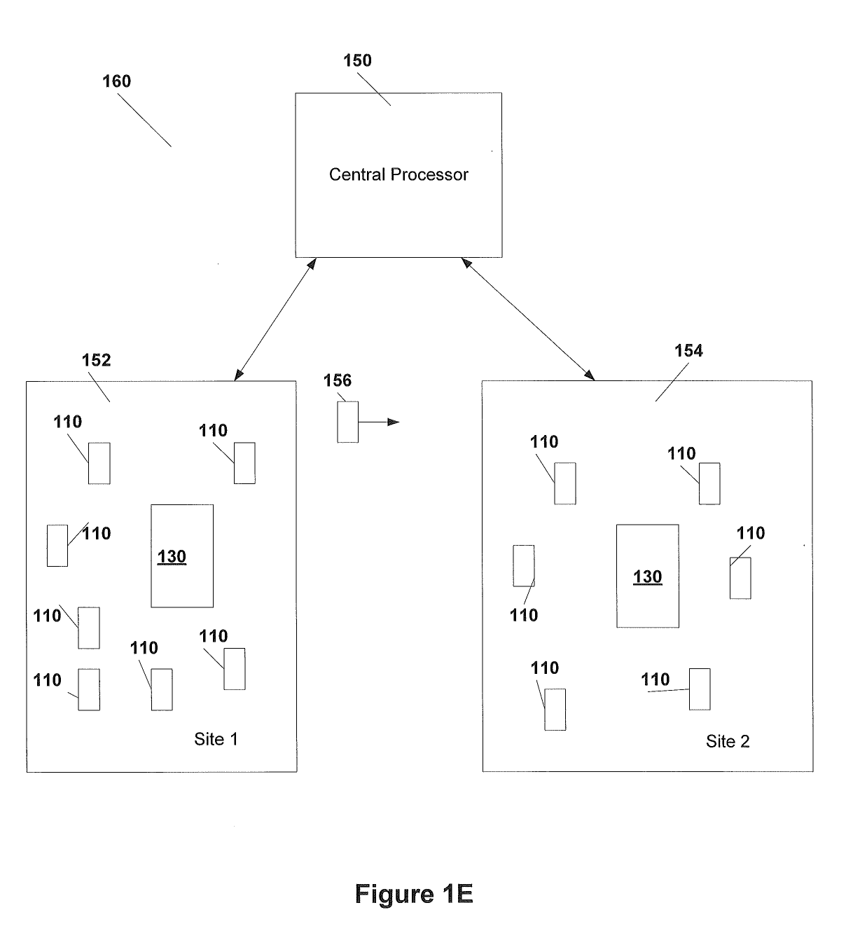

FIG. 1A illustrates an RFID network environment 100 in which some embodiments of the present invention can be utilized. In environment 100, one or more RFID devices 110 are within wireless communications range with a reader or gateway device 130. In some examples, some of RFID devices 110 may be outside the range of gateway device 130 and messages rely on multi-hop communications. Gateway device 130 may, in some embodiments, be one of RFID devices 110 operating in a gateway mode.

In accordance with some embodiments of the present invention, devices 110 are not generally classified as either tags or gateway devices. Instead, devices 110 either operate as an endpoint, a subcontroller, or a gateway. Additionally, devices 110 may switch between operation according to one of these modes of operation. Further, not all of devices 110 are capable of operating in each of the these modes. Other classifications are possible. Throughout this disclosure, devices 110 are alternatively referred to as devices and tags. Device 130 is alternatively referred to as a device, an interrogator, or a reader.

Endpoint operation is similar in behavior to a normal RFID tag. While operating as an endpoint device, device 110 spends most of its time in a low-power or sleep state. Once device 110 awakens (by receiving a wake-on event or triggered by internal sensor or triggered by internal timer), device 110 engages in a process of processing a request and usually accessing the communication channel through one of multiple channel access methods that are discussed in further detail below.

In Subcontroller mode, device 110 behaves halfway between an Endpoint mode and a Gateway mode. Devices 110 in the subcontroller mode open and maintain dialogs with devices in Endpoint mode or other devices 110 in subcontroller mode. Devices 110 that support subcontroller mode may also support Endpoint mode.

A device 110 in gateway mode behaves much like a typical implementation of a tag interrogator or reader. As such, in gateway mode tag 110 is always on, it is actively receiving, and it is generally connected to a wire-line power-supply. In some embodiments devices 110 in Gateway mode can connect to another type of network. Device 110 in gateway mode can also be optimized for lowest latency channel access and network arbitration.

Gateway device 130 performs queries of RFID devices 110 in order to, for example, inventory RFID devices 110, provide data to inventory RFID devices 110, receive other information from RFID devices 110, or otherwise communicate data with RFID devices 110. In many environments 100, RFID devices 110 are each attached to an item (not shown) and may carry information related to that item. For example, RFID devices 110 may be attached to a shipping container (not shown) and may carry information related to the inventory of the container, the shipping route of the container, the condition of the container, or other data.

In some environments 100, device 130 may be a signpost device. A signpost device is a low frequency device. Tag 110, responding to a signpost device 130, transitions from sleep mode to active mode as tag 110 enters a facility or choke point. Tag 110 can then become actively involved in the network of environment 100.

In some embodiments, network environment 100 can include a network coordinator 180. Network coordinator 180 can, for example, be a gateway device 130. Network coordinator 180 can provide network services such as beacon signals and other services to network environment 100.

FIG. 1B illustrates the interaction between gateway device 130 and one of RFID devices 110 in more detail. As shown in FIG. 1B, RFID device 110 includes a processor 112 and memory 114. Memory 114 may be of any type or combination of types and may, for example, include combinations of volatile and non-volatile memory. Processor 112 may be a microprocessor, a microcomputer, or any specially designed circuit such as an Application Specific Integrated Circuit (ASIC) that executes instructions to communicate with gateway device 130. The instructions may be stored in memory 114 or may be wired into processor 112. Processor 112 may store and retrieve data from memory 114 and may communicate with one or more external sensors 120 that provide data regarding the environment and condition of the item associated with RFID device 110. Processor 112 is coupled to a transceiver 118, which transmits and receives signals through an antenna 122 utilizing a transmitter and a receiver, respectively. Transceiver 118 transmits and receives digital data that is transmitted wirelessly between gateway device 130 and RFID device 110 or, in the case of multi-hop communications, with another RFID device 110. RFID device 110 is powered by an internal power source 116. Power source 116 can be a battery and is usually limited in capacity.

Gateway device 130 includes a transceiver 140 that receives and transmits signals wirelessly through antenna 144 using a transmitter and a receiver, respectively. Transceiver 140 is coupled to a processor 132. Processor 132 can be a microprocessor, a computer, a dedicated ASIC, or any other device capable of executing instructions to communicate with RFID device 110. Processor 132 is coupled to a memory 134 and may be coupled to a data storage 136. Memory 134 can include both volatile and nonvolatile memory and may be utilized to store data and instructions for processor 132. Data storage 136 can be any long term storage device, for example a magnetic hard drive, optical hard drive, memory based storage device, flash based storage device, or any other device for storing data. Processor 132 can also be coupled to a user interface 138. User interface 138 can include any user input device such as a touch screen, a keyboard, a pointer, or other device and may include video and audio displays. Processor 132 may receive input instructions and commands from user interface 138 for execution and may provide data and results to a user via user interface 138. In some embodiments, processor 132 may also be coupled to an external interface 142. External interface 142 can, for example, couple gateway device 130 to a separate computer, network, or network coordinator 180 in order to upload and download data and instructions to gateway device 130. Interface 142, for example, can be a hard-wire connector or may be a wireless interface such as a Bluetooth interface or other communications device. Gateway device 130 can be powered by removable batteries or by a permanent power source.

FIG. 1C illustrates a dialog 160 between two RFID devices 110, a gateway device 130 and an RFID device 110. Dialog 160 represents a request data frame dialog that can be utilized in a unicast mode. As shown in FIG. 1C, device 130 sends a request 162 to device 110. Device 110 then provides a response 164 followed by one or more data frames 166. After which, device 130 responds with a frame acknowledgment (ACK) 168.

FIG. 1D illustrate a dialog 170 where device 130 is sending data to one or more devices 110. This can occur either in a unicast mode or in a multicast mode. As shown in dialog 170, device 130 sends a request 172. Devices 110 then provide responses 174. Device 130 then provides one or more data frames 176. Once received, device 110 provides frame ACKs 178.

Therefore, in operation gateway device 130 queries RFID device 110 for a response. In most cases, RFID device 110 is powered by an internal power source 116, which is limited. Therefore, RFID device 110 spends most of its time in sleep state, waking periodically to check for an incoming wake-up signal from gateway device 130. Once the wake-up signal is received, RFID device 110 waits for a query from gateway device 130. Once the query is received, RFID device 110 responds to the request. The query can be, for example, a request for information, a request for identification, a request to download new data or instructions, or other requests. Once the dialog is complete between RFID device 110 and gateway device 130, RFID device 110 reenters a sleep state.

RFID device 110 and gateway device 130 communicate wirelessly by exchanging packet data. In some environments 100, for example, it may be desirable to utilize different standards of wireless communication than that commonly utilized for environment 100. For example, FIG. 1A illustrates multi-hop communications 146. In communications 146, a RFID device 110 that is operating in either subcontroller mode or gateway mode relays data through communications 148 between gateway device 130 and another RFID device 110. Such communication can be difficult with the standard RFID protocols.

FIG. 1C illustrates an example global RFID device environment 160 in which embodiments of the present invention can be utilized. As shown in FIG. 1C, a central processor 150 is in communication with multiple geographically separated sites, of which site 152 and 154 are illustrated. Each of sites 152 and 154 include at least one gateway device 130 and one or more RFID devices 110, as indicated in environment 100 of FIG. 1A. Gateway device 130 can communicate with another device, such as a network coordinator 180, at a site, which then communicates with central processor 150. In some cases, gateway device 130 communicates with central processor 150 directly.

FIG. 1C also illustrates an RFID device 156 that is in transit between site 152 and site 154. In some circumstances, a query of RFID device 156 that was initiated in site 152 results in a response that is not complete before RFID device 156 is transitioned out of range of site 152. In the example shown in FIG. 1C, RFID device 156 is transitioning to site 154. In some embodiments, RFID device 156 finishes responding to the query initiated in site 154 when RFID device 156 arrives within range of site 154. The full response can then be compiled by central processor 150.

In these examples, gateway device 130 and RFID devices 110 in each of sites 152 and 154 can be considered nodes of a larger network that includes central processor 150, gateway devices 130, and RFID devices 110 at each of sites 152 and 154. The network is dynamic in that RFID devices enter and exit sites such as sites 152 and 154, which causes communications difficulties overall. The present disclosure includes methods of communication between RFID devices such as gateway device 130 and RFID device 110 as nodes in a dynamic network. In some systems 100, RFID devices 110 may also be capable of communicating between each other.

Several wireless protocols operate in such network environments. For example, IEEE 802.11 or 802.15.4 protocols can be utilized. Other protocols can also be utilized. In these cases, an RFID application layer is stacked with the appropriate protocol layers in order to perform the communications.

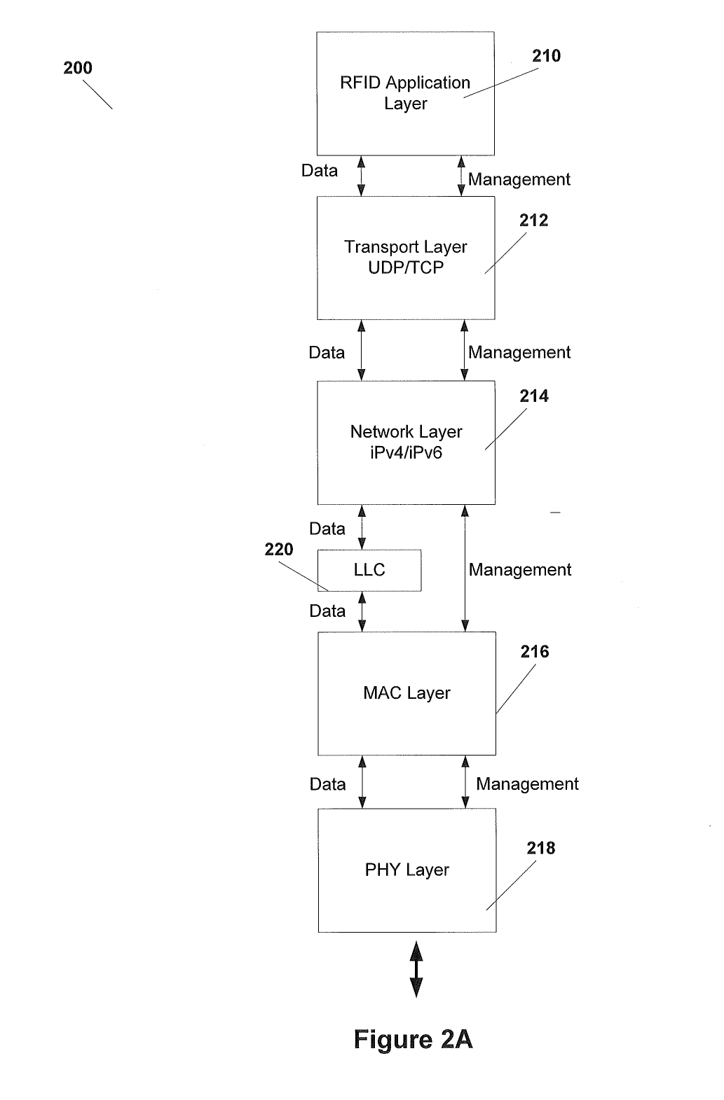

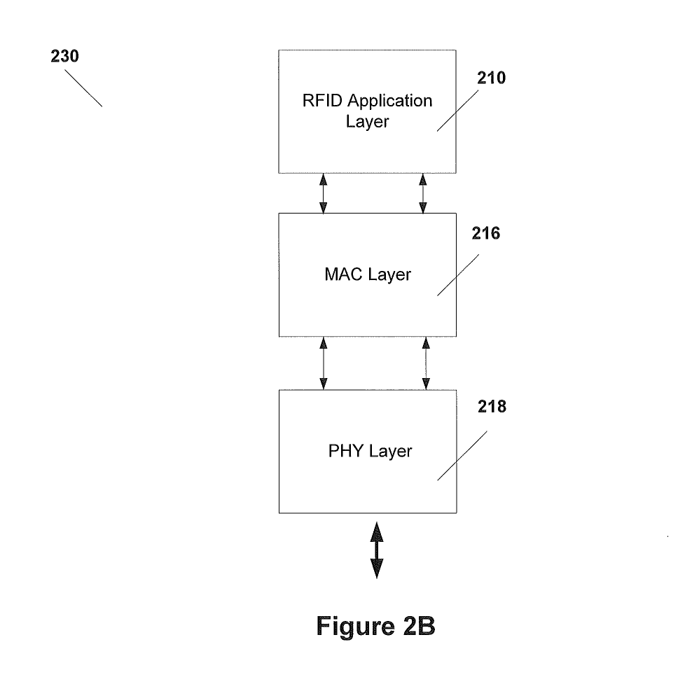

FIG. 2A illustrates a protocol stack 200 that can be utilized in some communications accordingly. Protocol stack 200 includes multiple protocol layers. Each layer is responsible for one part of the protocol stack and offers services to the higher layers. The layout of the layers is based on the open systems interconnection (OSI) seven-layer model (see ISO/IEC 7498-1:1994). The interfaces between the layers serve to define the logical links. As shown in FIG. 2A, the layers include the RFID Application layer 210, a transport layer 212, a network layer 214, a Media Access Control (MAC) layer 216, and a Physical (PHY) layer 218.

A Next Gen RFID device comprises a PHY layer 218, which contains the radio frequency (RF) transceiver, shown as transceiver 140 in gateway device 130 or transceiver 118 in RFID device 110 in FIG. 1B, along with the low-level control mechanism, and a MAC sub-layer 216 that provides access to the physical channels for all types of data transfer. As shown in FIG. 2B, the sub-layers MAC layer 216 and PHY layer 218 may be directly interfaced with the RFID application layer 210.

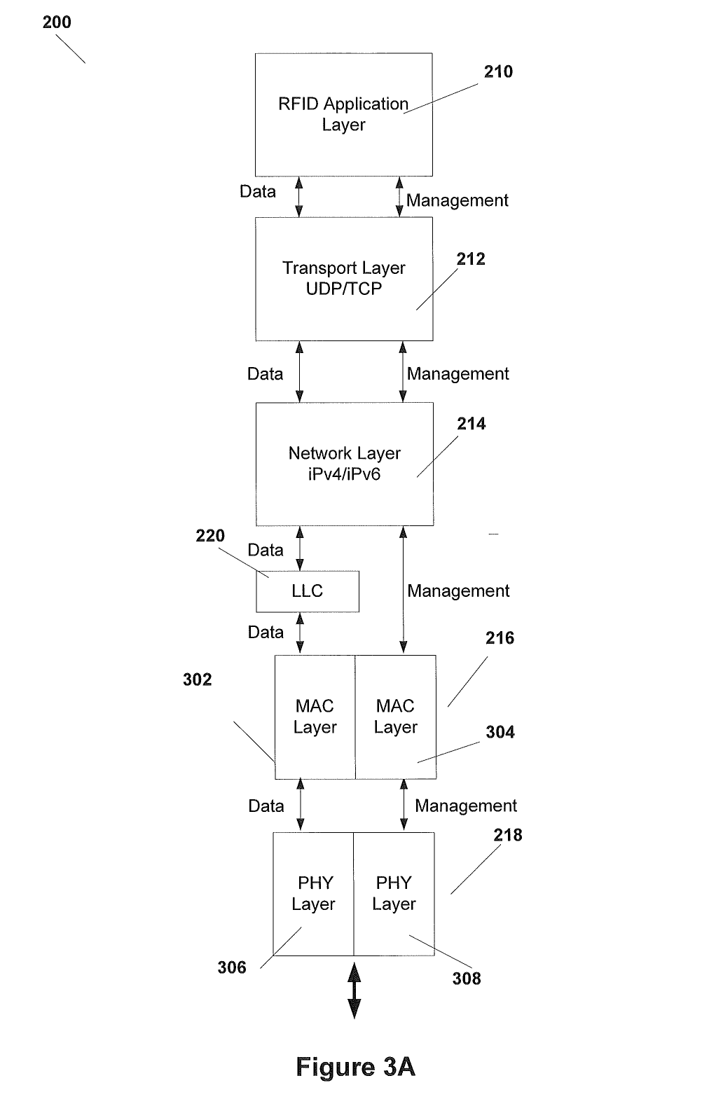

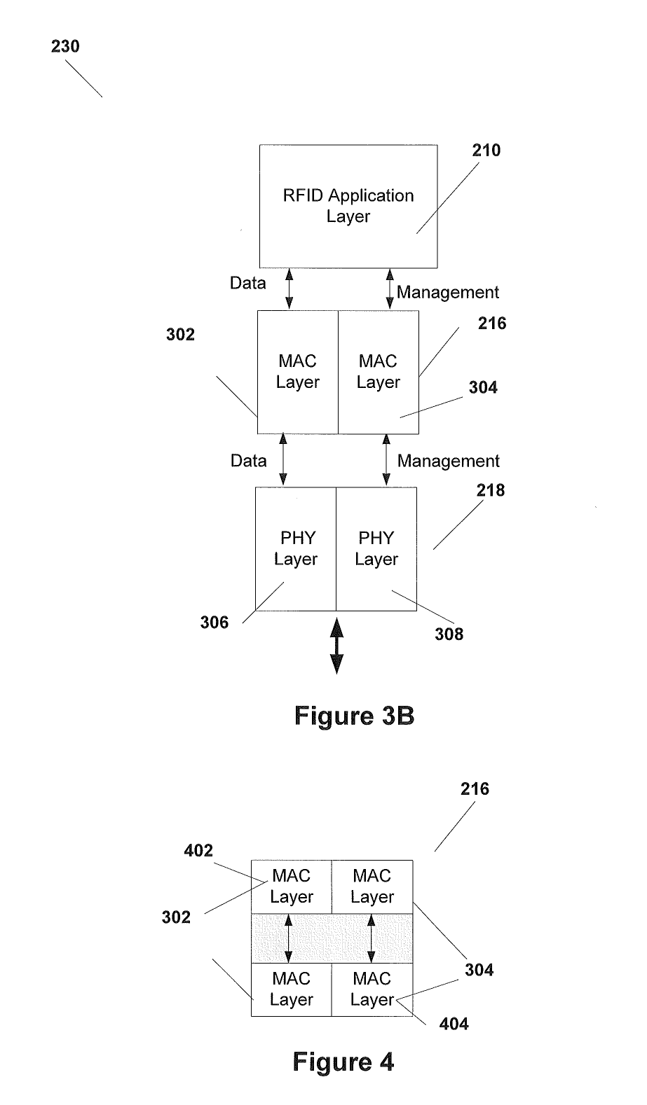

As shown in FIG. 3A, PHY layer 218 provides two services: the PHY data service 306 and the PHY management service 308. PHY data service 218 enables the transmission and reception of PHY protocol data units across the physical radio channel.

The features of PHY 218 are activation and deactivation of radio transceiver 140 in gateway device 130 or transceiver 118 in RFID device 110, Energy detection (ED) within the current channel, Link quality indication (LQI) for received packets, Clear channel assessment (CCA) for carrier sense multiple access with collision avoidance (CSMA-CA), Channel frequency selection, and Data transmission and reception. In gateway device 130, PHY sub-layer 218 is performed partly in processor 132 and in transceiver 140. In RFID device 110, PHY sub-layer 218 is performed partly in processor 112 and in transceiver 118.

MAC sub-layer 216 provides two services: the MAC data service 302 and the MAC management service 304. MAC data service 302 enables the transmission and reception of MAC protocol data units across PHY data service 306.

The features of MAC sub-layer 216 are management of power saving devices, synchronization, channel access, frame validation, acknowledged frame delivery, network association, and network disassociation. In addition, MAC sub layer 216 provides infrastructure for the MAC layer security. In some embodiments, MAC Layer 216 supports one or more of authentication, key derivation procedures, and crypto algorithms such as those defined in the ISO/IEC WD 29167-7. In gateway device 130, the functions of MAC sub-layer 216 are performed in processor 132. In RFID device 110, the functions of MAC sub-layer 216 are performed in processor 112.

As shown in FIGS. 2A and 3A, protocol stack 200 includes a network layer 214 and a transport layer 212. Data is received into MAC layer 216 from network layer 214. Data itself is coupled to a logical link control (LLC) 220 between network layer 214 and MAC layer 216. An IEEE 802.2 Type 1 logical link control (LLC) 220 can access the MAC sub-layer through the service-specific convergence sub-layer (SSCS).

Network layer 214 provides network configuration, manipulation, and message routing services to transport layer 212. The functions of network protocol layer 214 can include connection services, host addressing, and message forwarding. In some embodiments, network layer 214 can support, for example, IPv4 or IPv6 internet protocols. Other networking protocols include Distance Vector Multicast Routing Protocol (DVMRP), Internet Control Message Protocol (ICMP), Internet Group Multicast Protocol (IGMP), Protocol Independent Multicast Sparse Mode (PIM-SM), Protocol Independent Multicast Dense Mode (PIM-DM), Internet Protocol Security (IPsec), Internet Packet Exchange (IPX), Routing Information Protocol (RIP), Datagram Delivery Protocol (DDP), and Border Gateway Protocol (BGP).

Transport layer 212 provides general transport services such as connection-oriented data stream support, reliability control, flow control, congestion avoidance, and multiplexing services. RFID application layer 210 provides the intended function of RFID device 110 or gateway device 130. RFID application layer 210, for example, may support both IPv4 and IPv6 network protocols. Transport layer 212 may support both User Datagram Protocol (UDP) and Transmission Control Protocol (TCP) transport protocols, or may utilize some other protocol such as, for example, AppleTalk Transaction Protocol (ATP), Cyclic UDP (CUDP), Datagram Congestion Control Protocol (DCCP), Fiber Channel Protocol (FCP), IL Protocol (IL), NetBIOS Framers Protocol (NBF), Stream Control Transmission Protocol (SCTP), Sequenced Packet Exchange (SPX), Structured Stream Transport (SST), UDP Lite, or Micro Transport Protocol (μTP).

Transport Layer 212, Network Layer 214, and MAC Layer 216 each receive a packet of data and provide a header layer to that packet. As shown in FIG. 2A, RFID Application Layer 210 provides a packet consistent with an RFID Protocol such as the 18000-7 protocol standard. Transport layer 212 inserts the RFID protocol packet into the payload of a transport layer protocol packet. Network layer 214 receives the transport layer protocol packet and places it into the payload of one or more network protocol packets for transmission by physical layer 218. Since networking layer 214 and transport layer 212 headers may present excessive overhead for a short framed packet as defined by most RFID protocols, FIGS. 2B and 3B illustrate a layered architecture 230 that enables transport of the RFID Application Layer 210 protocol frame directly over MAC layer 216. Still, a clear separation of protocol layers is maintained in architecture 230.

As discussed above, RFID application layer 210, transport layer 212, network layer 214, LLC 220, and MAC layer 216 can be implemented in processor 112 of RFID device 110 and in processor 132 of RFID device 130. PHY layer 218 can be implemented in processor 112 of RFID device 110 in combination with transceiver 118 of RFID device 110, and can be implemented in processor 132 of gateway device 130 in combination with transceiver 140.

As discussed above and illustrated in FIGS. 2A, 2B, 3A, and 3B, Device Protocol Stack can be utilized with IEEE 802.15.4 or IEEE 802.11 MAC and PHY. Any other protocols providing the MAC/PHY functionality can be used instead.

As illustrated in FIG. 4, in some embodiments a RFID device 110 or gateway device 130 has a dual-MAC nature: generic MAC 402 and RFID specific MAC 404. Although depicted as separated in FIG. 4, the MAC 402 and MAC 404 may be inter-related. The features of generic MAC sub-layer 402 include synchronization, channel access, frame validation, acknowledged frame delivery, network association, and disassociation. In addition, MAC sub layer 402 provides infrastructure for the MAC layer security. The features of the RFID specific MAC 404 sub-layer are management of power save devices.

Wireless communications between RFID devices 110 and gateway devices 130 can utilize any MAC and PHY protocols discussed above, including one of the following protocols: ISO 18000-7 Mode 2; IEEE 802.15.4; IEEE 802.11, or any other layer 2 protocol. Besides a generic MAC layer 402 protocol, RFID devices 110 and gateway devices 130 MAC layers 216 may include a specific RFID Wakeup/Synchronization MAC protocol and correspondingly PHY layer 218 may include an RFID Wakeup/Synchronization protocol. A Hybrid RFID device 110 or gateway device 130 can support both an RFID Wakeup/Synchronization protocol MAC layer 216 and PHY layer 218 as well as, for example, an IEEE 802.15.4, IEEE 802.11, or some other non-RFID protocol (an example RFID protocol is the ISO 18000-7 Mode 2 protocol) MAC layer 216 and PHY layer 218. In contrast, a standard RFID device (RFID device or gateway device) may support only the RFID Wakeup/Synchronization MAC and PHY layer with ISO 18000-7 Mode 2 MAC/PHY.

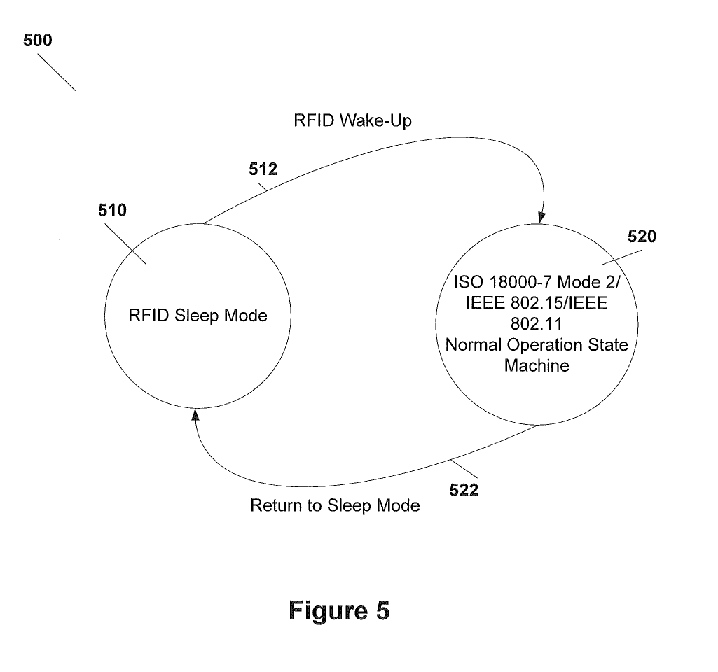

FIG. 5 illustrates a state machine 500 for a RFID device 110 according to some embodiments of the present invention. As presented in the FIG. 3: Next Gen RFID device state machine, a Next Gen RFID devices can be in one of two (top level of hierarchy) states: RFID Sleep State or in one of the compliant states of the Normal Operation State Machine of any of following protocols: ISO 18000-7 Mode 2, IEEE 802.15.4, IEEE 802.11, or some other layer 2 protocol.

As shown in FIG. 5, RFID device 110 spends most of the its lifetime in the RFID Sleep State 510 preserving the battery life. RFID device 110 transitions through transition 512 to operation state 520 when a wake-up signal is received. During operation state 520, RFID device 110 behaves normally in the wireless network. Operation state 520 includes several states. One state is listening for beacon frames. If the beacon frame or wake-up frame is not detected within a set period of time, RFID device 110 can perform transition 522 back to sleep state 510. In another state, RFID device 110 performs the associated procedure with the wireless infrastructure device (Gateway device 130 or, in some cases, a Coordinator 180 or an Access point depending on the network type). If the security is enabled, type of authentication is carried in the beacon frame. In another state, RFID device 110 can perform a mutual authentication of the wireless infrastructure device and derives session keys using pre-shared keys or certificates based authentication. The step can be performed if the network utilizes security. Some states include a data exchange state. In this state, RFID device 110 exchanges the (secure) data frames with the remainder of the infrastructure of the environment. In this process RFID device 110 can be collected (ISO 18000-7 terminology), can be configured, and data can be moved back and forth between the device and the infrastructure. The infrastructure device can send the device back to RFID Sleep State by sending a data frame from the RFID Application running on the wireless network infrastructure device or sending the Disassociation Request (MAC frame) from the infrastructure device.

The Wake-up procedures can, for example, be based on the mechanisms specified in the “Method, System and Apparatus for Managing Power Constrained Devices” patent application, U.S. patent application Ser. No. 13/166,130, filed on Jun. 22, 2011, which is herein incorporated by reference in its entirety.

Besides separating RFID specific MAC features such as the Wakeup/Synchronization procedure from the rest of the MAC functionality provided by many wireless protocols, the RFID Application layer 210 is separated from the MAC layer 216. In the current ISO 18000-7 protocol, the RFID Application is embedded into the MAC frame. In accordance with applications of the present invention, the RFID Application from RFID application layer 210 can be transferred over TCP/UDP/IP/ or other layer to MAC layer any layer 216 and PHY layer 218. In a special case, to respect the limitation of the frame size in some wireless protocols, the RFID Application can be carried directly as a payload of the MAC frame, as shown in FIGS. 2B and 3B. This clear separation of Application layer 212 enables Development and testing of the RFID application independent of the complex details of the wireless MAC and PHY, and carrying the RFID application data over different wireless protocols.

In some embodiments, the multiple protocol layers includes a network layer 214 operating on a MAC layer 216, which operates on a PHY layer 218; a transport layer 212 operating on the network layer; and an application layer 210 operating on the transport layer 212. In some embodiments, a first wireless MAC/PHY layer 216/218 has an RFID standard, for example the ISO18000-7 standard, application layer 210 over the first wireless MAC/PHY layer 216/218. The first wireless MAC/PHY layer 216/218 can be, for example, an IEEE802.15.4 MAC/PHY layer, an IEEE802.11 MAC/PHY layer, a Bluetooth MAC/PHY layer, or any other wireless protocol MAC/PHY layer.

The original ISO18000-7 protocol defines a set of applications and a set of the physical (PHY) layer and MAC layer functions tightly coupled. In this document, the Application Layer is separated from the ISO18000-7 MAC and PHY functions. This separation enables execution of the ISO18000-7 Application layer over an IEEE802.15.4 MAC and PHY as described below, over IEEE802.11, over Bluetooth, over any of cellular wireless data MAC/PHY protocols, etc.

The ISO 18000-7 Application Layer 210 relies on the generic MAC layer 216 functions for creating and synchronizing the network. These functions are not the same in all wireless network technologies, e.g. creating the network and device synchronization in IEEE802.15.4 and Bluetooth are different. Once the network is created, the ISO18000-7 Application layer 210 on end or infrastructure devices will exchange application layer messages to perform applications defined in the document. These application layer messages are carried as payload in the MAC data frames. The ISO18000-7 will configure the MAC layer 216 and PHY layer 218 as needed to support a specific application use case.

Although the specific examples provided in this disclosure are for ISO18000-7 overlayed onto the IEEE802.15.4 MAC/PHY, it should be understood that in accordance with aspects of the present invention the ISO18000-7 can be overlayed over other MAC/PHY standards such as, for example, Bluetooth or other wireless standards.

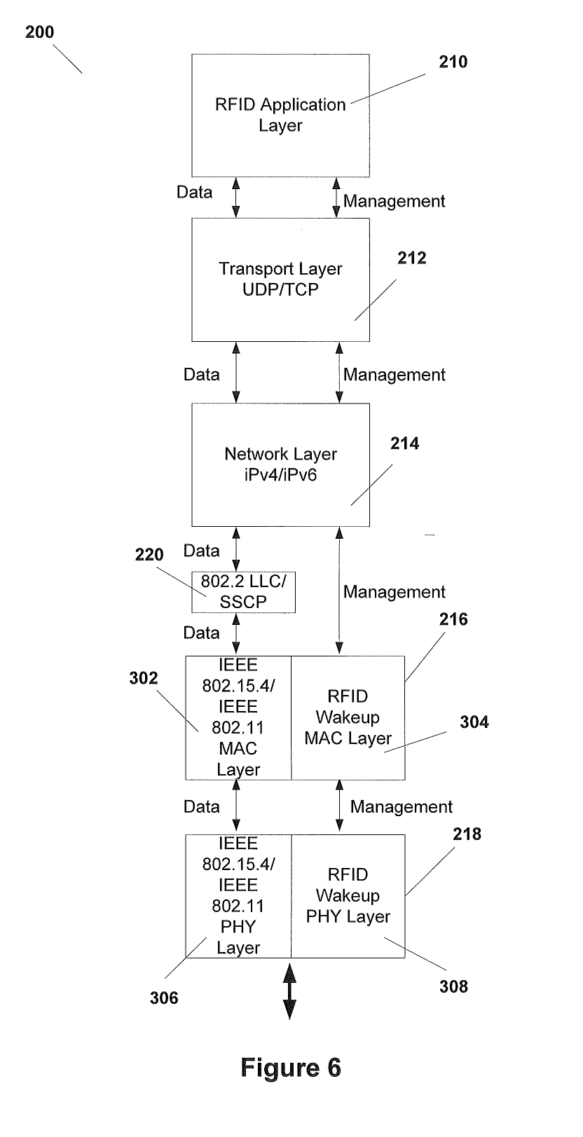

FIG. 6 illustrates a protocol layer according to some embodiments of the present invention. As shown in FIG. 6, protocol layer 200 that includes RFID application layer 210, transport layer 212, network layer 214, LLC 220, MAC layer 216, and PHY layer 218, as previously discussed with FIGS. 2A and 3A. As particularly illustrated in the embodiment shown in FIG. 6, LLC 220 is consistent with an IEEE 802.2 LLC/SSCP protocol. MAC layer 216 includes MAC management services 304 that is consistent with the RFID wakeup protocol and the MAC data services 302 that employs IEEE 802.15.4 or IEEE 802.11 protocols. Similarly, PHY layer 218 includes PHY management services 308 that operates according to the RFID wakeup protocol and PHY data services 306 that employs IEEE 802.15.4 or IEEE 802.11 protocols.

FIGS. 3A and 6 illustrates that device 110 can transition efficiently from sleep state 510 to active state 520 by switching between MAC layer 304 and MAC layer 302 and from PHY layer 308 and PHY layer 306. This ability can optimally support low power adhoc networks consistent with an RFID protocol and still utilize an industry standard upper protocol stack more typical of static wireless networks.

Returning to FIG. 5, with protocol layer 200 as illustrated in FIG. 6, RFID device 110 in sleep state 510 utilizes MAC management services 304 and PHY management services 308 to wait for a wake-up signal. Once the RFID wake-up signal is received, RFID device 110 transitions to state 520 for data exchange. In state 520, RFID device 110 utilizes MAC data services 302 and PHY data services 306 as the protocols for data transmission and receipt.

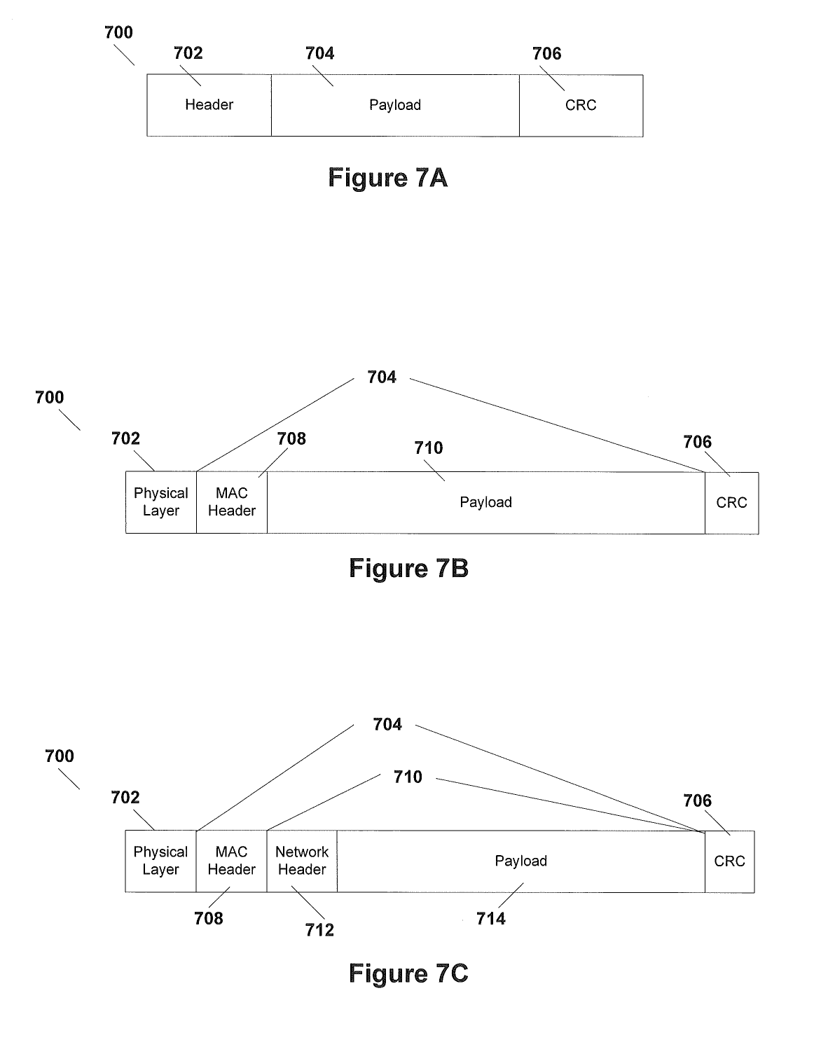

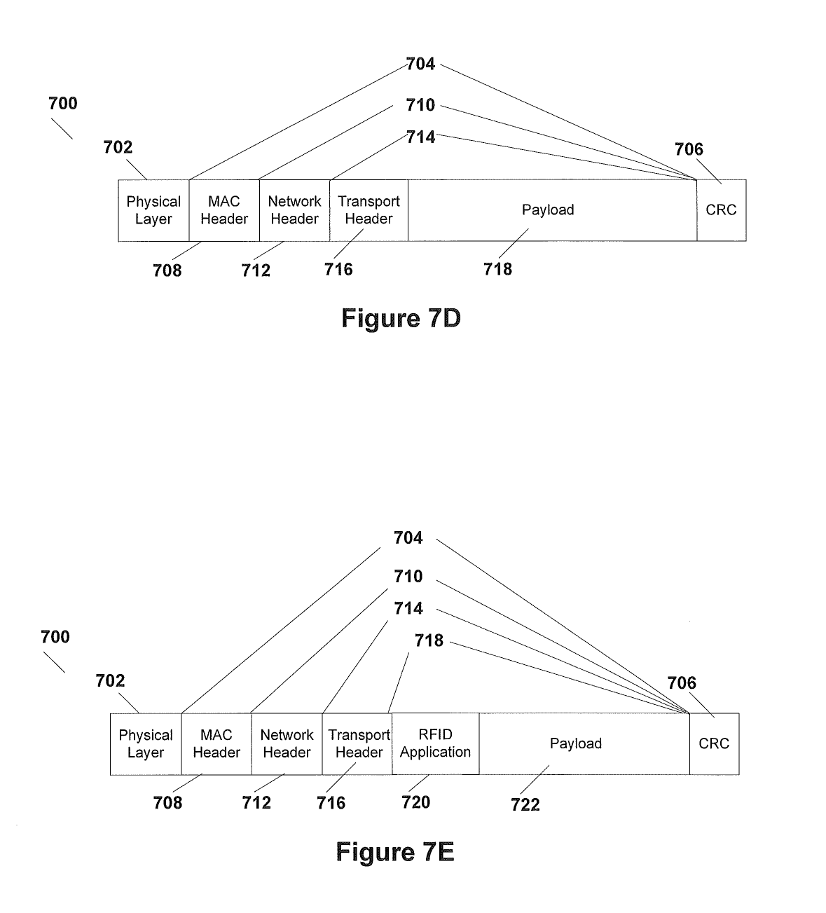

FIGS. 7A through 7E illustrate the packet format for a protocol layer such as that illustrated in FIGS. 2A, 2B, 3A, 3B, and 6. As shown in FIG. 7A, a packet 700 includes a header 702, a payload 704, and error correction 706. In some embodiments, as illustrated in FIG. 7A, error correction 706 can be a cyclic redundancy check (CRC) or other error correction technique. Header 702 includes commands and routing information regarding the packet. Payload 704 includes the packet data. In a layered protocol system, payload 704 can include headers and data from a higher protocol layer.

As shown in FIG. 7B, if header 702 is a physical layer header that is generated by PHY layer 218, then payload 704 may include a MAC header 708 and MAC payload 710 that are generated by MAC layer 216. FIG. 7C illustrates that MAC payload 710 may include a network header 712 and network payload 714 that was generated by network layer 214. As shown in FIG. 7D, network payload 714 may include a transport header 716 and transport payload 718 generated by transport layer 212. Finally, as illustrated in FIG. 7E, transport payload 718 may include the RFID application header 720 and RFID application payload 722 generated by application layer 210. Each of these packets may be of varying lengths and the information contained in each of the headers is dependent upon the actual protocol being implemented. Further, consistent with FIGS. 2B and 3B, transport layer 212 and network layer 214 may be absent, resulting in the absence of Transport header 716 and network header 712 from packets 700 as illustrated in FIGS. 7C through 7E.

As illustrated in FIGS. 7A through 7E, the RFID MAC frame format supports a clear separation of the application layer 210 from MAC layer 216. As discussed above, MAC layer 216 supports the encapsulation of network layer 214 protocols such as IPv4/iPv6, or other protocol. Further, MAC layer 216 enables IP applications on RFID protocol stack 200. Further, as illustrated in FIGS. 2B and 3B, MAC layer 216 can include direct encapsulation of an RFID packet from RFID application layer 210. Table 1 illustrates a packet 700 according to some embodiments of the present invention.

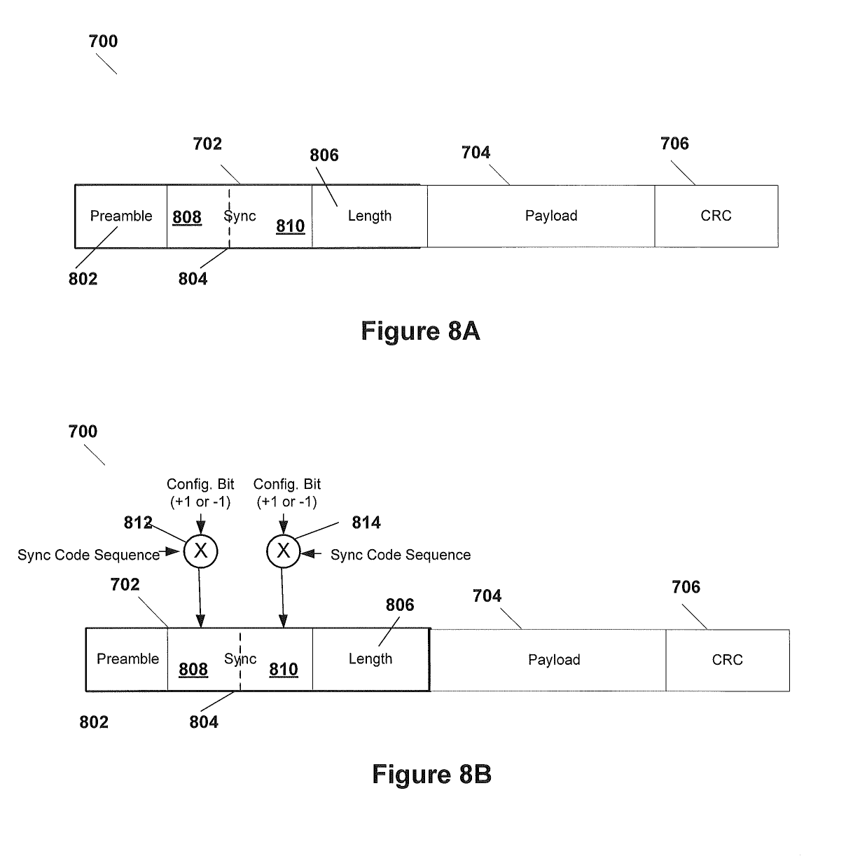

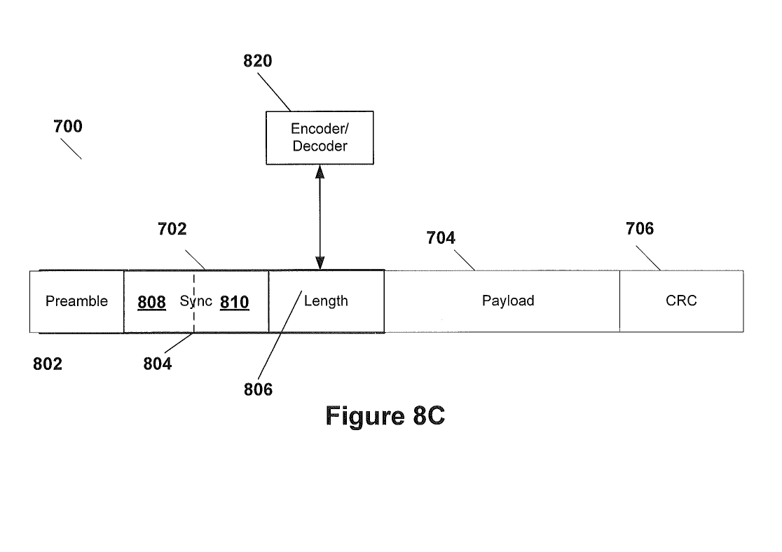

Frame 700 illustrated in FIG. 7A, as further illustrated in FIG. 7B, can be a Physical Layer 218 frame. As shown in FIG. 7A, frame 700 includes a header 702, a payload 704, and error coding 706. As shown in FIG. 8A, in some cases header 702 can include a preamble 802, a sync word 804, and a length 806. Physical layer frame 700 also includes a payload 704 and an error correction 706, which is shown here as a CRC field.

Preamble field 802 can be a fixed sequence of symbols. An example of such a sequence is “00110011 . . . ”. Preamble 802 serves several functions. One such function is to Provide a training sequence for the receiver section of transceiver 118 of RFID device 110 or transceiver 140 of gateway device 130 to detect DC offset, perform channel estimation, or other functions. Another function is to enable the receiver portion of transceiver 118 or transceiver 140 to detect RF signal energy, which may signify the arrival of a frame, and wake up the other idle receiver functions of transceiver 118 or transceiver 140 such as training, synchronization, and payload reception.

Synchronization Word field 804 enables the receiver of transceiver 118 or transceiver 140 to perform timing synchronization, including Symbol synchronization, Byte synchronization, and Detection of frame start time. The Length field 806 indicates the length of the payload field in number of bytes. Payload 704 carries upper layer data, e.g. MAC layer frame 710. CRC error field 706 can contain the cyclic redundancy check result for the Length 806 and Payload fields 704.

Sync Word 804 includes symbols, which are generally numbered larger than 2. For example, Sync Word 804 can be configured to support 16 or 32 symbols. The symbols in Sync Word 804 employ one fixed modulation scheme. The parameters of the modulation scheme are well defined and are known to all receivers of transceivers 118 and 140. No additional coding technique is applied to Sync Word 804.

Sync Word 804 carries a code sequence that exhibits good correlation property. The code sequence should have high autocorrelation values when two identical code sequences are perfectly aligned, and low or zero correlation values otherwise. The code sequence should also have low cross-correlation values.

The code sequence of sync word 804 is represented by a sequence of +1 and −1, or sometimes abbreviated as + and −. In the case of 2FSK modulation, a ‘0’ symbol can be used to represent +1, and a ‘1’ symbol can be used to represent −1. Sync Word field 804 might carry one single code sequence, or it can carry two or more concatenated code sequences. In FIG. 8A, sync word 804 is shown to carry code sequence 808 concatenated with code sequence 810. However, sync word 804 can include any number of concatenated sync codes. In some cases, code sequence 808 and code sequence 810 are identical sequences. To support concatenation of the same code in the Sync Word field, the code sequence should exhibit good circular correlation property.

One example of a code sequence that can be utilized in sync word field 804 is the Gold Code Sequence. For example, a 31-symbol Sync Word field 804 can be used to carry one 31-bit Gold Code Sequence. Alternatively a 30-symbol Sync Word field can be used to carry two concatenated 15-bit Gold Code Sequences. Other code sequences with good correlation properties can also be used. The key objective of code selection is to enable high synchronization success rate even under noisy interference environments.

FIG. 8B illustrates generation of the code sequence for sync word 804. The sync code sequence can optionally be used to carry configuration information by spreading one configuration bit (i.e. +1 or −1) per code sequence. As shown in the example of FIG. 8B, a correlator 812 receives a sync code sequence and a configuration bit and generates sync word 804. In some embodiments, correlator 812 generates a first sequence 808 and a second correlator 814 generates a second sequence.

The receiver of transceiver 118 or 140 synchronizes to the transmitted signal by correlating with the sync code in Sync Word 804 field using correlator. The receiver correlator performs the reverse function of correlator 814. In general, each symbol will be sampled multiple times (i.e. the sampling period is a fraction of the symbol time) to ensure accurate synchronization. Synchronization is achieved when the magnitude of the output of correlator is higher than a pre-determined threshold value. When there are more than one sync codes in the Sync Word field, 804, such as 808 and 810, the receiver sequentially correlates with the sync codes using the same correlator. Once synchronization is achieved, the receiver then determines the configuration and control bits carried by the sync codes based on the polarities of the correlator output values.

Based on this concept, Sync Word 804 provides a reliable way (it has better reliability compared to carry the info in the un-coded header or payload) to carry limited system configuration information. The receiver, during correlation, can extract the control bits from Sync Word 804. The method utilizing sync word 804 reduces communication delay as no higher layer signaling is necessary to carry the same information. For example, a single configuration bit can indicate to the receiver that one of two available modulation schemes will be used in frame payload 704, or it can indicate whether forward error correction is used or not in the payload field 704, or it can indicate whether coding is applied to Length field 806, or may be utilized for other indications. If multiple concatenated code sequences are used in Sync Word field 804, additional configuration information can be carried. For example, two configuration bits enable the Sync Word 804 to inform the receiver to use one of four possible PHY configurations, without requiring additional signaling and higher layer protocol exchange. Therefore, data bits can be spread across sync codes in Sync Word 804 in order to transmit data.

Note that this concept does not increase the complexity of the correlator design. A single corrector can be used to sequentially correlate with one or more concatenated code sequences. The spreading of data bit by the sync code sequence will only change the polarity of the correlation result and it will not affect the correlation and detection performance. The spreading operation can simply be done by reversing the polarity of the code sequence. Similar correlator design can be used whether spreading and code concatenation are used or not.

Length field 806 is utilized to indicate the length of Payload field 704. For example, an 8-bit length field enables PHY frame 700 to carry up to 256 bytes of payload in payload field 704. When receiving PHY frame 704, a receiver part of transceiver 118 or transceiver 140 first detects the channel using the Preamble field and performs synchronization using Sync Word field 804. Then the receiver receives the Length field 806. The receiver will then receive a number of payload bytes as indicated by the value carried by Length field 806. For example, a Length field 806 of “01111111” (in binary) indicates that Payload field 704 is carrying 128 bytes of data, and the receiver should collect 128 bytes of payload data from payload field 704 after Length field 806.

Length field 806 is outside of payload field 704 and it is not protected by error coding, such as forward error correction, that is applied to the Payload field 704. To ensure a high quality Length field 806 such that a frame 700 can be received correctly, coding can be applied to Length field 806 independently. FIG. 8C illustrates an encoder/decoder 820 that handles length field 806. For example, in order to carry an 8-bit payload length, a 16-bit Length field 806 can be used. The 8-bit payload length is first encoded by an encoder 820 into 16 bits, and the result is placed into the 16-bit Length field 806 for transmission. At the receiver, a decoder 820 decodes the 16-bit Length field 806 back to an 8-bit payload length. This 8-bit payload length will indicate the number of payload bytes to be received from payload 704 after Length field 806. When the appropriate coding mechanism is used, certain bit errors in Length field 806 can be corrected during the decoding process executed in decoder 820, which results in better reliability when receiving PHY frames 700.

As shown in FIG. 7B, payload 704 may carry a MAC packet that includes a MAC header 708 and a MAC payload 710. As shown in Table 1, physical layer header 702 is N bytes in length, MAC header 708 is M bytes in length, MAC payload 710 is of variable length, and CRC 706 is 2 bytes in length.

TABLE 1

| Physical Layer 702 | MAC header 708 | MAC Payload 710 | CRC 706 |
|---|---|---|---|
| N bytes | M bytes | Variable | 2 bytes |

MAC header 708 includes a Frame Signature, Sequence Number, addressing information and an optional security field. An example MAC header 708 is illustrated in Table 2. Table 2 illustrates a particular set of byte lengths for fields in MAC header 708. However, it should be realized that these lengths may vary with different embodiments.

TABLE 2

| | | Desti- | | Interme- | Interme- | Secu- |
|---|---|---|---|---|---|---|
| Frame | Sequence | nation | Source | diate | diate | rity |
| Signature | Number | Address | Address | Address 1 | Address 2 | Field |
| 2 bytes | 1 byte | 0/2/6/8 | 0/2/6/8 | 0/2/6/8 | 0/2/6/8 | 8 bytes |
| | | bytes | bytes | bytes | bytes | |

Addressing information is determined by addressing control bits in the Frame Signature. MAC frame header 708 can include a minimum of one address. In the embodiment shown in Table 2, MAC frame header 708 includes up to four addresses. One address can be utilized for a broadcast frame where the broadcast bit is set in the frame signature field. Intermediate addresses are optional and can be used for a Mash networking arrangement at MAC Layer 216. Address size can be defined by control bits in the Frame Signature field. As shown in the example of Table 2, the addresses sizes are provided as 0/2/6/8 bytes. In many embodiments, the source address field is always present and cannot be set to zero in length.

The security filed will be present in MAC header 708 if the security enable bit is set in the Frame Signature field of MAC header 708. Table 3 illustrates MAC header 708 for some embodiments of the present invention. As shown in Table 3, MAC header 708 can include a destination address and a source address. In some embodiments, the security field is optional.

TABLE 3

| | Sequence | Destination | Source | Security |
|---|---|---|---|---|
| Frame Signature | Number | Address | Address | Field |
| 2 byte | 1 byte | 2/6 bytes | 2/6 bytes | 8 bytes |

As illustrated in Tables 2 and 3, the first two bytes of MAC header 708 are the frame signature. An example of the bit allocations for the frame signature of MAC header 708 is provided below, although other definitions may be utilized. The most-significant bit (MSB) in the Frame Signature field can be reserved for future expansions. In that case, if the value of the MSB is 1 than the frame signature can be expanded by one byte in length. If the value of the MSB is zero than Frame signature is 2 byte long. The frame signature can include Address size flags, which are 2 bits where “00” indicates 6 byte addresses, “01” indicates 2 byte addresses, and “10” indicates 8 byte address. Intermediate address flags may also be 2 bits where “00” indicates that there are no any intermediate address in MAC header 708, “01” indicates one intermediate address in MAC header 708, and “10” indicates two intermediate addresses in MAC header 708.

There may also be a MAC frame security bit, where “0” indicates security disabled and “1” indicates that security is enabled. The security bit, described in the above table, shall be used to indicate if the frame is secured or not. If the value of the bit is set to 1 then the frame is secured and the fields IV/CCM Header, Encrypted Payload, and Authentication Data are present in the frame and MAC payload 710 is encrypted. If the Secure is set to 0 then the frame is NOT secured and the fields IV/CCM Header, Encrypted Payload, and Authentication Data are NOT present in the frame.

The frame signature may also include a LLC bit that indicates whether or not LLC 220 is present. In some examples, if the LLC bit is “1” then an 802.2 LLC field is present and MAC payload 710 carries an 802.2 LLC protocol layer and supports IPv4 or 6LowPan or any other protocol specified in the LLC header. IF the LLC bit is “0” then the RFID Application Protocol is present MAC Frame Payload 710.

The Frame Signature field of MAC header 708 may also include a broadcast frame bit. If the broadcast frame bit is “0” then frame 700 is a broadcast frame and the destination address is not present in MAC header 708. If the broadcast frame bit is “1” then frame 700 is a unicast frame and the destination address is present in MAC header 708.

The Frame Signature field of MAC header 708 may also include a MAC frame type, which may be 4 bits. This field will indicate the type of MAC frame, which may include a Beacon frame, a Join or Association request with response, an Acknowledge (ACK) frame, an Authentication Request and Response, or a Data frame. Frame 700 may be any number of types.

If LLC 220 is utilized, then LLC 220 may be an IEEE 802.2 protocol LLC. LLC 220 is used if the encapsulation of the RFID Application into a network layer 214 is utilized, for example if an IPv4/6LowPAN or other protocol is utilized. In this case MAC frame payload 710 will contain additional protocol headers, for example network header 712. In some embodiments, RFID Application data 722 can be carried directly into the MAC frame payload 710. The absence of the field corresponding to LLC 220 can be specified with a dedicated bit (802.2 LLC Present bit) in the Frame Signature field of MAC header 708. If present the field corresponding to LLC 220 is part of MAC payload 710.

In some embodiments, RFID Application Data can be carried directly after MAC header 708 in MAC payload 710. In that case, network header 712 and transport header 716 are absent in FIG. 7E. Table 4 illustrates an example of frame 700 where RFID application data is presented in MAC payload 710.

TABLE 4

| | | RFID Application | |
|---|---|---|---|
| Physical Layer | MAC Header | Data | CRC |
| N bytes | M bytes | Variable | 2 bytes |

In Table 4, RFID application data includes RFID application header 720 and RFID application payload 722, as illustrated in FIG. 7E. In this case, the LLC Present bit in the Frame Signature field of MAC header 708 will be set to zero. Utilizing the packet illustrated in Table 4, the overhead to the frame length can be minimized.

RFID Application Data can be tunneled through any of network layer 214 and transport layer 212 protocols. In this case, the LLC Present bit in the Frame Signature field of MAC header 708 will be set to one. The LLC protocol type will specify network layer protocol such as 6LowPAN, IPv4, etc. Network layer 214 will specify the transport layer 212 protocol such as TCP or UDP and the transport layer protocol will specify the port number for the RFID Application from RFID application layer 210. In this case, the overhead to the size of frame 700 may be significant. However, such embedding can be used if either the size of the MAC frame is big enough or if the IP (Internet Protocol) connectivity is mandatory. To reduce the overhead, the 6LowPan can be used with compression. This type of encapsulation is presented in Table 5, which describes MAC payload 710 for an RFID Application over a network and transport layer. Encapsulation can be attained with any network layer 214 and transport layer 212 protocols and these protocols (802.11 LLC, 6LowPAN, IP, UDP, TCP, etc) are used as already defined by their respective standards.

TABLE 5

| 802.2 | Network Header 712 | Transport Header | RFID Application |
|---|---|---|---|
| LLC | (IPv4/6LowPAN) | 716 (UDP/TCP) | Data |
| Defined | Defined Standard | Defined Standard | N bytes |
| Standard | | | |

RFID Application layer 210 provides packets according to the RFID protocol. As indicated above, these packets are carried by MAC layer 216 and PHY layer 218 as discussed above. Table 6 provides RFID Application command codes and functions that are consistent with the 18000-7 RFID protocol. For commands that include a sub command code, the sub command code field is the first byte of the command arguments field that follows the command code. Some commands require arguments, which will be supplied with the commend. Contents and length of any arguments are specific to each command. These commands are further described below with particular examples to the 18000-7 Mode 2 protocol. Other RFID protocols may be utilized as well.

TABLE 6

| Command | | | | | |
|---|---|---|---|---|---|
| code + Sub | | | | | |
| Command | | Command | Mandatory/Optional | | |
| Code (R/W) | Command name | type | Interrogator | Tag | Description |
| 0x1F/NA | Collection with | Broadcast | Mandatory | Mandatory | Collects all Tag IDs and Universal Data |
| | Universal Data Block | | | | Block |
| NA/0x15 | Sleep | Point to Point | Mandatory | Mandatory | Puts tag to sleep |
| NA/0x16 | Sleep All But | Broadcast | Mandatory | Mandatory | Puts all tags but one to sleep |
| 0x13/0x93 | User ID | Point to Point | Mandatory | Optional | Sets user assigned ID (1-60 bytes) |
| 0x09/0x89 | Routing Code | Point to point | Mandatory | Mandatory | Reads and writes routing code |
| 0x0C/NA | Firmware Version | Point to Point | Mandatory | Optional | Retrieves manufacturer-defined tag |
| | | | | | firmware revision number |
| 0x0E/NA | Model Number | Point to Point | Mandatory | Optional | Retrieves manufacturer-defined tag |
| | | | | | model number |
| 0x60/0xE0 | Read/Write Memory | Point to Point | Mandatory | Optional | Reads and writes user memory |
| NA/0x95 | Set Password | Point to Point | Mandatory | Optional | Sets tag password (4 bytes long) |
| NA/0x97 | Set Password Protect | Point to Point | Mandatory | Optional | Engages/disengages password protection |
| | Mode | | | | |
| NA/0x96 | Unlock | Point to Point | Mandatory | Optional | Unlocks password protected tag |
| 0x70/NA | Read Universal Data | Point to Point | Mandatory | Mandatory | Reads the Universal Data Block |
| | Block | | | | |
| 0x26 + 0x01 | Table Create | Point to Point | Mandatory | Optional | Creates a database table |
| 0x26 + 0x02 | Table Add Records | Point to Point | Mandatory | Optional | Prepares to add new records to the |
| | | | | | specified database table |
| 0x26 + 0x03 | Table Update Records | Point to Point | Mandatory | Optional | Prepares to modify the specified table |
| | | | | | records |
| 0x26 + 0x04 | Table Update Fields | Point to Point | Mandatory | Optional | Prepares to update the specified fields of |
| | | | | | a table record |
| 0x26 + 0x05 | Table Delete Record | Point to Point | Mandatory | Optional | Deletes existing record from the existing |
| | | | | | database table |
| 0x26 + 0x06 | Table Get Data | Point to Point | Mandatory | Optional | Prepares to retrieve the specified table |
| | | | | | records |
| 0x26 + 0x07 | Table Get Properties | Point to Point | Mandatory | Optional | Gets total number of records and the |
| | | | | | maximum number of records the table |
| | | | | | can hold |
| 0x26 + 0x08 | Table Read Fragment | Point to Point | Mandatory | Optional | Retrieves a block of data from a table as |
| | | | | | initiated by the Table Get Data command |
| 0x26 + 0x09 | Table Write Fragment | Point to Point | Mandatory | Optional | Writes a block of data into a table as |
| | | | | | initiated by the Table Add Records, Table |
| | | | | | Update Records, or Table Update fields |
| | | | | | command |
| 0x26 + 0x10 | Table Query | Broadcast or | Mandatory | Optional | Initiates table search based on the |
| | | Point to Point | | | specified criteria |
| 0xE1/NA | Beep ON/OFF | Point to Point | Mandatory | Optional | Turns tag's beeper ON or OFF |
| 0x8E | Delete Writeable Data | Point to Point | Mandatory | Optional | Deletes all allocated writeable data on a |
| | | | | | tag |

As discussed above, the RFID protocols utilized in RFID application layer 210 define a set of applications. PHY layers 218 and MAC layers 216 are separated from the RFID application layer 210 such that RFID packets are transmitted as at least part of the payload of MAC layer 216. This separation of RFID application layer 210 from PHY layer 218 and MAC layer 216 allows for the execution of the RFID application over other protocols, for example over IEEE 802.15.4, IEEE 802.11, Bluetooth, or over any other cellular wireless data MAC/PHY protocols. The RFID application layer, which may utilize the 18000-7 RFID protocol, relies on the MAC/PHY protocols to create and synchronize with the network.

As further discussed above, the RFID application layer 210, in addition to being transported directly through MAC layer 216, can run on IP transport layers 212 such as TCP or UDP, which itself runs on Network layers 214 such as IPv4 and IPv6 protocols. Additionally, MAC layer 216 can be separated into MAC management services 304 that is consistent with the RFID wakeup protocol and the MAC data services 302 that employs IEEE 802.15.4 or IEEE 802.11 protocols. Similarly, PHY layer 218 includes PHY management services 308 that operates according to the RFID wakeup protocol and PHY data services 306 that employs IEEE 802.15.4 or IEEE 802.11 protocols.

As indicated above, RFID devices 110 and gateway devices 130 according to embodiments of the present invention implement at least PHY layer 218, MAC layer 216, and Application Layer 210. Utilization of Transport layer 212, Network layer 214, and LLC 220 is optional and utilized when the higher frame sizes can be tolerated.

Further details regarding different layers of the protocol layering in some embodiments are provided below. In some embodiments, RFID devices 110 and devices 130 shown in FIGS. 1A, 1B, 1C, and 1D operate according to the ISO 18000-7 Mode 2 RFID standard (the Mode 2 standard) is described in U.S. patent application Ser. No. 12/893,790, entitled “Apparatus and Method for Advanced Communication in Low-Power Wireless Application”, filed on Sep. 29, 2010, which is herein incorporated by reference in its entirety.

The ISO 18000-7 Mode 2 RFID Standard (the Mode 2 standard) specifies a physical layer that is not interoperable with that of the Mode 1 PHY, but it is similar enough that RF resources capable of generating the Mode 2 PHY can typically generate the Mode 1 PHY as well. Additionally, Mode 2 specifies provisions for coexistence with Mode 1 via configuration options that propagate through most layers of the stack.

TABLE 7

| Center | | Center | |
|---|---|---|---|
| Freq. Index | Center Frequency | Freq. Index | Center Frequency |
| 0x00 | 433.164 MHz | 0x01 | 433.272 MHz |
| 0x02 | 433.380 MHz | 0x03 | 433.488 MHz |
| 0x04 | 433.596 MHz | 0x05 | 433.704 MHz |
| 0x06 | 433.812 MHz | 0x07 | 433.920 MHz |
| 0x08 | 434.028₊ MHz | 0x09 | 434.136 MHz |
| 0x0A | 434.244 MHz | 0x0B | 434.352 MHz |
| 0x0C | 434.460 MHz | 0x0D | 434.568 MHz |
| 0x0E | 434.676 MHz | 0x0F | — |

Mode 2 uses the 433 MHz ISM Band, occupying 433.05 to 434.79 MHz. The formal Mode 2 spectrum extends from 433.056 to 434.784 MHz, organized into channels. Each channel is defined by an index specifying its center frequency and an index specifying its bandwidth. Any given device 110 may, at any given time, permit communication on any combination of supported channels. Optimal practice, however, is to minimize the usage of overlapping channels within a single network environment 100. Channel center frequencies are indexed pursuant to Table 7. Channel identification includes the channel frequency index.

Channel bandwidths are indexed according to Table 8 below. Channel identification includes the channel bandwidth index. The Channel Bandwidth Index also stipulates the type of modulation and symbol rate the identified channel utilizes.

TABLE 8

| Bandwidth | | | | |
|---|---|---|---|---|
| Index | Channel Bandwidth | Modulation | Symbol Rate | |
| 0x00 | 0.432 MHz | FSK-1.8 | 55.555 | kHz |
| 0x01 | 0.216 MHz | FSK-1.8 | 55.555 | kHz |
| 0x02 | 0.432 MHz | FSK-0.5 | 200 | kHz |
| 0x03 | 0.648 MHz | FSK-0.5 | 200 | kHz |
| 0x04 | 0.108 MHz | MSK (Narrow | 31.25 | kHz |
| | | band) | | |
| 0x05 | 0.540 MHz | MSK (Wide | 250 | kHz |
| | | band) | | |

Channel usage and modulation type can be indicated by a Base Channel ID. Each Base Channel ID is a one byte concatenation of the Channel Bandwidth Index (upper nibble) and Channel Center Frequency Index (lower nibble). Base Channel IDs are grouped into Channel Classes. If a Device Class optionally supports a Channel Class, it shall either support all or none of the included Channel IDs. In some embodiments, channel FF can be reserved. Channel FF may be used as a “wildcard” in scan and beacon sequence lists, where it resolves to

TABLE 9

| Channel | | | | | |
|---|---|---|---|---|---|
| ID | Chan Class | Gateway | Subcont. | Endpoint | Blinker |
| 0x00 | Base | Mandatory | Mandatory | Mandatory | Mandatory |
| 0x01 | Legacy | Optional | Optional | Optional | Optional |
| 0x10 | Normal | Mandatory | Mandatory | Optional | N/A |
| 0x12 | | | | | |
| 0x14 | | | | | |
| 0x16 | | | | | |
| 0x18 | | | | | |
| 0x1A | | | | | |
| 0x1C | | | | | |
| 0x1E | | | | | |
| 0x21 | Hi-Rate | Mandatory | Mandatory | Optional | N/A |
| 0x23 | | | | | |
| 0x25 | | | | | |
| 0x27 | | | | | |
| 0x29 | | | | | |
| 0x2B | | | | | |
| 0x2D | | | | | |
| 0x32 | Blink | Optional | Optional | Optional | Optional |
| 0x3C | | | | | |
| 0x3D- | Narrow- | Optional | Optional | Optional | N/A |
| 0x4B | Band | | | | |
| 0x4B- | Wide-Band | Mandatory | Mandatory | Optional | N/A |
| 0x4D | | | | | |
| 0xFF | Reserved | — | — | — | — |

the channel on which device 110 has most recently completed a dialog. Mode 2 supports only certain Channel IDs, as shown in Table 9.

The Physical Layer Channel ID is a logically OR'ed combination of (0x00 OR Base Channel ID), if no optional encoding is used, and (0x80 OR Base Channel ID) if an optional encoding is used. Currently there is only one optional encoding. Channel expansion may occur by adding new center frequencies to currently supported channel bandwidths, or alternatively by adding new channel bandwidths.

Channel Classes specify the data rates, message modulation types, passband requirements, and stopband requirements for each Mode 2 channel Channels in a given class may also participate in a CSMA process prior to transmission. The channel classes can include a base class, a legacy class, a normal class, a hi-rate class, a blink class, a wide-band class, and a narrow band class. All mode 2 devices 110 include support for the base channel class. The legacy class is a mode 1 legacy channel. The normal class is a multi-channel variant of the base class. The hi-rate class is a high data rate variant of the normal class. The blink class is a high data rate beacon-only channel class. The wide band class is the maximum data rate variant of the normal class channels. The narrow-band class is the low data rate variant of the normal class channels.

Table 10 provides an example of the physical specifications for the modulation classes. Table 11 provides additional physical specifications by modulation class as discussed above.

TABLE 10

| Specification | Min | Typ | Max | Units |
|---|---|---|---|---|
| Subcarrier Frequency Deviation | ±49 | ±50 | ±51 | kHz |
| Carrier Frequency Deviation | −12 | 0 | +12 | kHz |
| Data Rate Deviation | −2% | 0 | +2% | |
| Peak to Channel-Stopband | 30 | | | dB |
| Attenuation | | | | |
| EIRP at Channel-Stopband | −40 | | | dBm |
| EIRP at Neighboring Channel- | −60 | | | dBm |
| Stopband | | | | |
| Passband EIRP | | 0 | | dBm |

TABLE 11

| | | | Carrier | | |
|---|---|---|---|---|---|
| Channel | Optional | | Sense Min | 1% BER□Min | Passband |
| Class | Encodings | CSMA | Sensitivity | Sensitivity | Max EIRP |
| Base | None | Optional | −110 dBm | −90 dBm | 0 dBm |
| Legacy | None | Optional | −110 dBm | −90 dBm | None |
| Normal | All | Mandatory | −110 dBm | −90 dBm | None |
| Hi-Rate | All | Mandatory | −100 dBm | −80 dBm | None |
| Blink | None | Optional | −100 dBm | −80 dBm | 0 dBm |
| Wide- | None | Optional | TBD | TBD | TBD |
| Band | | | | | |
| Narrow- | None | Optional | TBD | TBD | TBD |
| Band | | | | | |

Certain channel classes use a wideband Frequency Shift Keying (FSK) modulation, which in accordance with the Mode 2 standard is 55.555 kS/s and uses a nominal modulation index of 1.8. Transmission filtering may be utilized to meet the stopband requirements for a given Channel Class. In 2-FSK type of modulation, the frequency deviation can be ±50 kHz so that a symbol “0” or low is transmitted at a frequency of the carrier-50 kHz and a symbol “1” or high is transmitted at a frequency of the canier+50 kHz. The typical symbol rate is 55.555 kHz. The transmission is received by 2-FSK receivers. If a filter is utilized, the filter should not reduced the detectable Signal to Noise Ratio (SNR) over that of 2-BFSK by more than about 3 dB. If gaussian pulse shaping is utilized (i.e. GFSK), the bandwidth-time product of the gaussian filter should be in the range of about 0.5 to 1.0.

Certain channel classes use a narrowband FSK modulation, which in accordance with the Mode 2 standard is at a symbol rate of 200.00 kS/s and uses a nominal modulation index of 0.5. Transmission filtering may be utilized to meet the stopband requirements for a given Channel Class. Again, the modulation can be 2-FSK modulation with frequency deviation of ±50 kHz where the symbol “0” (Low) is at Carrier−50 kHz and the symbol “1” (High) is at Carrier+50 kHz. Transmission is receivable by 2-BFSK receivers. Any filter that is utilized should not decrease the detectable SNR over that of 2-BFSK by more than about 5 dB. If gaussian pulse shaping is utilized, the bandwidth-time product of the gaussian filter should be in the range of 0.5 to 1.0.

Certain channel classes use a Wide-Band Minimum Shift Key (MSK) modulation, which in accordance with the Mode 2 standard is at a symbol rate of 250 kS/s and uses a nominal modulation index of 0.5. Transmission filtering may be used to meet the stopband requirements for a given Channel Class. In accordance with the Mode-2 standard, the frequency deviation is ±62.5 kHz. Therefore, the symbol “0” (Low) is at a frequency of Carrier −62.5 kHz and the symbol “1” (High) is at a frequency of Carrier+62.5 kHz.

Certain channel classes use a Narrow-Band MSK modulation, which in accordance with the Mode 2 standard has a symbol rate of 31.25 kS/s and uses a nominal modulation index of 0.5. Transmission filtering may be utilized to meet the stopband requirements for a given Channel Class. In accordance with the mode-2 standard, the frequency deviation for Narrow Band MSK is ±7.8125 kHz. Therefore, the symbol “0” (Low) is transmitted at the frequency of Carrier−7.8125 kHz and the symbol “1” (High) is transmitted at the frequency of Carrier+7.8125 kHz.

In accordance with the Mode 2 standard, the Base Channel Class permits a single channel using Mode 2 FSK-1.8 Modulation. The channel center frequency is always 433.920 MHz, the channel bandwidth 432 kHz, and Carrier Sense Multiple Access with Collision Avoidance (CSMA-CA) is optional.

The Legacy Channel Class provides for a single channel using the Mode 1 modulation method, which is described in the Mode 1 air interface specification, over a 432 kHz channel centered on 433.920 MHz. Via this channel class, devices that use the Mode 2 MAC, Data, and Protocol layers, may communicate with Mode 1 devices while still abiding by all Mode 2 system requirements.

The Normal Channel Class provides for up to eight concurrent channels, using Mode 2 FSK-1.8 Modulation on even-spaced Channel Center Frequency Indices. The Channel Bandwidth is 216 kHz. CSMA-CA is required prior to transmission.

The Hi-Rate Channel Class permits up to four concurrent channels, using Mode 2 FSK-0.5 Modulation on odd-spaced Channel Center Frequency Indices. The Channel Bandwidth is always 432 kHz. CSMA-CA is required prior to transmission.

The Blink Channel Class according to the mode-2 standard permits up to two concurrent channels, using Mode 2 FSK-0.5 Modulation. The Channel Bandwidth is always 648 kHz. CSMA is optional, prior to transmission.

The Super Channel Class permits up to three concurrent channels, using Mode 2 high data rate MSK Modulation. The Channel Bandwidth is always 540 kHz. CSMA is optional, prior to transmission.

The Blink Channel Class permits up to fifteen concurrent channels, using Mode 2 low data rate MSK Modulation. The Channel Bandwidth is always 108 kHz. CSMA is optional, prior to transmission.

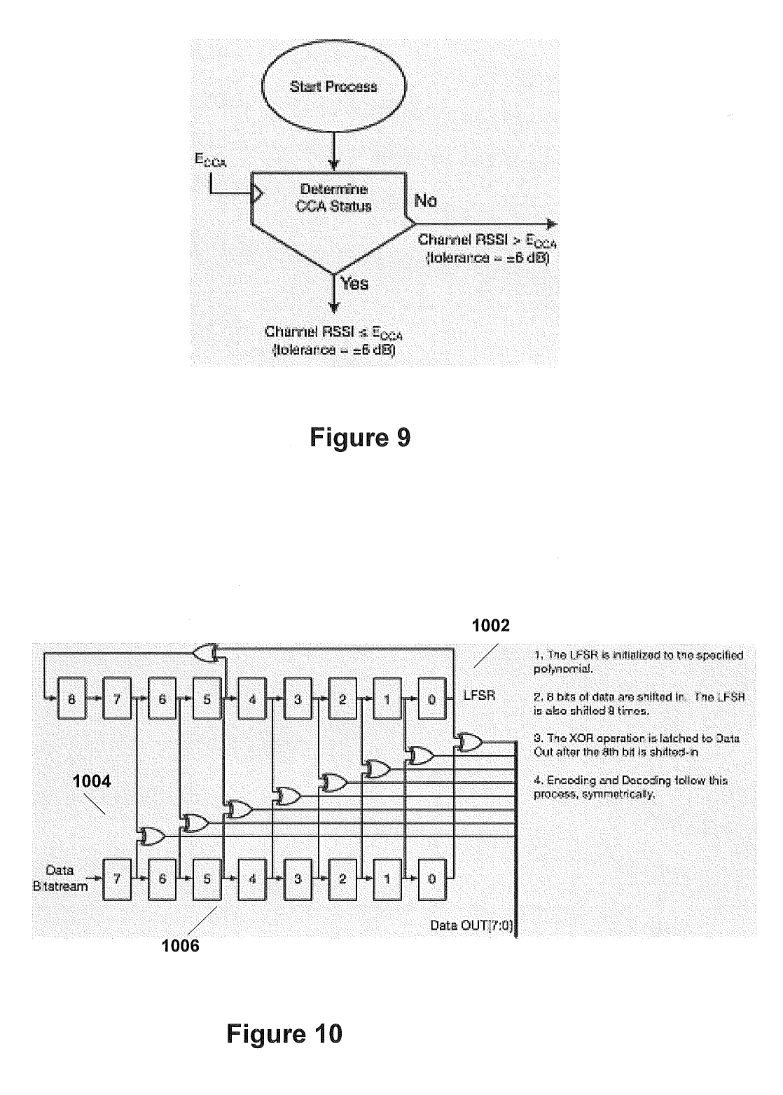

Certain Channel Classes in the mode-2 standard utilize a CSMA routine prior to transmission of data over the channel, and for other classes the CSMA routine is optional. Upper layers of the specification, particularly the Data Link Layer and Transport Layers, describe the processes that utilize CSMA and Collision Avoidance models (CSMA-CA). All CSMA-CA processes, however, are based on the common, inner-loop CCA process illustrated in FIG. 9.

Messages transmitted or received over Mode 2 Channel Classes are comprised of binary symbols. The symbols are encoded by one of two methods supported by the Mode 2 standard, or, in the case of application to the Mode 1 standard data trafficked on the Legacy Channel, by the one encoding method specified by Mode 1. The goal of symbol encoding in Mode 2 is to provide a statistically DC-Free datastream, while maximizing throughput efficiency.

Two encodings are available, one that emphasizes simplicity and data rate (PN9) and another that emphasizes data integrity in mid-to-low SNR environments (FEC). When using the Channel Classes that support multiple encodings, Normal and Hi-Rate, it is the duty of the upper layers (e.g., MAC layer 216, network layer 214, or transport layer 212) to configure the encoder and decoder as needed, to utilize one of these two methods.

A PN9 encoder is illustrated in FIG. 10. The final stage of all encoding methods is the use of PN9 encoding, as described below. Likewise, the first stage of all decoding is the same PN9 method. Sometimes referred to as “data whitening,” PN9 encoding is a full-rate, statistically DC-free encoding that offers no encoding gain. Encoding and decoding require the use of a Linear Feedback Shift Register (LFSR) 1002 and a seed polynomial (for example 11111111) to produce a predictable sequence of pseudo-random values that are XOR'ed 1004 with the datastream 1006. The PN9 polynomial is always initialized to the following value: x⁸+x⁷+x⁶+x⁵+x⁴+x³+x²+x¹+x⁰. In accordance with the Mode-2 standard, all Channel Classes support communication via PN9 Encoding.

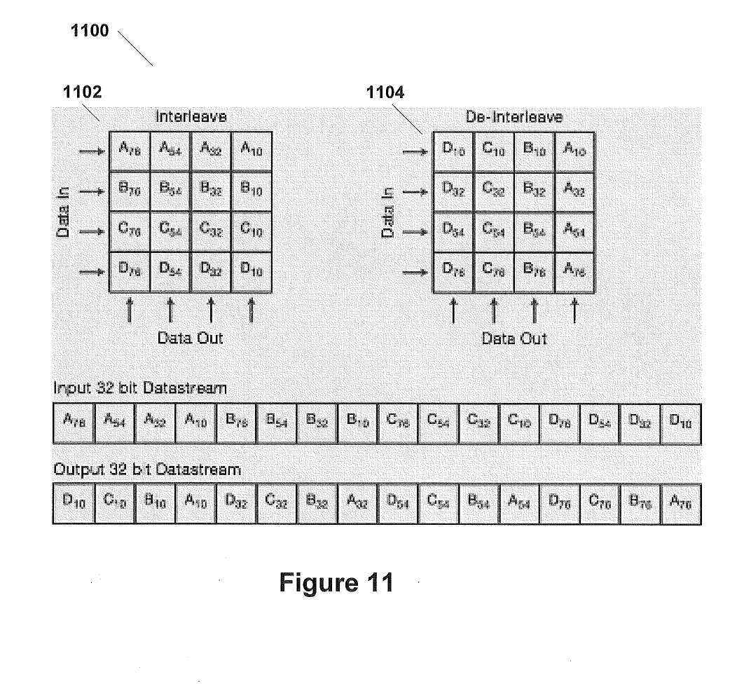

FIG. 11 illustrates a Forward Error Correction (FEC) encoder 1100 utilized in the ISO 18000-7 mode 2 standard. Forward error correction (FEC) is an optional encoding method. The technique used is a non-recursive convolutional code followed by 4×4 matrix interleaver 1102. FIG. 11 also illustrates the 4×4 matrix de-interleaver 1104. Mode 2 FEC Encoding is chiefly designed to improve bit error rates at mid-to-low SNR environments and less-so to improve decodability near the SNR limit (i.e. communications range). By virtue of its use of the 433 MHz band, the Mode 2 air interface already has sufficient propagation performance for all intended applications. To this end, the interleaved convolutional code performs better than most, if not all, other methods.

The first stage of the encoder and second stage of the decoder is the computation of a convolutional code from the non-encoded data. The code is a ½ rate convolutional code, using a specific algorithm of constraint length=4 and polynomial (13, 17). As the input to the interleaves is 32 bit aligned, the convolutional code trellis terminator appended to the unencoded data is 0x0B0B for even-length byte input and 0x0B for odd length byte input. Decoding may be accomplished by a variety of means, although the Viterbi algorithm is the preferred and expected method for decoding the convolutional codes. Encoded data is always 32 bit aligned.

The second stage of the encoder, as is shown in FIG. 11, and the first stage of the decoder is a matrix interleave/deinterleave process, which is designed to separate adjacent data so that bursty data errors can be more effectively treated by the convolutional code error corrector.

In accordance with the mode-2 standard, data trafficked on Mode 2 Channels is in the form of Mode 2 Packets. Mode 2 Packets include an RFID application header 720 that includes a Preamble, Sync Word, and Payload Length. The Mode 2 packet also includes a Payload 722 and CRC 706. As shown in Table 12, the Preamble is a series of 32 binary symbols, 10101 . . . used for the purpose of calibrating data rate circuits on the receiver. The Sync Word is a block of 16 binary symbols, chosen for excellent auto-correlation properties, and it is used to align the frame. The Payload Length is a 7-symbol value that contains the length of the Payload field. The Payload contains encoded data. Additionally, power ramp-up and ramp-down periods may precede and follow the packet. These periods should be kept as short as possible, and used only for the purpose of meeting the channel stopband requirements.

TABLE 12

| | Sync | Payload | | |
|---|---|---|---|---|
| Preamble | Word | Length | Payload 722 | CRC |
| 32 symbols | 16 | 7 | 0-127 bytes | 16 |
| | symbols | symbols + | | symbols |
| | | 1 reserved | | |

As discussed above, Mac layer 216 adds a packet that includes a MAC header 708 and MAC payload 710. MAC sub-layer 216 handles access to the physical radio channel through PHY layer 218 and is responsible for the following tasks: Generating network beacons if device 110 is a gateway or subcontroller; Synchronizing to network beacons; Supporting network association and disassociation; Supporting device security; Employing appropriate mechanism for channel access; Providing a reliable link between two peer MAC entities; Employing data whitening (PN9 coding); Employing optional Forward Error Correction Coding; Providing management utility to access PHY layer 218 and layers above the MAC layer 216 (see FIGS. 2A, 3A, and 6).

Accordingly, the MAC frame (header 708 and payload 710) format performs the following: support the clear separation of the higher protocol layers from the MAC layer, support encapsulation of any network layer protocol (e.g. IPv4, 6LowPAN/IPv6) in the MAC; support direct encapsulation of the Application layer; Allows various forms of addressing to be deployed. Each MAC frame includes the following basic components: A header (MHR), which includes frame control, sequence number, address information, and security related information; A MAC payload 710, of variable length, which contains information specific to the frame type; and A MFR that contains a FCS. Acknowledgment frames may not contain payload 710.

A MAC frame 700 can include the PHY Header 702, MAC Header 708, MAC Payload 710, and CRC 706 as shown in FIG. 7B. Further, the frame structure can be adopted from the IEEE 802.15.4e standard. Data provided here is shown for example purposes only. The IEEE 801.15.4e standard can be consulted for more information.

An example of MAC header 708 is illustrated in Table 13. A MAC signature field, which is part of PHY header 702, contains information that specifies the type of MAC frame and the usage of other fields within MAC frame header 708. The Sequence Number field is an incrementing value that is unique for each and every MAC frame. MAC frame header 708 contains a minimum of zero and a maximum of four of address fields: Source Address, Destination Address, Source Network Address, and Destination Network Address. If all address fields in MAC Header are suppressed, alternate addresses must be provided in either Information Elements field or in Payload 710. The Security field is present if the Security bit is a value of 1 in the Frame Signature field. The Information Elements field is used to encapsulate frame specific data. Devices 110 can accept or discard a particular element if the element ID is unknown. The MAC Payload field 710 contains the encapsulated data specific for the MAC frame type. Optionally, application data can be tunneled through any of the network layer 214 and transport layer 212 protocols.

TABLE 13

| | | Dest. | Destina- | Source | | | |
|---|---|---|---|---|---|---|---|
| Frame | Sequence | Network | tion | Network | Source | Security | Information |
| Control | Number | Identifier | Address | Identifier | Address | Header | Elements |
| ½ bytes | 1 byte | 0/2 | 0/1/2/8 | 0/2 | 0/1/2/8 | 0/10/14 | Variable |
| | | | bytes | | bytes | bytes | |

FIG. 7C illustrates a frame 700 that encapsulates network header 712 and network payload 714. Table 14 below illustrates the MAC data frame with LLC 120 and Network layers 212 included. Network Frame Control defines what fields are included in MAC payload 710. Network Frame Type defines what kind of higher layer addressing is used (LLC, network, transport) and if Application Data is present

TABLE 14

| MAC Header 708 | MAC Payload 710 | | | |
|---|---|---|---|---|
| Table 13 | Network | Network | Network | Application |
| | Frame | Frame Type | Addressing | Data |
| | Control | (optional) | (optional) | (optional) |

The Frame Control field is utilized to define all packet types, security enable/disable, ACK request and addressing types. Table 15 illustrates the bit identification in one embodiment of Frame control field. The Frame Type field indicates the type of MAC frame. The following frames can be defined: Beacon Frame; Data Frame; Command Frame; Acknowledgement Frame; Low Latency Frame; and Short Frame.

TABLE 15

| Bit: | | | | | | | | | | |
|---|---|---|---|---|---|---|---|---|---|---|
| 0-2 | 3 | 4-5 | 6-7 | 8 | 9-10 | 11 | 12 | 13 | 14 | 15 |
| Frame Type | Long | Dest. | Src. | Net. | Sec. | Frame | Ack | IEs | Seq. # | Reserved |
| | Frame | Mode | Mode | ID | | Pending | Req. | | Suppr. | |

Beacon Frames are sent by Network Coordinator 180 to synchronize network devices and advertise network capabilities. A coordinator 180 (which may be one of devices 110) can transmit network beacons in a beacon-enabled PAN. MAC payload 710 contains the superframe specification: GTS fields, pending address fields, and beacon payload. MAC payload 710 is prefixed with a MAC header (MHR) 708 and appended with a MAC footer (MFR). The MHR 708 contains the MAC Frame Control field, beacon sequence number (BSN), addressing fields, and optionally the auxiliary security header. The MFR contains a 16-bit frame check sequence (FCS). The MHR, MAC payload, and MFR together form the MAC beacon frame (i.e., MPDU).

The MAC beacon frame is then passed to the PHY as the PHY service data unit (PSDU), which becomes the PHY payload. The PHY payload is prefixed with a synchronization header (SHR), containing the Preamble Sequence and Start-of-Frame Delimiter (SFD) fields, and a PHY header (PHR) containing the length of the PHY payload in octets. The SHR, PHR, and PHY payload together form the PHY packet 700 (i.e., PPDU) as illustrated in FIG. 7B.

A data Frame is a general purpose frame sent to exchange data between two devices 110. The payload of a data frame includes the sequence of octets that the next higher layer has requested the MAC sub-layer to transmit. The data payload is passed to the MAC sublayer and is referred to as the MAC service data unit (MSDU). The MAC payload is prefixed with an MHR and appended with an MFR. The MHR contains the Frame Control field, data sequence number (DSN), addressing fields, and optionally the auxiliary security header. The MFR includes a 16-bit FCS. The MHR, MAC payload, and MFR together form the MAC data frame, (i.e., MPDU). The MPDU is passed to the PHY as the PSDU, which becomes the PHY payload 704. The PHY payload 704 is prefixed with an SHR 702, containing the Preamble Sequence and SFD fields, and a PHR containing the length of the PHY payload in octets. The preamble sequence and the data SFD enable the receiver to achieve symbol synchronization. The SHR, PHR, and PHY payload together form the PHY packet, (i.e., PPDU).

With regard to the Command Frame, the MAC payload 710 includes the Command Type field and the command payload. The MAC payload 710 is prefixed with an MHR and appended with an MFR. The MHR contains the MAC Frame Control field, DSN, addressing fields, and optionally the auxiliary security header. The MFR contains a 16-bit FCS. The MHR, MAC payload, and MFR together form the MAC command frame, (i.e., MPDU).

The MPDU is then passed to PHY layer 218 as the PSDU, which becomes the PHY payload 704. The PHY payload 704 is prefixed with an SHR, containing the Preamble Sequence and SFD fields, and a PHR containing the length of the PHY payload 704 in octets. The preamble sequence enables the receiver to achieve symbol synchronization. The SHR, PHR, and PHY payload together form the PHY packet, (i.e., PPDU).

The following Commands for the command field can be defined: an Association Request is sent by un-associated device 110 when it wants to associate with the network; an Association Response is generated by a device 110 that controls the network and that can accept or reject the association request; a Disassociation Notification is sent by a device 110 that wants to terminate its association with the network; a Data Request is sent by a device 110 that wants to send unsolicited data to other network device; a Personal Area Network (PAN) ID Conflict Notification is sent by a device 110 to the network coordinator 180 when a Network identifier conflict is detected; an Orphan Notification command is used by an associated device 110 that has lost synchronization with its coordinator 180; a Beacon Request Command is used by a device 110 to locate all coordinators 180 within its radio communications range during an active scan; a GTS Request Command is used by an associated device 110 that is requesting the allocation of a new Guaranteed Time Slot or the deallocation of an existing GTS from the PAN coordinator 180; and a Wakeup Request that is transmitted as a sequence of back-to-back frames to alert sleeping devices 110 to wakeup and synchronize with the network. The Wakeup Request is similar to a Beacon frame except Wakeup frames are intended for devices 110 not yet connected to the network.

An Acknowledgement Frame is sent either in response to a received Data Request Command or in response to receiving a Data Frame or a Command Frame. The MAC acknowledgment frame is constructed from an MHR and an MFR; it has no MAC payload 710. The MHR contains the MAC Frame Control field and DSN. The MFR is composed of a 16-bit FCS. The MHR and MFR together form the MAC acknowledgment frame (i.e., MPDU). The MPDU is passed to the PHY layer 218 as the PSDU, which becomes the PHY payload 704. The PHY payload 704 is prefixed with the SHR, containing the Preamble Sequence and SFD fields, and the PHR containing the length of the PHY payload in octets. The SHR, PHR, and PHY payload together form the PHY packet 700, (i.e., PPDU). The Sequence Number field includes the value of the sequence number received in the frame for which the acknowledgment is to be sent.

A Blink Frame is a periodic transmission from active RFID/RTLS tags 110 that is received by an RFID reader infrastructure. The Blink frame is of minimal size to make its transmission require the lowest amount of energy and to give maximum battery life to RFID/RTLS tags. The MHR for a blink frame typically only contains a 1-octet, Frame Control Field, the Sequence Number Field, and the Source Address field. The Blink frame provides a mechanism for a device 110 to communicate its ID (i.e. the EUI-64 Source Address) and/or an alternate ID (in payload), and optionally additional payload data to other devices without prior association and without an acknowledgment. The Blink frame can be used by “transmit only” devices 110 to co-exist within a network, utilizing the Aloha protocol. Any devices 110 that are not interested in the Blink frame have an opportunity to reject the frame at an early stage during frame processing and not burden the MAC layer 216 or higher communication layers with this, potentially high volume, data traffic.

A Wake-up frame is used by a network coordinator 180 to wake up a specific device 110. A Wake-up frame includes the Frame Control field, the Sequence Number field, Destination Network ID, and Destination Address field.

Referring back to the control field illustrated in Table 15, if the long frame field is set to 1, then Frame Signature includes 2 bytes. If the long frame field is set to 0, then the Frame Signature is using only a single byte. The destination mode filed is a 2-bit field that specifies which kind of destination addressing is used (64-bit, 16-bit, 8-bit, O-bit). The source addressing mode filed is a 2-bit field that specifies which kind of source addressing is used (64-bit, 16-bit, 8-bit, 0-bit). The Network ID field, if set, indicates that Network ID addresses (source and destination) are not present in MAC Header 708. The security field is a 2-bit field that specifies if Security is used and, if it is, if an additional Security Header is present in MAC Header 708. The Frame pending field, if set, specifies that an additional frame will follow immediately after current frame. The Acknowledgment request field, if set, specifies that the sending device expects acknowledgement. The data elements present field (IEs), when set, specifies the presence of Data Elements field in MAC Header 708. The Sequence Number Suppressed field, when set, specifies that that sequence number in MAC Header 708 is not present.

Application Data can be routed through any of the network layer 216 and transport layer 218 protocols. This is accomplished by setting Network Protocol type to the appropriate protocol, including the LLC, network, and transport headers within the Mac Payload field, preceding the application data (see Table 14). In this scenario the LLC protocol type will specify network layer 216 protocol such as 6LowPAN, IPv4, etc. The network layer 216 will then specify the transport 218 layer protocol such as TCP or UDP. Finally, the transport layer 218 protocol will specify the port number for the application. Note that inclusion of these protocol headers within the MAC frame may increase the size of the frame significantly, so this can be used if either the MAC frame size is big enough or if the IP (Internet Protocol) connectivity is being utilized. To reduce the MAC frame size, the 6LowPan can be used with compression. This is a standard method for encapsulation of network layer 216 and transport layer 218 protocols. These protocols (802.11 LLC, 6LowPAN, IP, UDP, TCP, etc) are used as defined by their standards, and there is no need for modification of these protocols for support of embodiments of the present invention.

Each of devices 110 utilizes channel access to communicate with gateway devices 130 and other devices 110 that form the network of environment 100. Mechanisms for channel access include scheduling, contention based, and contention free access of the channel. Contention-based access allows devices to access the channel in a distributed fashion using a CSMA-CA back-off algorithm. In some cases, channel access can be defined within a superframe structure.

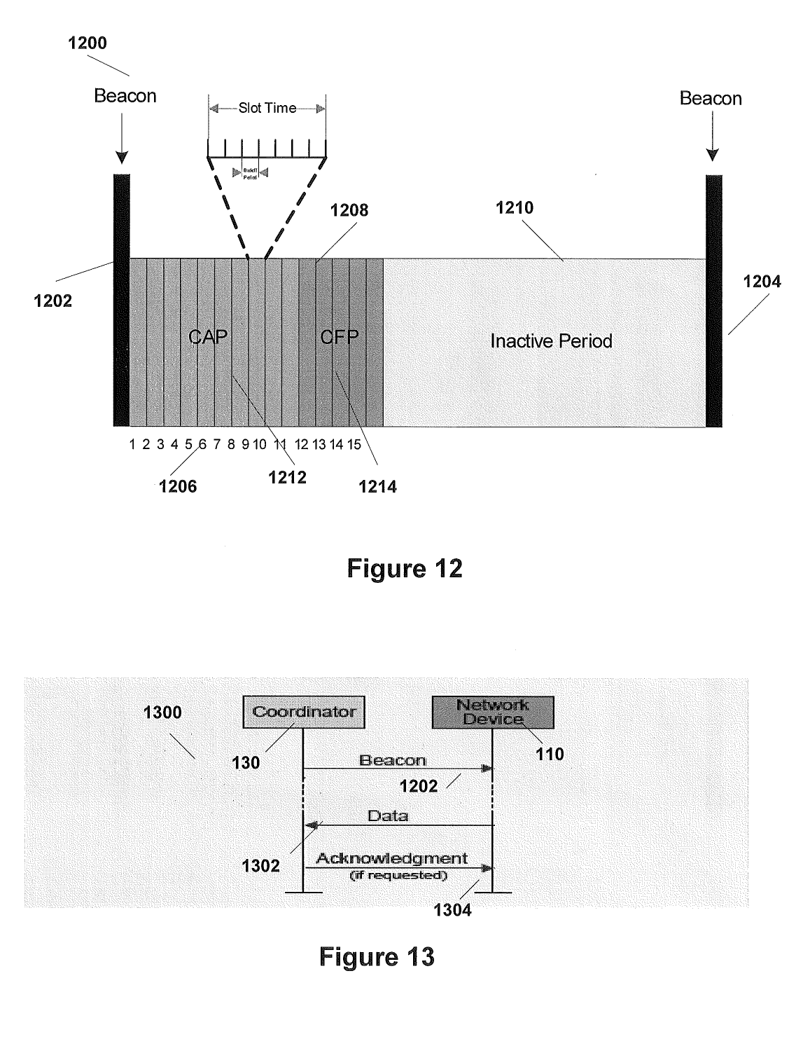

FIG. 12 illustrates an example superframe structure 1200. The format of superframe 1200 is defined by a coordinator 180, which may be gateway device 130 or other component of environment 100. Superframe 1200 is bounded by network beacons 1202 and 1204 sent by the coordinator 180 and is divided into equally sized slots 1206. Optionally, the superframe 1200 can have an active 1208 and an inactive portion 1210. The beacon frame 1202 is transmitted in the first slot of each superframe 1200. If a coordinator 180 does not wish to use a superframe structure 1200, it can turn off the beacon transmissions. The beacons 1202 and 1204 are used to synchronize the attached devices 110, to advertize the capabilities of the network environment 100, and to describe the structure of the superframes 1200.

For low-latency applications or applications requiring specific data bandwidth, the coordinator 180 may dedicate portions of active superframe 1208 to that application. These portions are called guaranteed time slots (GTSs). The GTSs form the contention-free period (CFP) 1212, which appear at the end of the active superframe starting at a slot boundary immediately following the contention access period (CAP) 1214.

For networks supporting beacons, synchronization is performed by receiving and decoding the beacon frames 1202 and 1204. For networks not supporting beacons, synchronization is performed by polling the coordinator 180 for data.

The Contention Access Period (CAP) 1212 starts immediately following beacon 1202 and completes before the beginning of the Contention Free Period (CFP) 1214 on a superframe slot boundary. If the CFP 1214 is zero length, the CAP 1202 completes at the end of the active portion 1212 of the superframe 1200. The CAP 1212 is at least aMinCAPLength symbols, unless additional space is needed to temporarily accommodate the increase in the beacon frame length needed to perform GTS maintenance, and shall shrink or grow dynamically to accommodate the size of the CFP 1214.

Frames, except acknowledgment frames and any data frame that quickly follows the acknowledgment of a data request command, transmitted in the CAP 1212 use a slotted CSMA-CA mechanism to access the channel. A device 110 transmitting within the CAP 1212 ensures that its transaction is complete (i.e., including the reception of any acknowledgment) one IFS period before the end of the CAP 1212. If this is not possible, the device 110 shall defer its transmission until the CAP 1212 of the following superframe 1200. MAC command frames can always be transmitted in the CAP 1212.

The CFP 1214 starts on a slot boundary immediately following the CAP 1212 and completes before the end of the active portion 1208 of the superframe 1200. If any GTSs have been allocated by the PAN coordinator 180, they will be located within the CFP 1214 and occupy contiguous slots. The CFP 1214 shall therefore grow or shrink depending on the total length of all of the combined GTSs. No transmissions within the CFP use a CSMA-CA mechanism to access the channel. A device 110 transmitting in the CFP 1214 ensures that its transmissions are complete one IFS period before the end of its GTS.

In accordance with the mode-2 standard, three types of data transfer transactions exist. The first one is the data transfer to a coordinator 180 in which a device 110 transmits the data. The second transaction is the data transfer from a coordinator 180 in which the device 110 receives the data. The third transaction is the data transfer between two peer devices 110. In star topology, only two of these transactions are used because data may be exchanged only between the coordinator 180 and a device 110. In a peer-to-peer topology, data may be exchanged between any two devices 110 on the network; consequently all three transactions may be used in this topology.

The mechanisms for each transfer type depend on whether the network supports the transmission of beacons or not. A beacon-enabled PAN is used in networks that either require synchronization or support for low latency devices 110, such as PC peripherals. If the network does not need synchronization or support for low-latency devices 110, it can elect not to use the beacon for normal transfers. However, the beacon is still utilized or network discovery.

FIG. 13 illustrates data transfer 1300 between a device 110 and a coordinator 180, which may be gateway device 130. When a device 110 wishes to transfer data to a coordinator 180 in a beacon-enabled PAN, it first listens for the network beacon 1200. When the beacon 1200 is found, the device 110 synchronizes to the superframe structure 1200. At the appropriate time, the device 110 transmits its data frame 1302, using slotted CSMA-CA, to the coordinator 180. The coordinator 180 may acknowledge the successful reception of the data by transmitting an optional acknowledgment frame 1304.

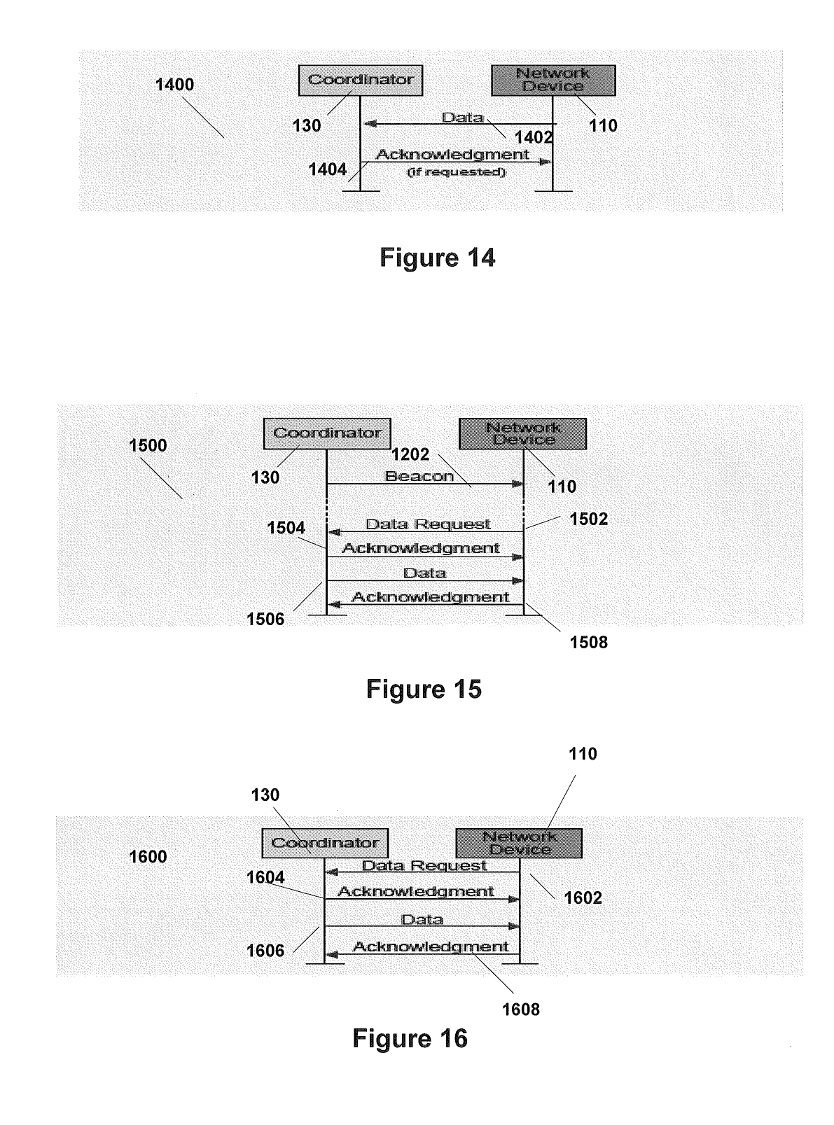

As illustrated in FIG. 14, when a device 110 wishes to transfer data in a nonbeacon-enabled PAN, it simply transmits its data frame 1402, using unslotted CSMA-CA, to the coordinator 180. The coordinator 180 acknowledges the successful reception of the data by transmitting an optional acknowledgment frame 1404. The transaction is now complete.

As shown in FIG. 15, when coordinator 180 wishes to transfer data to a device 110 in a beacon-enabled PAN, it indicates in the network beacon 1202 that the data message is pending. The device 110 periodically listens to the network beacon 1202 and, if a message is pending, transmits a MAC command 1502 requesting the data, using slotted CSMA-CA. The coordinator 180 acknowledges the successful reception of the data request by transmitting an acknowledgment frame 1504. The pending data frame 1506 is then sent using slotted CSMA-CA or, if possible, immediately after the acknowledgment frame 1504. The device 110 may acknowledge the successful reception of the data by transmitting an optional acknowledgment frame 1508. The transaction is now complete. Upon successful completion of the data transaction, the message is removed from the list of pending messages in the beacon.

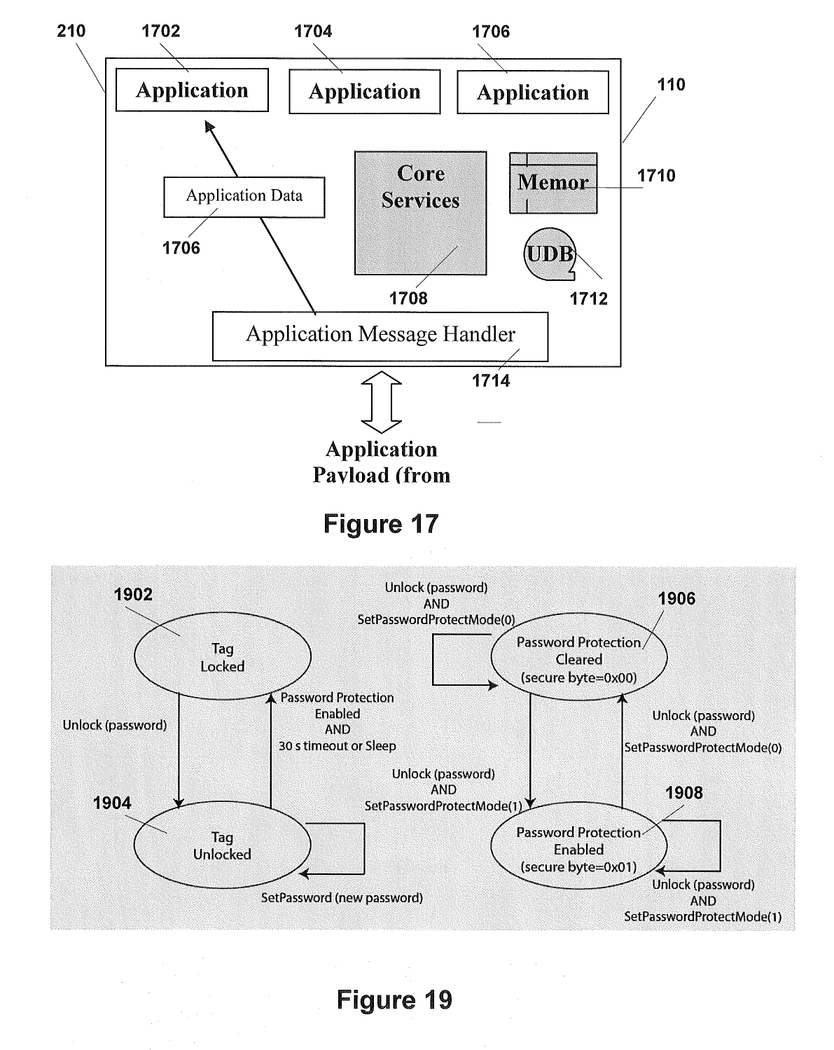

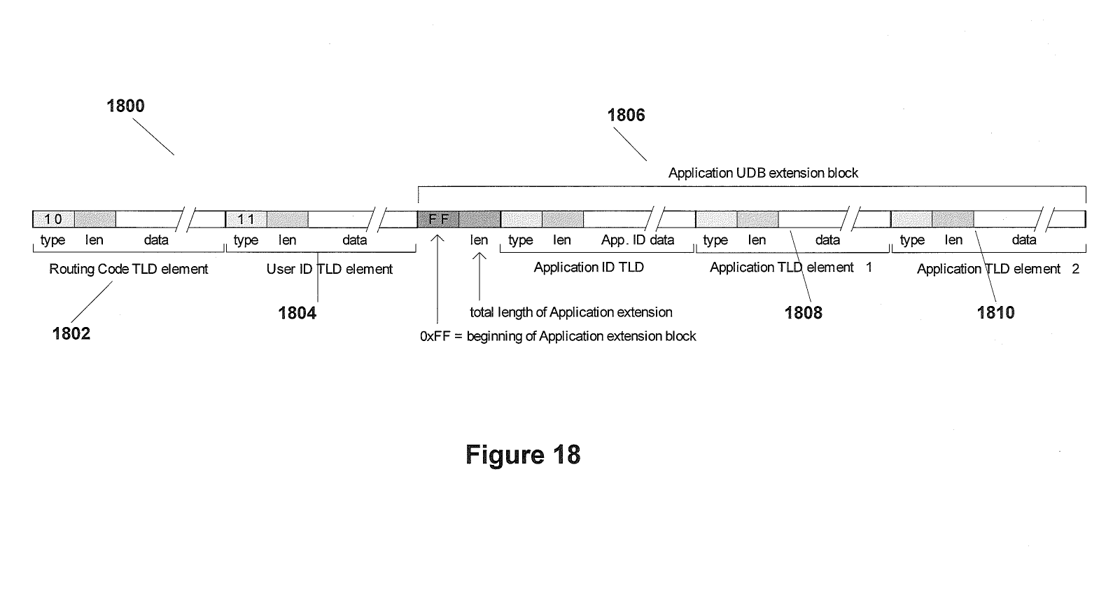

As illustrated in FIG. 16, when a coordinator 130 wishes to transfer data to a device 110 in a nonbeacon-enabled PAN, it stores the data for the appropriate device 110 to make contact and request the data. A device 110 may make contact by transmitting a MAC command 1602 requesting the data, using unslotted CSMA-CA, to its coordinator 180 at an application-defined rate. The coordinator 180 acknowledges the successful reception of the data request by transmitting an acknowledgment frame 1604. If a data frame is pending, the coordinator 180 transmits the data frame 1606, using unslotted CSMA-CA, to the device 110. If a data frame 1606 is not pending, the coordinator 180 indicates this fact either in the acknowledgment frame 1604 following the data request 1602 or in a data frame 1606 with a zero-length payload. If requested, the device 110 acknowledges the successful reception of the data frame by transmitting an acknowledgment frame 1608.

In a peer-to-peer PAN, every device 110 may communicate with every other device 110 in its radio sphere of influence. In order to do this effectively, the devices 110 wishing to communicate either receive constantly or synchronize with each other. In the former case, the device 110 can simply transmit its data using unslotted CSMA-CA. In the latter case, other measures are taken to achieve synchronization.

Two types of CSMA-CA channel access mechanism can be used, depending on the network configuration. CSMA-CA algorithm according to the Mode 2 standard can adhere to the IEEE 802.15.4-2006, Section 7.5.1.4, standard.

Nonbeacon-enabled networks use an unslotted CSMA-CA channel access mechanism. Each time a device 110 wishes to transmit data frames or MAC commands, it waits for a random period. If the channel is found to be idle, following the random backoff, the device 110 transmits its data. If the channel is found to be busy following the random backoff, the device 110 waits for another random period before trying to access the channel again. Acknowledgment frames are sent without using a CSMA-CA mechanism.

Beacon-enabled networks use a slotted CSMA-CA channel access mechanism, where the backoff slots are aligned with the start of the beacon transmission. The backoff slots of all devices 110 within one network are aligned to the coordinator 180 device 130. Each time a device 110 wishes to transmit data frames during the CAP 1212, it locates the boundary of the next backoff slot and then waits for a random number of backoff slots. If the channel is busy, following this random backoff, the device 110 waits for another random number of backoff slots before trying to access the channel again. If the channel is idle, the device 110 begins transmitting on the next available backoff slot boundary. Acknowledgment and beacon frames are sent without using a CSMA-CA mechanism.

An Aloha mechanism allows for transmission of unacknowledged and unassociated frames. In this case, devices 110 transmit data and do not receive an ACK. Also, devices 110 may receive data without acknowledging.

A successful reception and validation of a data or MAC command frame can be optionally confirmed with an acknowledgment. If the receiving device 110 is unable to handle the received data frame for any reason, the message is not acknowledged. If the originator device 110 does not receive an acknowledgment after some period, it assumes that the transmission was unsuccessful and retries the frame transmission. If an acknowledgment is still not received after several retries, the originator device 110 can choose either to terminate the transaction or to try again. When the acknowledgment is not required, the originator device 110 assumes that the transmission was successful.

A data or MAC command frame is sent with the Acknowledgment Request subfield (see Table 15) of its Frame Control field set appropriately for the frame. A beacon or acknowledgment frame can be sent with the Acknowledgment Request subfield set to zero. Similarly, any frame that is broadcast can be sent with its Acknowledgment Request subfield set to zero.

In order to detect bit errors, an FCS mechanism employing a 16-bit International Telecommunication Union-Telecommunication Standardization Sector (ITU-T) cyclic redundancy check (CRC) (as shown in FIG. 700 of FIG. 7A) is used to detect errors in every frame.

In some embodiments, MAC security is important. From a security perspective, wireless ad hoc networks are no different from any other wireless network. They are vulnerable to passive eavesdropping attacks and potentially even active tampering because physical access to the wire is not required to participate in communications. The very nature of ad hoc networks and their cost objectives impose additional security constraints, which perhaps make these networks the most difficult environments to secure. Devices 110 are low-cost and have limited capabilities in terms of computing power, available storage, and power drain; and it cannot always be assumed they have a trusted computing base or a high-quality random number generator aboard. Communications cannot rely on the online availability of a fixed infrastructure and might involve short-term relationships between devices 110 that may never have communicated before. These constraints might severely limit the choice of cryptographic algorithms and protocols and would influence the design of the security architecture because the establishment and maintenance of trust relationships between devices 110 need to be addressed with care. In addition, battery lifetime and cost constraints put severe limits on the security overhead these networks can tolerate, something that is of far less concern with higher bandwidth networks. Most of these security architectural elements can be implemented at higher layers and may, therefore, be considered to be outside the scope of this standard. Aspects of MAC security can be found in the IEEE802.15.4:2006 standard, which provides for MAC Layer security as defined in or derived from the ISO/IEC WD 29167-7 standard.

The cryptographic mechanism according to aspects of the Mode 2 standard is based on symmetric-key cryptography and uses keys that are provided by higher layer processes. The cryptographic mechanism assumes a secure implementation of cryptographic operations and secure and authentic storage of keying material. The cryptographic mechanism provides particular combinations of the following security services: Data confidentiality, which is assurance that transmitted information is only disclosed to parties for which it is intended; Data authenticity, which is assurance of the source of transmitted information (and, thereby, that information was not modified in transit); and Replay protection, which is assurance that duplicate information is detected.

The actual frame protection provided can be adapted on a frame-by-frame basis and allows for varying levels of data authenticity (to minimize security overhead in transmitted frames where required) and for optional data confidentiality. When nontrivial protection is required, replay protection can always provided.

Cryptographic frame protection may use a key shared between two peer devices 110 (link key) or a key shared among a group of devices 110 (group key), thus allowing some flexibility and application-specific tradeoffs between key storage and key maintenance costs versus the cryptographic protection provided. If a group key is used for peer-to-peer communication, protection is provided only against outsider devices and not against potential malicious devices 110 in the key-sharing group.

In accordance with the mode-2 standard, several wake-on mechanisms can be supported. These include UHF Wake on, LF Wake on, Sensor/Alarm wake on, and Additional wake on mechanisms.

As discussed above, any wireless protocols can be supported in MAC layer 216. This includes IEEE 802.15.4: 2006 and the newer IEEE 802.15.14e Draft. Several behaviors are provided in IEEE802.15.4e Draft for different industrial and other application domains and functional improvements compared to IEEE 802.15.4:2006. The different industrial and other application domains have quite different requirements that are often in conflict with each other such that the resulting solutions cannot be the same. That is the rationale for specifying more than one solution because there is more than one problem to solve. The intentions of these behaviors are to enhance and add functionality to the IEEE 802.15.4-2006 MAC to better support the industrial markets and permit compatibility with modifications being proposed within the Chinese WPAN. Industrial applications have requirements that are not adequately addressed by the IEEE 802.15.4-2006 standard such as low latency, robustness in the harsh industrial RF environment, and determinism. The Chinese Wireless Personal Area Network (CWPAN) standard has identified enhancements to improve network reliability and increase network throughput to support higher duty-cycle data communication applications.

The most recent draft of the IEEE 802.15.4e standard can be found at obtained from the IEEE (www.IEEE.org). The MAC enhancements provided by this standard are grouped into two categories: Industrial and other application domains such as Process automation, Factory automation and Additional functional improvements such as Low energy. The MAC enhancements for IEEE 802.15.4e include Time Slotted Channel Hopping (TSCH), e.g. for Process automation, see M.2 and M.6; Low Latency Deterministic Networks (LL), e.g. for Factory automation, see M.3; Distributed Synchronous Multi-Channel Extension (DSME), e.g. for Process automation and Commercial applications, see M.4; RFID Blink (RFID), e.g. For item and people identification, location, and tracking, see M.7; and Asynchronous Multi-Channel Adaptation (AMCA), see M.8. Additional functional improvements include Low Energy (LE), optional, see M.5; Enhanced Beacon request (EBR), optional, see M.6; Enhanced Security and Overhead Reduction (ESOR); MAC Performance Metrics (Metrics); Fast association (FastA); and Asynchronous Multi-Channel Adaptation (AMCA), see M.8. Only some of these enhancements are applicable to the RFID/wireless sensor networks. Some of these will be identified through a definition of use cases in of the Application Layer 212 Framework described below. Some of the enhancements, including RFID Blink, frame structure and LLC, are discussed above for the MAC layer 216 description.

FIG. 17 illustrates a more detailed diagram of application layer 210. Application layer 210 may include multiple applications, of which applications 1702, 1704, and 1706 are illustrated. Application data 1706 is communicated between applications 1702, 1704, and 1706 and an application message handler 1714. Application message handler 1714 communicates with MAC layer 216, possible as shown in FIGS. 2A, 3A, and 6 through a transport layer 212 and network layer 214. Application layer 210 may also include core services 1708, a portion of memory 134 that is dedicated to application layer 210, and a universal data base 1712.

As discussed above, application layer 210 provides a framework and services for user applications to employ. Application layer 210 is responsible for the following tasks: Defining resident resources and providing core services to access and manage resources; and Routing of application data to/from MAC layer 218 to resident applications 1702, 1704, and 1706.

The Application Data Packet consists of a MAC Data Frame with a MAC Header and MAC Payload. An Application Data Packet 700, as illustrated in FIG. 7E, includes Application Header 720 and Application Payload 722 embedded within the MAC Payload 710, optionally utilized an LLC layer 120 that results in network header 712 and transport header 716. This structure is further illustrated below in Table 16.

TABLE 16

| MAC Header 708 | ← MAC Payload 710 → | | | | |
|---|---|---|---|---|---|
| MAC Data Frame | LLC | 6LowPAN | UDP/TC | ← Application Data → | |
| type | (opt.) | or IPv4 | P Header | Application | Application |
| (refer to | | Header | (optional) | Header 720 | Payload 722 |
| Table 13) | | (optional) | | | |

TABLE 17

| Application ID | Options | Payload Length | Payload 722 |
|---|---|---|---|
| 1 byte | 1 byte | 1 byte | 0-TBD |

An Application Header 720 includes the fields shown in Table 17. As illustrated in Table 17, Application header 720 includes an Application ID, Options, and a Payload Length field. The Application ID field presents a unique identifier for a specific application. Table 18 provides an example set of applications IDs that can be utilized. These applications IDs are consistent with the ISO 18000-7 standard.

TABLE 18

| Application ID | Standards |
|---|---|
| 0x40 | 18000-7 version 1 |
| 0x80 | 18185 eSeal standard |
| 0xC0 | 17363 Shipment Tags |

In order to support any of the applications listed in Table 17, a separation of the application layer 210 from the MAC layer 216 and PHY layer 218 is accomplished according to embodiments of the present invention. In some embodiments, Application Layer 210 relies on IEEE802.15.4 MAC functionality. The network is created on the MAC layer 216. Once the network is created, the application layer 210 on infrastructure gateway 130 and end devices 110 can exchange application layer commands to perform functions.

The IEEE802.15.4 standard defines the methods for creating Beacon enabled and Beaconless wireless network environments 100. This process may include association procedure of wireless devices 110 as well as synchronization procedures. Depending on a specific use case, wireless devices 110 create a network with a coordinator 180 and then exchange application layer messages. Application layer messages are carried in the payload of MAC Data frames 700. Application layer 210 will configure the MAC layer 216 and PHY layer 218 depending on the application use case.

In order to support ISO18000-7 functionality, application layer 210 is separated from the MAC layer 216 and PHY layer 218. The commands without dependencies on the MAC layer 216 and the PHY layer 218 remain unchanged. However, some commands and procedures that depend on the MAC/PHY functionality are provided. The fields of the original ISO 18000-7 packets are mapped as follows: ISO18000-7 Protocol ID is mapped into the Application ID field of the Application header and ISO18000-7 Command Code and Command Arguments are mapped into the application Payload. Application header and payload fields for legacy ISO18000-7 type of application are defined in the Table 19.

TABLE 19

| | |
|---|---|
| Application Header 720 | Application Payload 722 |

| Application | | Payload | Command | Command |
|---|---|---|---|---|
| ID | Options | Length | Code | Arguments |
| 0x40 | 1 byte | 1 byte | 1 byte | N bytes |

As illustrated in Table 19, the Protocol ID is mapped into the Application ID field of the Application header 720. The protocol ID field value 0x40 is used as the Application ID value for support of legacy ISO18000-7 applications. The payload length field is used to indicate the full length of the application payload 722 in bytes, including all Command Code and Command Arguments parameters. The Command codes and their function as a Read and/or Write command shall be as listed in Table 6 above. Codes not identified are reserved.

In Table 6, the Command Type column indicates whether the command is broadcast or point-to-point. Once the payload is passed down the protocol stack, the MAC layer 216 will initialize addresses and frame control bits accordingly. For commands requiring a Sub Command Code, the Sub Command Code field is the first byte of the Command Arguments field that follows the Command Code.

Some commands require arguments. For those commands where arguments are defined, argument data can be supplied with the command. The contents and length of any arguments are specific to each command.

The tag-to-interrogator message can use one of two formats depending on the type of message being transmitted to the Interrogator 130. The device 110 shall always respond to a command using one of the response formats described below except in the following situations, for which the device 110 does not respond: the command is explicitly specified as requiring no response; receipt of a broadcast command containing an invalid command code or other error; or the tag is in the asleep state. There are two possible response formats: the Broadcast response message format and the Point-to-Point response message format.

TABLE 20

| Application | Tag | Payload | Command | |
|---|---|---|---|---|
| ID | Status | Length | Code | Data |
| 0x40 | 2 bytes | 1 byte | 1 byte | N bytes |

The application payload format shown in Table 20 can be used in response to Interrogator broadcast commands from interrogator or gateway device 130 received by tags 110 within the Interrogator's communication range. Broadcast commands are identified in Table 6.

The Tag Status Indicates various conditions such as response format, tag type, alarm and hardware fault. The Payload Length field can be used to indicate the full length of the application payload in bytes, including all Command Code and Command Arguments parameters. The Command Code is the command code (see Table 6) received from the Interrogator. The Data field is returned by tag 110 as a response to an Interrogator 130's valid broadcast command request. The value of N, the length of the data in bytes, is specific to the command. In the event that the tag 110 receives an invalid command, no response is sent to the interrogator 130.

TABLE 21

| Application | Tag | Payload | Command | Response |
|---|---|---|---|---|
| ID | Status | Length | code | Data |
| 0x40 | 2 bytes | 1 byte | 1 byte | N bytes |

The Point-to-point response application payload format is illustrated in Table 21. The application payload format shown in Table 21 can be returned to Interrogator 130 as a response to all point-to-point commands. Such point-to-point commands utilize the Tag Manufacturer and Serial Number in order to access a particular tag 110. (Point-to-point commands are identified in Table 6).

The response data field may not be utilized in all commands. The Tag Status field indicates various conditions such as response format, tag type, alarm and hardware fault. The Packet Length field indicates the message length in bytes from the Protocol ID field up to and including the CRC field. The Command Code is the command code received from the Interrogator. The Response Data is returned by the tag 110 as a response to an Interrogator's valid command request. The value of N, the length of the data in bytes, is specific to the command. In the event an error is detected, a NACK flag within the Tag Status word can be set and the Response Data will contain an error response as described in Error codes subsection.

In response to a point-to-point command a tag 110 may reply with one of the errors listed in Table 22. If multiple errors are detected in a point-to-point command, only the first error is reported. Errors resulting from broadcast commands do not generate responses.

TABLE 22

| Error Code | Description |
|---|---|
| 0x01 | Invalid Command Code |
| 0x02 | Invalid Command Parameter |
| 0x03 | Optional Command not Supported |
| 0x04 | Not Found |
| 0x06 | Can't Create Object |
| 0x08 | Authorization Failure |
| 0x09 | Object is Read-Only |
| 0x0A | Operation Failed |
| 0x3f | Implementation Dependent |
| 0x40 | Stale Token |
| 0x41 | Boundary Exceeded |

Error response data consists of a one-byte error code; possibly a one-byte sub-code, depending on the kind of error; possibly one or more bytes of parameter data, also depending on the error; and an optional, manufacturer-defined number of additional data bytes, as shown in Table 23. In the following error definitions, the optional, manufacturer-defined data bytes are not shown.

TABLE 23

| Error | | Error Parameter | Manufacturer |
|---|---|---|---|
| Code | Sub code | Data | Data |
| 1 byte | 1 byte | N bytes | M bytes |

From Table 23, the Error Code field includes a value from Table 22 identifying the type of error. The Sub-code field is an optional value that further refines the nature of the error and is specific to the kind of error detected. The sub-code field may be absent if the error does not define a Sub-code. Sub-codes are further discussed below. The Error Parameter Data field includes N bytes of data, where N is zero or greater, whose existence, length, and content depend on the nature of the error. This Error Parameter Data field may be absent if the error does not define Error Parameter Data. Error specific Error Parameter Data and length N of this field, if any, is specified in the error description subsections below. The Manufacturer Data field includes M bytes of data, where M is zero or greater, whose existence, field length, and content are at the discretion of the tag manufacturer.

Invalid command code error places the command code 0x01, from Table 22, in the error code field of the error response data shown in Table 23. No subcode field or error parameter data field is included. The invalid command error data can be generated when the tag device 110 receives a packet with a Command Code and/or Sub Command Code that is not defined by the RFID standard, in this example the ISO/IEC 18000 standard. Those command codes are provided in Table 6.

Table 24 illustrates the error data that resulting from an invalid command parameter error. From Table 22, the error code for this error is “0x02.” The sub code field for this error is illustrated in Table 25. The Sub-code field describes the error more specifically. The Parameter offset, which is placed in the error parameter data field illustrated in Table 22, is the offset in bytes from the beginning of the Command Arguments field where the error was detected. The invalid command parameter error can be generated when the tag 110 receives a command with invalid or malformed parameters. If more than one parameter is in error, the first invalid parameter can be reported.

TABLE 24

| | Sub | Parameter |
|---|---|---|
| Error Code | Code | Offset |
| 0x02 | 1 byte | 1 byte |

TABLE 25

| Sub | Sub-Error | |
|---|---|---|
| Code | Name | Meaning |
| 0x01 | Parameter Out | The value of a parameter is not legal |
| | of Range | |
| 0x02 | Too Few | There are fewer bytes in the Command |
| | Parameters | Arguments field than expected |
| 0x03 | Too Many | There are more bytes in the Command |
| | Parameters | Arguments field than expected |

The Optional Command Not Supported error code, as shown in Table 22, is “0x03”. This error data for the Optional Command Not Supported error code does not include any other fields except the error code. This error can be generated when the tag 110 receives an ISO optional command that is not supported on this tag 110.

The Not Found error data is illustrated in Table 26. As shown, the Not Found error data includes the “0x04” error code and a 1 byte subcode. The not found subcodes are illustrated in Table 27. The Not Found error is generated when tag 110 does not find the requested data.

TABLE 26

| Error Code | Sub-Code |
|---|---|
| 0x04 | 1 byte |

TABLE 27

| Sub | Sub-error | |
|---|---|---|
| Code | name | Meaning |
| 0x01 | Table Does | There is no existing table for the table ID given |
| | Not Exist | |
| 0x02 | Record Does | There are fewer records than the record number |
| | Not Exist | given |
| 0x03 | Field Does | There are fewer fields than the field number given |
| | Not Exist | |

The Cannot Create Object error data is illustrated in Table 28. The error code, from Table 22, is “0x06”. The Sub-codes, which describe the error more specifically, are illustrated in Table 29. This error can be generated upon an unsuccessful attempt to create a database table.

TABLE 28

| Error Code | Sub-Code |
|---|---|
| 0x06 | 1 byte |

TABLE 29

| Sub- | Sub-error | |
|---|---|---|
| Code | Name | Meaning |
| 0x02 | Table | The requested table ID is already in use |
| | Already | |
| | Exists | |
| 0x03 | Out of | There is insufficient memory in the tag to create the |
| | Memory | requested table |
| 0x04 | Table ID | The table ID provided is reserved, and not available |
| | Reserved | for assignment to a table. |

The Authorization Failure Error data includes only the Error code, “0x08” as shown in Table 22. This error can be generated upon an invalid attempt to access a tag 110 feature that is protected by a password.

The Object is Read Only Error data includes on the error code “0x09” as shown in Table 1. This error can be generated upon an attempt to modify some tag data entity for which the tag 110 does not allow modifying operations.

The Operation Failed error data is shown in Table 30 and the corresponding sub-codes are shown in Table 31. This error can be generated upon the failure of a valid command to complete properly. This error may be reported if the command failed to complete and no other error has been reported.

TABLE 30

| Error Code | Sub-Code |
|---|---|
| 0x0A | 1 byte |

TABLE 31

| Sub-code | Sub-error Name | Meaning |
|---|---|---|
| 0x01 | Write Failure | The Memory write operation failed. |
| 0x02 | Erase Failure | The Memory erase operation failed. |
| 0x03 | Memory Consistency | Memory corruption has been detected |
| 0x04 | Other Failure | Operation failed for other reason |

The Implementation Dependent Error data can include both the Error Code field and the Sub-Code field. This error code is reserved for tag manufacturers and applications to define for tag behavior errors not covered by this part of ISO/IEC 18000. At a minimum, the tag implementation includes a Sub-code field. Sub-code and any additional fields of the error are left to the tag manufacturer and applications to specify.

The Stale Token error data includes the error code “0x40” in the Error Code field, as is illustrated in Table 22. This error can be generated by the tag 110 when a submitted Request Token is invalid due to an intervening modification that was made to the table for which the Request Token applies. These modifications include invocations of the following commands: Table Add Records, Table Update Records, Table Update Fields, and Table Delete Record.

The Boundary Exceeded error data is shown in Table 32. Table 33 illustrates the sub-codes for the error. This error as shown in Table 32 and sub-code shown in Table 33 can be generated upon an attempt to access a record outside of a valid boundary.

TABLE 32

| Error Code | Sub-Code |
|---|---|
| 0x41 | 1 byte |

TABLE 33

| Sub- | Sub-Code | |
|---|---|---|
| Code | Name | Meaning |
| 0x01 | Table Full | The table has been filled to the create-time allotment |
| 0x02 | Record Does | The record has not been added yet |
| | Not Exist | |
| 0x03 | Fragment | The write operation completed with still more to |
| | Overran | write |
| 0x04 | Field Does | The field does not exist |
| | Not Exist | |

TABLE 34
Bit

| 15 | 14 | 13 | 12 | 11 | 10 | 9 | 8 |
|---|---|---|---|---|---|---|---|
| Mode Field | | | | Alarm | Reserved | Reserved | ACK |
| | | | | | | | 1 = NACK |
| | | | | | | | 0 = ACK |

Bit

| | | | | | | | |
|---|---|---|---|---|---|---|---|
| 7 | 6 | 5 | 4 | 3 | 2 | 1 | 0 |

| | | | | |
|---|---|---|---|---|
| Reserved | Tag Type | Reserved | Reserved | Service |

Referring back to table 20, the tag status field can be included in all tag-to-interrogator messages and can include the bit structure illustrated in Table 34. In some cases, reserved fields can be set to “0”. The Mode field indicates the format (response to Broadcast command or response to Point-to-Point command) of the response data from tag 110. In some cases, a Mode field of “0000” indicates a broadcast command while a Mode field of “0010” indicates a point-to-point command.

The Alarm field is intended as a general status bit indicating a non-command related reportable condition. If set (‘1’), an alarm condition has been detected by the tag 110. The interpretation and actions to retrieve data and clear the alarm bit is defined by the tag vendor.

The Acknowledgment field, when clear (‘0’), indicates that the tag 110 has received a valid command (CRC ok and all fields valid) from the Interrogator 130 and processed the command successfully. If set (‘1’), the command was invalid or the tag 110 encountered an error during the processing of the command. The tag issues no response in the case of a CRC error.

The Tag type field holds a value assigned by, and meaningful only to, the tag manufacturer. The manufacturer can use this value to indicate manufacturer-defined special features.

The Service field, when set (‘1’), indicates that the tag 110 has detected a hardware-related fault condition. Additional information on the hardware fault condition may be retrieved with the Hardware Fault Status UDB element.

In general, a tag 110 responds to multiple tag commands. Some of those commands that are consistent with the Mode-2 standard are illustrated below. In particular, the command codes are provided in Table 6 and the Command code field is illustrated in Table 21 above.

TABLE 35

| | | Max Packet | |
|---|---|---|---|
| Command Code | Windows Size | Length | UDB Type Code |
| 0x1F | 2 bytes | 1 byte | 1 byte |

The Collection with Universal Data Block (UDB) command code and associated data is illustrated in Table 35. The Collection with Universal Data Block command is used to collect Tag Manufacturer ID and Tag Serial Numbers with the contents of a specified UDB data block.

The Window Size field is utilized in ISO 18000-7 Mode 1 operation and is not utilized in the Mode 2 standard. The field indicates the number of 57.3 ms intervals to use for listening for tag responses in the collection algorithm. The field is encoded as an unsigned 16-bit integer, with a valid range of 1 to 512.

The Max Packet Length field holds an integer in the range 20 to 255 inclusive that specifies the maximum value that a tag 110 can use as the Packet Length field of it's response. Tags 110 may select a different reply packet length as long as the length does not exceed the value of Max Packet Length. This parameter may be used to tune performance or to limit RF transmission times for compliance with regional RF regulatory requirements. The value 20, the size of a minimum tag response packet (the length 20 include 15 bytes for response packet overhead, 1 byte for the UDB Type Code value, 2 bytes for the Total UDB Length value and 2 bytes for the Requested Offset value), indicates no bytes of the UDB should be included in the tag response.

TABLE 36

| UDB | | |
|---|---|---|
| Type | Description | UDB Elements included in this UDB type |
| 0x00 | Transit data | Routing Code UDB element (Element Type 0x10), |
| | | User ID UDB element (Element Type 0x11) and |
| | | any Application defined UDB elements. |
| 0x01 | Capability | Optional Command element (Element Type 0x12), |
| | data | Memory Size element (Element Type 0x13) and |
| | | Table Query Size element (Element Type 0x14) |
| | | and any Application defined UDB elements. |
| 0x02 | Query | Table Query Results element (Element Type |
| | results | 0x15) and any Application defined UDB elements. |
| 0x03 | Hardware | Hardware Fault Status element (Element 0x16) |
| | Fault data | and any Application defined UDB elements. |

The UDB Type Code field identifies the requested UDB type. The UDB types codes are listed in Table 36 and will be discussed further below.

TABLE 37

| Command | UDB Type | Total UDB | | |
|---|---|---|---|---|
| Code | Code | Length | Requested Offset | UDB Data |
| 0x1F | 1 byte | 2 bytes | 2 bytes | N bytes |

The tag 110 selects a random time slot based upon the Window Size and Max Packet Length values received. The tag 110 responds with the Collect with Universal Data Block broadcast response message as shown in Table 37. When this command is received the tag 110 saves all requested UDB data and ensures that no change to the UDB data until all the data has been sent.

The UDB Type Code identifies the requested UDB type. The Total UDB Length is the total length, in bytes, of the UDB data on the tag 110 for the selected UDB Type. The Requested Offset is presumably 0 and the tag 110 shall replies with the value zero for its response to a Collection with UDB command. All Collection with UDB commands will begin at the implied offset of zero and the tag 110 responds with data beginning at the first byte of the requested UDB block and confirm this offset value with the value 0 for the Requested Offset field. The Universal Data Block data is an initial portion of the Universal Data Block requested.

TABLE 38

| UDB Element | | |
|---|---|---|
| Type ID | Length | Data |
| 1 byte | 1 byte | N bytes |
| UDB Element Type ID | N | Data bytes |
| (see Table 39) | (length of Data in bytes) | |

TABLE 39

| UDB Element | | |
|---|---|---|
| Type ID | Description | Note |
| 0x00-0x0A | Reserved | |
| 0x10 | Routing | The routing code as specified within this |
| | Code | document |
| 0x11 | User ID | User ID as specified within this document |
| 0x12 | Optional | A list of command codes for optional |
| | Command | commands supported on this tag |
| | List | |
| 0x13 | Memory | Total and available memory on this tag |
| | Size | |
| 0x14 | Table | The total number of Table Query elements |
| | Query | supported on this tag |
| | Size | |
| 0x15 | Table | Results for the previously executed |
| | Query | Table Query |
| | Results | |
| 0x16 | Hardware | Hardware reset count, Watchdog reset |
| | Fault | count and Hardware Fault bitmap |
| | Status | (including low battery flag) to provide |
| | | additional information when the |
| | | “service” bit is set in the |
| | | tag Status word |
| 0x17-0x7F | Reserved | These elements are reserved for future |
| | | tag data elements |
| 0x80-0xFE | Future | Reserved for future use |
| | extension | |
| 0xFF | Application | Application extensions |
| | Element | |

The Universal Data Block contains zero, one, or more data elements, which are referred to as TLD (Type, Length, Data) Elements. The Data Block is formatted as shown in Table 38. Each TLD element is identified with a UDB Element Type ID as illustrated in Table 39. Non-present or zero length data elements shall not be included in the Universal Data Block. For example, if the length of the User ID is zero, no part of the User ID TLD shall be included in the UDB.

The UDB Element Type ID identifies Data element, UDB Element Type IDs are defined in Table 39. The Length field is the number of bytes in length of the Data element. The Data is the informational content of the TLD, such as a Routing Code or User ID.

TABLE 40

| UDB Element | | |
|---|---|---|
| Type ID | Length | Data |
| 1 byte | 1 byte | N bytes |
| 0x10 | N | Routing code data |

TABLE 41

| UDB Element | | |
|---|---|---|
| Type ID | Length | Data |
| 1 byte | 1 byte | N bytes |
| 0x11 | N | User ID data |

TABLE 42

| UDB Element | | |
|---|---|---|
| Type ID | Length | Data |
| 1 byte | 1 byte | N bytes |
| 0x12 | N | N-1-byte command code values |

TABLE 43

| UDB Element | | | | |
|---|---|---|---|---|
| Type ID | Length | Data | | |
| 1 byte | 1 byte | 12 bytes | | |
| 0x13 | 0x0C | 4 bytes | 4 bytes | 4 bytes |
| | | R/W | Total | Available |
| | | Memory | Table | Table |
| | | | Memory | Memory |

TABLE 44

| UDB Element | | |
|---|---|---|
| Type ID | Length | Data |
| 1 byte | 1 byte | 1 bytes |
| 0x14 | 0x01 | Number of Table Query elements supported |

TABLE 45

| UDB Element | | | | | |
|---|---|---|---|---|---|
| Type ID | Length | Data | | | |
| 1 byte | 1 byte | 7 bytes | | | |
| 0x15 | 0x07 | 1 byte | 2 bytes | 2 bytes | 2 bytes |
| | | Query | Table | Number of | Index of |
| | | Status | ID | Records | First Matched |
| | | | | Matched | Record |

TABLE 46

| Query | |
|---|---|
| Status | |
| Value | Description |
| 0x00 | The Table Query operation was successful. |
| 0x01 | The tag did not execute the query because the tag did |
| | not receive a complete sequence of Table Query packets, |
| | or a command has been received by the tag that has |
| | invalidated any previous query results. |
| 0x02 | The tag received a complete sequence of Table Query |
| | packets but the tag cannot comply and did not execute |
| | the query (e.g. the Table ID is invalid on the tag or |
| | a Sequence ID value greater than the maximum number |
| | supported by the tag). |
| 0x03 | Partial Query Results. The Table Query operation |
| | started but has not completed. The Number of Records |
| | matched and Index of First Matched Record field |
| | represent partial results of the Query. |
| 0x04-0xFF | Reserved. |

TABLE 47

| UDB Element | | | | |
|---|---|---|---|---|
| Type ID | Length | Data | | |
| 1 byte | 1 byte | 3 bytes | | |
| 0x16 | 0x03 | 1 byte | 1 byte | 1 byte |
| | | Lifetime count | Lifetime count | Hardware |
| | | of hardware | of firmware | fault |
| | | resets | resets | bitmap |

TABLE 48

| 7 | 6 | 5 | 4 | 3 | 2 | 1 | 0 |
|---|---|---|---|---|---|---|---|
| re- | re- | Re- | re- | re- | re- | Memory | Low |
| served | served | served | served | served | served | Cor- | Bat- |
| | | | | | | ruption | tery |
| | | | | | | De- | De- |
| | | | | | | tected | tected |

The Routing Code UDB Element (0x10) is illustrated in Table 40. The User ID UDB Element (0x11) is illustrated in Table 41. The Optional Command List Element (0x12) is illustrated in Table 42. The data returned in this TLD element is a list of one-byte command code values for the optional commands that are implemented on this tag 110.

The Memory Size Element (0x13) is illustrated in Table 43. The data returned in this TLD is composed of three 4-byte values: the total number of bytes available for Read/Write Memory commands, the total number of bytes allocated for Table database memory, and the number of bytes currently available in the Table database memory (available memory size does not include overhead and simply reports the number of unused memory bytes).

The Table Query Size Element (0x14) is illustrated in Table 44. The 8-bit unsigned integer value returned in this TLD element represents the number of Table Query elements supported on this tag.

The Table Query Results Element (0x15) is illustrated in Table 45. The data returned in this TLD is available after the successful execution of a Table Query and includes a Query Status value, the Table ID for the queried table, the number of records matched in that table, and the index of the first matching record. The values of the Query Status field is shown in Table 46.

The Hardware Fault Status Element (0x16) is illustrated in Table 47. The data returned in this TLD is composed of three 1-byte values: the lifetime count of hardware resets, the lifetime count of Watchdog (firmware) resets, and the Hardware Fault bitmap. The Hardware Fault Bitmap is defined as shown in Table 48. In Table 48, the Low Battery Detected (bit 0), when set (‘1’), indicates that the tag battery is “low.” The exact meaning of “low” is implementation defined. Further, the Memory Corruption Detected (bit 1), when set (‘1’), indicates that the tag 110 has detected a memory hardware fault condition. Reserved (bits 2-7) can be reserved for future use.

As discussed above, a UDB Type is a predefined collection of UDB Element Types. The Collection with UDB and Read UDB commands include a UDB Type argument that allows an application to select one of the available predefined collections of UDB data. All UDB Types may include additional Application Extension TLD Elements following the required TLD Elements. The values of the UDB Types is shown in Table 36 above.

TABLE 49

| Application | Application | | |
|---|---|---|---|
| Extension | Extension | Application ID | Application TLD |
| Type ID | Length | TLD Element | Elements |
| 1 byte | 1 byte | N bytes | M bytes |
| 0xFF | N + M | TLD containing the | one or more |
| | bytes | Application ID Type and | Application |
| | | Application ID value | defined TLDs |

The Universal Data Block may optionally include one or more UDB Application Extension Blocks each encapsulating one or more TLDs, which are uniquely identified by the included Application ID as illustrated in Table 49. Any individual tag 110 may support the extensions defined by multiple vendors (with appropriate licensing if required).

The Application Extension Type ID is defined in Table 39. This Application Extension ID identifies that all TLDs included within this UDB Application Block are identified by the included Application ID. The Application Extension Length is the full length of UDB Application Extension Block in bytes, including the Application ID TLD, and the combined lengths of the included Application TLD elements. The Application ID TLD Element is formatted as described in Table 38 and consists of an Application ID Type, a one-byte length field and a data field containing the Application ID value for the entity responsible for defining the following Application defined TLD elements.

TABLE 50

| Application ID | |
|---|---|
| TLD Type code | Application ID TLD Values |
| 0x00 | Manufacturer ID—the Application ID is the 16-bit |
| | Tag Manufacturer ID assigned by the Registration |
| | Authority as called out in ISO/IEC 15963. |
| 0x01 | Routing Code—The Application ID is the Tag Data |
| | Routing Code as defined in the ISO 17363 standards. |
| 0x02-0xFF | Reserved |

Application ID Types are defined as in Table 50. The TLD Elements are a series of one or more TLDs each consisting of a Type ID byte defined by the included Application ID, a one-byte length field and a data field. The TLD Type IDs are defined solely by the Application identified, and are not required to be made public. All of the included TLDs are formatted as described in Table 38, except that the Type ID is assigned by the manufacturer rather than this part of ISO/IEC 18000. All of the included TLDs should fit completely within the Application Element Length byte count.

FIG. 18 illustrates an example Universal Data Block of UDB Type 0x00. The example includes a Routing Code element 1802, a User ID element 1804 and an Application extension block 1806 with two application extension elements, elements 1808 and 1810.

Referring to Table 21 and to Table 6, the command code to put a tag 110 to sleep is “0x15”. Upon receiving the Sleep command in the command code field, the tag enters the Sleep state. The tag 110 then does not respond to this command and shall ignore any subsequent commands until the tag is woken again by the Wake Up Signal.

TABLE 51

| Command Code | Tag Manufacturer ID | Tag Serial Number |
|---|---|---|
| 0x16 | 2 bytes | 4 bytes |

The “Sleep All But” command can be utilized to put all except one tag 110 to Sleep. The command, which is written to tag 110, is illustrated in Table 51. The command code is provided in Table 6. The Tag Manufacturer ID field is the Tag Manufacturer ID of the tag 110 which should remain awake following the “Sleep All But” command. The Tag Serial Number is the Tag Serial Number of the tag 110 which should remain awake following the “Sleep All But” command.

The “Sleep All But” command is a broadcast command used to place all tags into the sleep state, as with the Sleep command discussed above, except for the one tag 110 that matches the provided Tag Manufactures ID and Tag Serial Number. Upon receiving this command, all tags 110 except the one tag 110 that matches the provided Tag Manufactures ID and Tag Serial Number shall enter “sleep” state 510. Tags 110 do not respond to this command.

The command codes in Table 6 also provide a number of security commands. As illustrated in FIG. 19, access to tag write commands are guarded by a password protection mechanism that application software can command the tag 110 to engage or disengage. As shown in FIG. 19, tag 110 can be in a tag locked state 1902 or tag unlocked state 1904. If password protection is engaged as in state 1908, those write commands shall be non-accessible unless the tag is unlocked in state 1904; that is, they will not perform their usual operations but rather respond with an Authorization Failure error. If the password protection is disengaged as in state 1906, the commands are accessible—they behave as described in the corresponding sections of this part of ISO/IEC 18000 without the possibility of an Authorization Failure error. Password protection is engaged and disengaged by means of the Set Password Protect Mode command. Password protection is disengaged by default.

While password protection is engaged, application software can command the tag to enter the unlocked state 1904 temporarily. While a tag is unlocked, the password-protected write commands shall be accessible. Any time the tag 110 enters the sleep state 510 (either the tag receives a “Sleep” or “Sleep All But” command or 30 seconds passes since the last well-formed command has been received), the tag 110 returns to the locked state 1902, in which the password-protected commands shall be non-accessible. The Unlock command puts the tag into the unlocked state 1904. There is no command to put a tag into the locked state explicitly. Table 52 lists the commands that are affected by password protection. In Table 52, the Set Password and Set Password Protect Mode behave as though password protection are permanently engaged.

TABLE 52

| Command | | |
|---|---|---|
| Code | Command Name | Description |
| 0x93 | User ID | Sets user assigned ID (1-60 bytes) |
| 0x89 | Routing Code | Writes routing code |
| 0xE0 | Write Memory | Writes user memory |
| 0x95* | Set Password* | Sets tag password (4 bytes long) |
| 0x97* | Set Password | Engages/disengages password protection |
| | Protect Mode* | |
| 0x26 | Table Create | Creates a database table |
| 0x26 | Table Add | Prepares to add new records to the |
| | Records | specified database table |
| 0x26 | Table Update | Prepares to modify the specified |
| | Records | table records |
| 0x26 | Table Update | Prepares to update the specified |
| | Fields | fields of a table record |
| 0x26 | Table Delete | Deletes existing record from the |
| | Record | existing database table |
| 0x26 | Table Write | Writes a block of data into a table |
| | Fragment | as initiated by the Table Add Records, |
| | | Table Update Records, or Table |
| | | Update fields command |
| 0x8E | Delete | Deletes all allocated writeable data |
| | Writeable Data | on a tag, |

TABLE 53

| Command Code | Password |
|---|---|
| 0x95 | 4 bytes |

The password of a tag 110 can be sent, or written to tag 110, with the command illustrated in Table 53. The Password is a four byte binary value, which acts as the password for subsequent security commands. To the Set Password command the tag responds with a point-to-point response message (and no data, unless an error is encountered) with only the command code of “0x95”. This command sets the tag's 110 password. This command requires the tag 110 to be first unlocked with the Unlock command, which is discussed below, before the Set Password command can be accessed. The initial value of the tag's password can be set, for example, to 0xFFFFFFFF. The possible error responses shall be as shown in Table 54.

TABLE 54

| Error | | |
|---|---|---|
| Code | Error Name | Reason |
| 0x02 | Invalid | Password parameter is missing or the |
| | Command | wrong length |
| | Parameter | |
| 0x08 | Authorization | Unlock command not invoked prior to |
| | Failure | invocation of this command |

TABLE 55

| Command Code | Secure |
|---|---|
| 0x97 | 1 byte |

To set a tag's Password Protect Mode the command in Table 55 can be sent (written) to the tag 110. The Secure field is a flag that specifies whether password protection shall be engaged or disengaged. The value 0x01 causes password protection to be engaged, the value 0x00 causes password protection to be disengaged. To the Set Password Protect Mode command the tag responds with a point-to-point response message (and no data, unless an error is encountered) by returning the Command Code 0x97. This command engages or disengages password protection in tag 110. To access this command the tag 110 shall first be unlocked with the Unlock command discussed below, regardless of the state of the tag's password protection. The possible error responses shall be as shown in Table 56.

TABLE 56

| Error | | |
|---|---|---|
| Code | Error Name | Reason |
| 0x02 | Invalid | Secure parameter is missing or the |
| | Command | wrong length |
| | Parameter | |
| 0x08 | Authorization | Unlock command not invoked prior to |
| | Failure | invocation of this command |

TABLE 57

| Command Code | Password |
|---|---|
| 0x96 | 4 bytes |

To unlock a tag 110 the command in Table 57 is sent (written) to the tag 110. The Password is a four-byte binary value that was previously defined as the password via the Set Password command. To the Unlock command the tag 110 responds (write response) with the Command Code 0x96 alone. This command unlocks the tag 110 and transitions the tag 110 from locked state 1902 to unlocked state 1904. If the supplied password matches tag's password, the tag 110 shall permit the execution of all commands ordinarily non-accessible because of password protection. The tag 110 remains in the unlocked state 1904 until it receives the Sleep command, “Sleep All But” command, or a time period (30 seconds) has elapsed since the tag 110 received a command. The possible error responses are illustrated in Table 58.

TABLE 58

| Error Code | Error Name | REason |
|---|---|---|
| 0x02 | Invalid Command | Password parameter is missing |
| | Parameter | or the wrong length |
| 0x08 | Authorization Failure | Incorrect password supplied |

To retrieve a tag's User ID command with command code 0x13 is sent to the tag 110. In response to the User ID read command, the tag 110 respond with a point-to-point response message with command code and data as shown in Table 59. The User ID Length is the length in bytes of the User ID being returned, where N is between 0 and 60 inclusive. The User ID is the contents of the User ID on the tag.

TABLE 59

| Command Code | User ID Length | User ID |
|---|---|---|
| 0x13 | 1 byte | N bytes |

TABLE 60

| Command Code | User ID Length | User ID |
|---|---|---|
| 0x93 | 1 byte | N bytes |

To set a tag's User ID, the command in Table 60 can be sent to the tag 110. The User ID Length is the length, N, in bytes, of the User ID, where N is between 0 and 60 inclusive. The User ID is the contents of the User ID. In response to the User ID write command illustrated in Table 60, the tag 110 can respond with a point-to-point response message that includes the command code with 0x93 (and no data, unless an error is encountered).

The User ID is a user-readable and writeable memory whose meaning and size (up to 60 bytes) is user defined. The User ID format and content follows the requirements of unique identifiers as defined in ISO/IEC 15459-1. Moreover, organizations wishing to allocate unique userids do so according to the rules defined by the accredited issuing agency. Issuing Agencies apply to the Registration Authority for registration according to 15459-2: NEN—Nederlands Normalisatie-instituut—Registration Authority of ISO/IEC 15459; Postbus 5059; 2600 GB Delft; THE NETHERLANDS; Fax: +31 15 26 90 242; E-mail: RA-ISO15459@nen.nl.

The User ID command sets and gets the size and contents of the User ID. In addition to this command, the Collection with UDB and Read Universal Data Block commands also retrieve the User ID, except that when the User ID Length parameter is set to zero, the UDB message will not contain the User ID. The default length of the User ID is zero. The possible error responses to this command are shown in Table 61.

TABLE 61

| Error | | |
|---|---|---|
| Code | Error Name | Reason |
| 0x02 | Invalid | The length of the User ID parameter does not agree |
| | Command | with the User ID Length parameter, or the wrong |
| | Parameter | number of parameter bytes was given, or the User |
| | | ID Length parameter is greater than the maximum, |
| | | 60 |
| 0x08 | Authoriza- | Write command was attempted with password |
| | tion | protection engaged and tag in the locked state |
| | Failure | |
| 0x0A | Operation | Tag data corrupted, or internal failure on write |
| | Failed | of User ID on tag |

TABLE 62

| | Routing Code | |
|---|---|---|
| Command Code | Length | Routing Code |
| 0x09 | 1 byte | N bytes |

To retrieve a tag's Routing Code the command code 0x09 is sent to the tag 110, without further data. In response to the Routing Code read command, the tag 110 responds with a point-to-point response message with command code and data as shown in Table 60. The Routing Code Length is the length in bytes of the Routing Code being returned, where N is between 0 bytes and 50 bytes inclusive. The Routing Code is the contents of the Routing Code on the tag.

TABLE 63

| | Routing Code | |
|---|---|---|
| Command Code | Length | Routing Code |
| 0x89 | 1 byte | N bytes |

To set a tag 110's Routing Code the command in Table 63 can be sent to the tag 110. The Routing Code Length is the length, N, in bytes, of the Routing Code, where N is between 0 and 50 inclusive. The Routing Code is the data to be written to Routing Code on the tag 110. In response to the Routing Code write command, the tag 110 responds with a point-to-point response message with the command code 0x89 (and no data, unless an error is encountered).

TABLE 64

| Error | | |
|---|---|---|
| Code | Error Name | Reason |
| 0x02 | Invalid | Routing Code Length parameter is greater than 50 |
| | Command | (maximum length permitted), or the length of the |
| | Parameter | Routing Code parameter does not agree with the |
| | | Routing Code Length parameter, or the wrong |
| | | number of parameter bytes was given |
| 0x08 | Authoriza- | Write command was attempted with password |
| | tion | protection engaged and tag in the locked state |
| | Failure | |
| 0x0A | Operation | Tag data corrupted, or internal failure on write |
| | Failed | of User ID on tag |

The Routing Code is a user-readable and writable memory whose purpose and size (up to 50 bytes) is user defined. The Routing Code should be used as defined in the ISO 17363 standard. Note that the Routing Code is part of the tag 110's response to the Collection with UDB and Read Universal Data Block commands, except that when the Routing Code Length parameter is set to zero, the UDB message will not contain the Routing Code. The default length of the Routing Code is zero. The possible error responses to this command are shown in Table 64.

The following two commands enable the tag manufacturer to provide manufacturer-defined, immutable information about a tag. To retrieve a tag's Firmware Version the command code 0x0C is sent to the tag 110. In response to the Firmware version command, the tag 110 responds with a point-to-point response message with the command code and data as shown in Table 65. The Firmware Version is the tag firmware version from the tag 110, a manufacturer defined immutable value.

TABLE 65

| Command Code | Firmware Version |
|---|---|
| 0x0C | 4 bytes |

TABLE 66

| Command Code | Model Number |
|---|---|
| 0x0E | 2 bytes |

To retrieve a tag's Model Number, the command 0x0E is sent to tag 110. In response to the Model Number command, tag 110 responds with a point-to-point response message with command code and data as shown in Table 66. The Model number is the tag model number from the tag 110, a manufacturer defined immutable value.

A tag 110 may provide one or more bytes of user-readable and writable random-access memory in which the user can store and retrieve user-defined data. This memory is independent of all other data storage concepts (such as User ID and tables) defined in ISO/IEC 18000. Associated with every byte of memory is an unsigned integer address, through which that memory byte can be accessed. For B bytes of memory the addresses 0 through B−1 access the full range of memory.

To write memory of a tag 110, the command illustrated in Table 67 is sent (written) to the tag 110. The Number of Bytes, N, is the number of bytes to write and is typically in the range of 1 to 237 inclusive. The number of bytes of data in a Write Memory command message is typically no greater than 255−18=237 (18 is the combined length of the command packet header, the number of bytes field, the start address field and the CRC bytes). The Start Address is the memory address of the first memory byte to write, in the range 0 to the manufacturer-defined maximum address. The Data is the memory contents to write.

TABLE 67

| Command Code | Number of Bytes | Start Address | Data |
|---|---|---|---|
| 0xE0 | 1 byte | 3 bytes | N bytes |

In response to the Write Memory command, the tag 110 responds with a point-to-point response message with the command code 0xE0, but with no data unless an error is encountered. The Write Memory command stores the given data into the user random-access memory for later retrieval with the Read Memory command. The possible error responses are illustrated in Table 68.

TABLE 68

| Error | | |
|---|---|---|
| Code | Error Name | Reason |
| 0x02 | Invalid | length of the Data parameter does not agree with |
| | Command | the Number of Bytes parameter, or the wrong |
| | Parameter | number of parameter bytes was given, or the |
| | | Number of Bytes parameter is outside its legal |
| | | range, or the Start Address plus Number of Bytes |
| | | extends beyond the maximum address |
| 0x08 | Authoriza- | Write command was attempted with password |
| | tion | protection engaged and tag in the locked state |
| | Failure | |
| 0x0A | Operation | Tag data corrupted, or internal failure on write |
| | Failed | of memory on tag |

TABLE 69

| Command Code | Number of Bytes to Read | Start Address |
|---|---|---|
| 0x60 | 1 byte | 3 bytes |

To read memory the command in Table 69 is sent to the tag 110. The Number of Bytes to Read field is the number of bytes to read from tag 110, which typically in the range 1 to 239 inclusive. The number of bytes of data in a Read Memory command message should be no greater than 255−16=239 (16 is the combined length of the response packet header, the number of bytes field and the CRC bytes). The Start Address is the memory address of the first memory byte to read. This address is typically in the range 0 to the manufacturer-defined maximum address.

In response to the Read Memory command, the tag 110 responds with a point-to-point response message with command code, parameter, and data as shown in Table 70. The Number of Bytes Actually Read, N, is the number of bytes of data returned in the response, which should agree with Number of Bytes to Read. The Data is the memory contents read from the memory of tag 110. The Read Memory command retrieves from the user random-access memory the requested data previously written with the Write Memory command of the previous section. The possible error responses are shown in Table 71.

TABLE 70

| Command code | Number of Bytes Actually Read | Data |
|---|---|---|
| 0x60 | 1 byte | N bytes |

TABLE 71

| Error | | |
|---|---|---|
| code | Error Name | Reason |
| 0x02 | Invalid | The wrong number of parameter bytes was given, |
| | Command | or the Number of Bytes to Read parameter is |
| | Parameter | outside its valid range, or the Start Address |
| | | plus Number of Bytes to Read extends beyond |
| | | the maximum address |
| 0x0A | Operation | Tag data corrupted, or internal failure on read |
| | Failed | of memory on tag |

To delete all allocated writeable data on a tag 110, the Delete Data command code 0x8E can be sent to tag 110. Data that is permanent on the tag 110 and that is marked non-writeable is left untouched. In response to the Delete Writeable Data command, the tag 110 responds with a point-to-point response message with command code 0x8E. No data is exchanged unless an error is encountered. Those errors are illustrated in Table 72.

TABLE 72

| Error | | |
|---|---|---|
| Code | Error Name | Reason |
| 0x08 | Authorization | Command was attempted with password protec- |
| | Failure | tion engaged and tag in the locked state |
| 0x0A | Operation | Internal failure on deleting data on tag |
| | Failed | |

The Delete Data command restores all user-writeable memory to factory defaults. In particular, the following operations can be performed: The length of the User ID is reset to zero; The length of the Routing Code is reset to zero; All user database tables are deleted; The password shall be reset to 0xFFFFFFFF (initial value); Password Protect Mode is reset to disabled mode; Any existing database table tokens are invalidated; and The Table Query Results table (Table 0x0000) shall be cleared. The possible error responses are illustrated in Table 72.

TABLE 73

| Command | UDB Type | | |
|---|---|---|---|
| Code | Code | Offset into UDB | Max Packet Length |
| 0x70 | 1 byte | 2 byte | 1 byte |

TABLE 74

| Command | UDB Type | Total UDB | Requested | |
|---|---|---|---|---|
| Code | Code | Length | Offset | UDB |
| 0x70 | 1 byte | 2 bytes | 2 bytes | N bytes |

TABLE 75

| Error | | |
|---|---|---|
| Code | Error Name | Reason |
| 0x02 | Invalid | The Offset into UDB parameter is greater than |
| | Command | the total length of the specified UDB, or Max |
| | Parameter | Packet Length is less than 21, or the wrong |
| | | number of parameters bytes was given. |

The Read Universal Data Block command can be used to read the Universal Data Block (UDB). The UDB can become large enough to require multiple Read Universal Data Block commands to retrieve the entire UDB. The Offset into the UDB field allows an interrogator to retrieve a specific portion of the complete Universal Data Block. To read the Universal Data Block the Read UDB command in Table 73 can be sent to tag 110. The UDB Type Code identifies the requested UDB type. The Offset into UDB field is used by interrogator 130 to identify a starting offset into the specified UDB in tag 110. In order to retrieve longer Universal Data Blocks, the interrogator will use multiple Read UDB commands and advance the offset value appropriately after each successfully received tag response. The Max Packet Length field is an integer in the range 21 to 255 inclusive that specifies the maximum value that a tag 110 can use as the Packet Length field in its response. The value 21 includes the 15 bytes of response packet wrapper, one byte of UDB Type Code, two bytes of Total UDB Length value, 2 bytes for the Requested Offset value and at least one byte of UDB data.

In response to the Read Universal Data Block command, the tag 110 responds with a point-to-point response message with command code, parameters, and data as shown in Table 74. The UDB Type Code identifies the requested UDB type. The Total UDB Length is the total length, in bytes, of UDB data on tag 110 for the selected UDB Type. The Requested Offset is the value provided in the Interrogator 130's command message. The Universal Data Block is a portion of the Universal Data Block being read.

To read the entire UDB, an Interrogator 130 can begin with Offset into UDB set to 0 and Max Packet Length set to the largest acceptable packet size. Tags 110 may select a smaller packet size than the length specified by Maximum Packet Length but may not exceed that value. After successfully receiving the initial portion of the UDB, the Interrogator 130 may continue by advancing the Offset into UDB value to the next unread data byte position and sending a second Read UDB command. The interrogator 130 may continue to read the entire UDB but does not have to read the entire UDB. In addition, Interrogator 130 is not restricted to sending Read UDB commands with any ordered sequence of Offset into UDB values to tag 110. The possible error responses are shown in Table 75.

In accordance with the Mode 2 standard, Database Table commands provide basic database functionality, allowing application software to create one or more tables of varying schemas, perform table updates, and query a table. The Database Table commands provide no mechanism for performing table joins. The schema and maximum number of records of a Database Table is fixed at table creation time.

A table schema consists of a list of field (column) widths, in bytes. Fields are numbered (indexed) sequentially, left to right, starting at 0 for the first field. Every field in a table is untyped; that is, all field value comparisons are performed on a byte-for-byte basis, with equality being established between two fields if all bytes in each field match. One field is considered “less than” a second field if for some byte position p in the two fields, all bytes in the byte range 0 to p−1 are equal in the two fields, and byte p of the first field is less than byte p of the second field. In other words, a straight multi-byte value comparison is performed with the first byte being the most significant and the last byte being the least significant.

Table records (rows) are indexed starting at 0 for the first record. The record number (the record index) does not maintain a fixed relationship with a record. When a record is deleted, any remaining records in the database table are re-numbered and may be different than the record order prior to the Table Delete Record command. Associated with a database table is a table ID, an immutable 2-byte value that is assigned at table creation time which uniquely identifies a table among all other tables in the tag. The database tables can be divided into the following types by Table ID, as shown in Table 76.

TABLE 76

| Table ID Range | Table Type |
|---|---|
| 0x0000-0x7FFF | ISO defined |
| 0x8000-0xBFFF | Solution |
| 0xC000-0xFFFF | Manufacturer/Vendor |

Table IDs in the “ISO Defined” range are reserved for future inclusion in this part of ISO/IEC 18000. Table ID 0x0000 is reserved for the Query Results table. Table IDs in the “Solution” range are reserved for special features, functions and enhancements. In this region, the database tables are read and written with standard database commands, but the tables may have special functions and can have side effects. Table IDs within the Solution range must have published interfaces, and Table ID numbers shall be defined and assigned by the entity that owns the routing code. Table IDs in the “Manufacturer/Vendor” range are reserved for vendor proprietary extensions, features and enhancements. In this region, the database tables are read and written with standard database commands, but the tables my have special functionality and can have side effects. Table IDs within the Manufacturer/Vendor range are available for use solely at the vendor's discretion, with no requirements to make public the purpose or use of the interfaces within this Table ID space. Data collected from a “Collect with UDB” command contains data from both the Manufacturers Data Block (MDB) and the Universal Data Block (UDB). The MDB data shall be stored in database tables within the range of the Manufacturer/Vendor Table ID space.

Certain table read and write commands produce a data element called a “token”. Tokens provide a way for tag 110 implementation to abstract sequential data access to data sets larger than may be passed in a single message, and do some amount of error detection and recovery. The write commands (Table Add Records, Table Update Records, and Table Update Fields) declare a start location in logical terms (table ID, record #, field #) and a count. The read command, Table Get Data, declares only a start location. Upon receipt of one of these commands tag 110 generates a token value and returns it to interrogator 130. Subsequently, the token is passed in a Table Read Fragment or Table Write Fragment command from interrogator 130, back to the same tag 110, along with any necessary data (subject to context-dependent size restrictions). The tag 110 then performs the read or write, also subject to context-dependent size restrictions, and generates a new token value. The new token is passed back to interrogator 130 for use in next Table Read Fragment or Table Write Fragment command.

The value of the token is completely at the discretion of tag 110 implementer, except for the following requirements. First, while interrogator 130 is issuing a series of Table Read Fragment or Table Write Fragment commands, by inspecting the token value the tag 110 is able to differentiate the next command in the series from the most recently received command in that series. For example, if an interrogator 130 sends tag 110 a command to read or write a fragment of data, receives no response from tag 110, and then sends the same command again with the intention of reading or writing the same fragment, tag 110 shall identify it as a retry attempt (by means of the token).

Second, in response to the last command of the series, as determined by the limits imposed by the Table Add Records, Table Update Records, Table Update Fields, or Table Get Data command that preceded the series, tag 110 returns a single-byte token whose value is specifically 0x00. That special value informs interrogator 130 that tag 110 considers the series to be complete.

A tag 110 supports the existence of multiple, independent “read tokens,” and may support the existence of multiple, independent write tokens. A tag 110 usually supports a minimum of two independent read tokens. A “read token” is a token generated by an invocation of the Table Get Data command and used subsequently in invocations of the Table Read Fragment command. A “write token” is a token generated by an invocation of one of the table write commands and used subsequently in invocations of the Table Write Fragment command. The table write commands are Table Add Records, Table Update Records, and Table Update Record Fields. Supporting multiple, independent read tokens means that an invocation of Table Get Data or Table Read Fragment using one token does not affect the operation of those commands using another token, even if the two tokens are associated with the same table. Supporting multiple, independent write tokens means that an invocation of a Table Write command (Table Add Records, Table Update Records, and Table Update Fields) with one token shall not affect the operation of any other Table Write command with another token, provided that the two tokens are associated with different tables. However, invoking a table write command on a table will invalidate all read and write tokens associated with that table.

The high-order 4 bits of the first byte of the token indicates the length of the token, not including the first byte, so zero indicates a token length of 1 byte (see Table Write Fragment). The Token value of exactly 0x00 is reserved, and indicates an end-of-iteration condition. The structure of a Token field is shown below in Table 77.

TABLE 77

| N Token Length | Token Data |
|---|---|
| N value in bits 7-4 | 4 low order bits of Token Length byte, then N |
| [Value of N = 0-15] | bytes |

Table commands are categorized as being either a read command or a write command. The read commands include Table Get Data, Table Get Properties, Table Query, and Table Read Fragment, while the table write commands include Table Create, Table Add Records, Table Update Records, Table Update Fields, Table Delete Record, and Table Write Fragment. For all table write commands, the application rewrites the data on tag 110 for any error occurs during the table write command operation.

For the commands Table Add Records, Table Delete Records, Table Read Fragment, and Table Write Fragment special error handling is necessary if the interrogator does not receive the response from a successful completion of the command and, therefore, must do a retry of the command. A retry of the command shall be shall an identical copy of the initial invoked command packet, explicitly using the same Session ID, Command Code, Sub Command Code, Sequence ID or Request Token, Table ID (if used), and Data (if used) as the original. Tag 110 determines if a command request is a retry of the previously successful database command by comparing it to the previously received command packet. If tag 110 identifies a request to be a retry of the previous executed and successful database command then the tag 110 resends the same response from the previous successful command. Refer to command descriptions for Table Add Records, Table Delete Records, Table Read Fragment, and Table Write Fragment for additional details. Note that other database commands also may incur retry requests and retries should be supported.

TABLE 78

| | | | Maximum | | Length |
|---|---|---|---|---|---|
| Command | Sub-Command | | Number of | Number of | of Each |
| Code | Code | Table ID | Records | Fields | Field |
| 0x26 | 0x01 | 2 bytes | 2 bytes | 1 byte | N bytes |

TABLE 79

| Error | | |
|---|---|---|
| Code | Error Name | Reason |
| 0x02 | Invalid | A parameter is missing, or the Number of Fields |
| | Command | parameter is outside its valid range, or the |
| | Parameter | length of the Length of Field array does not |
| | | match Number of Fields, or one or more of the |
| | | Length of Field elements is zero, or the wrong |
| | | number of parameter bytes was given. |
| 0x06 | Can't | The Table ID is already assigned to an existing |
| | Create | table and this is not a retry command, or the |
| | Object | tag does not have sufficient memory, or the Table |
| | | ID is 0x0000. The following sub-codes define |
| | | the kind of error: |
| | | 0x02 Object already exists |
| | | 0x03 Out of Memory |
| | | 0x04 Reserved |
| 0x08 | Authoriza- | Command was attempted with password protection |
| | tion | engaged and tag in the locked state |
| | Failure | |
| 0x0A | Operation | Database is corrupted, or unable to create table |
| | Failed | regardless of valid command parameters or |
| | | available memory |

A table can be created by invoking the Table Create command. When invoking Table Create, the command illustrated in Table 78 can be sent to tag 110. The sub-command 0x01 indicates creation of the table. The Table ID field indicates the identifier to be assigned to the table. Valid ID range is 0x0001 to 0xFFFF. The Table ID 0x0000 is reserved for the Query Results Table. The Maximum Number of Records indicates how many records may ultimately exist in the table in total. The Valid range for the Maximum Number of Records is from 0x0001 to 0xFFFF. The remaining amount of unallocated table memory on tag 110 may additionally limit the valid range. The Number of Fields is the number of the fields, N, per record. The valid range for the Number of Fields is 1 to 32 The Length of Each Field is a byte array of length N bytes. Each one-byte element of the byte array indicates the size of a field. The first element of the byte array specifies the length of the first field (index 0), the second element specifies the length of the second field (index 1), and so forth. The length of a field is within the range 1 to 255 inclusive.

In response to the Table Create command, tag 110 responds with a point-to-point response message with the command code 0x26, with no data, unless an error is encountered.

The Create Table command creates a database table with a defined maximum number of records, the record format consisting of a specified number of fields each having a specified length. Initially after creation, the table has no records. The possible error responses are illustrated in Table 79. If tag 110 identifies a request of this command to be a retry of the previous command that was executed successfully tag 110 does not execute the request and instead, resends the same response from the previous successful command.

TABLE 80

| | Sub | | | |
|---|---|---|---|---|
| Command | Command | | | Number of |
| Code | Code | Table ID | Sequence ID | Records |
| 0x26 | 0x02 | 2 bytes | 1 byte | 2 bytes |

TABLE 81

| Command Code | Token |
|---|---|
| 0x26 | N bytes |

TABLE 82

| Error | | |
|---|---|---|
| Code | Error Name | Reason |
| 0x02 | Invalid | Number of Records is zero, or the wrong number |
| | Command | of parameter bytes was given, or the Sequence |
| | Parameter | ID is the same value used with the previous |
| | | same command. |
| 0x04 | Not Found | There is no database table associated with the |
| | | specified table ID |
| 0x08 | Authoriza- | Command was attempted with password protection |
| | tion | engaged and tag in the locked state |
| | Failure | |
| 0x09 | Object is | Table ID is 0x0000, which specifies the read- |
| | Read-Only | only query results table |
| 0x41 | Boundary | The table is too full to accept an additional |
| | Exceeded | Number of Records new records |

When invoking Table Add Records the command illustrated in Table 80 with Sub-Code 0x02 can be sent to tag 110. The Table ID indicates the identifier assigned to the table. The Sequence ID is used to identify unique transactions. For each invocation of this command, the interrogator shall supply a different value for Sequence ID. If the interrogator receives no reply from an invocation of the command (due to a communication error, for example) the interrogator shall retry the Table Add Record command using the same Sequence ID as the unsuccessful attempt. Tag 110 verifies the Sequence ID is different from the value provided with the last successful Table Add Record command, only then is the table record added. The Number of Records indicates the total number of records to add to the table. The Valid range is 1 to the Maximum Number of Records set at the time of table creation minus the number of records previously added to the table.

In response to the Table Add Records command the tag shall respond with a point-to-point response message with command code and data as shown in Table 81. The Token indicates a value used to iteratively write data to the added records. The Token value of exactly 0x00 is reserved, and indicates an end-of-iteration condition. The structure of a Token field is shown above in Table 77.

The Table Add Records command instructs tag 110 to prepare to add the specified number of records to the Table. The record contents are written to the table with a sequence of Table Write Fragment commands. This command invalidates any existing tokens for this Table ID. This command also invalidates any Table Query results present in Table 0x0000. If tag 110 identifies a request of this command to be a retry of the previous command that was executed successfully, tag 110 executes the request and instead resends the same response from the previous successful command. The possible error responses is shown in Table 79.

TABLE 80

| Command | Command | | Starting | Number of |
|---|---|---|---|---|
| Code | Sub-Code | Table ID | Record Number | Records |
| 0x26 | 0x03 | 2 bytes | 2 bytes | 2 bytes |

TABLE 81

| Command Code | Token |
|---|---|
| 0x26 | N bytes |

TABLE 82

| Error | | |
|---|---|---|
| Code | Error Name | Reason |
| 0x02 | Invalid | Number of Records is zero, or the wrong number |
| | Command | of parameter bytes was given |
| | Parameter | |
| 0x04 | Not Found | There is no database table associated with the |
| | | specified table ID |
| 0x08 | Authoriza- | Command was attempted with password protection |
| | tion | engaged and tag in the locked state |
| | Failure | |
| 0x09 | Object is | Table ID is 0x0000, which specifies the read-only |
| | Read-Only | query results table |
| 0x41 | Boundary | Starting Record Number plus Number of Records |
| | Exceeded | extends beyond the total number of records in |
| | | the table |

Records can be updated by sending the Table Update Records the command as illustrated in Table 80 to tag 110. The Command Sub-code is 0x03. The Table ID indicates the identifier assigned to the table. The Starting Record Number indicates the first record to begin updating. Valid range is 0 up to (Number of Records in the Table−1). The Number of Records indicates the total number of records that will be updated. Valid range is 1 up to (Number of Records in the Table−Starting Record Number).

In response to the Table Update Records command tag 110 responds with a point-to-point response message with command code and data as shown in Table 81. The Token indicates a value used to iteratively write data to the updated records. The Token value of exactly 0x00 is reserved, and indicates an end-of-iteration condition. The structure of a Token field is shown in Table 77.

The Table Update Records command instructs tag 110 to prepare to update the specified table records. The new record contents are written to the table with a sequence of Table Write Fragment commands. This command invalidates any existing tokens for this Table ID. This command also invalidates any Table Query results present in Table 0x0000. The possible error responses are illustrated in Table 82.

TABLE 83

| | | | | Starting | |
|---|---|---|---|---|---|
| Command | Command | | Record | Field | Number of |
| code | Sub-Code | Table ID | Number | Number | Fields |
| 0x26 | 0x04 | 2 bytes | 2 bytes | 1 byte | 1 byte |

TABLE 84

| Command Code | Token |
|---|---|
| 0x26 | N bytes |

TABLE 85

| Error | | |
|---|---|---|
| Code | Error Name | Reason |
| 0x02 | Invalid | Number of Fields is zero, or the wrong number |
| | Command | of parameter bytes was given |
| | Parameter | |
| 0x04 | Not Found | There is no database table associated with the |
| | | specified table ID |
| 0x08 | Authoriza- | Command was attempted with password protection |
| | tion | engaged and tag in the locked state |
| | Failure | |
| 0x09 | Object is | Table ID is 0x0000, which specifies the read-only |
| | Read-Only | query results table |
| 0x41 | Boundary | Record Number is greater than or equal to the |
| | Exceeded | total number of records in the table, or Number |
| | | of Fields plus Starting Field Number extends |
| | | beyond the number of fields in the table |

Individual fields can be updated by sending the Table Update Fields command, as illustrated in Table 83. The Table ID indicates the identifier assigned to the table. The Record Number indicates the record to update. Valid range is 0 up to (Number of Records in the Table−1). The Starting Field Number indicates the first field to begin updating. The Valid range for the Starting Field Number is from 0 up to (Number of Fields in the Table−1). The Number of Fields indicates the total number of fields in the specified record that will be updated. The Valid range for the Number of Fields is 1 up to (Number of Fields in the Table−Starting Field Number).

The Table Update Fields command instructs tag 110 to prepare to update the specified fields of a table record. The new field contents are written with a sequence of Table Write Fragment commands. This command can only modify fields within a single record, which is provided as the Record Number. This command invalidates any existing tokens for this Table ID. This command also invalidates any Table Query results present in Table 0x0000.

In response to the Table Update Fields command, tag 110 respond with a point-to-point response message with command code and data as shown in Table 84. The Token indicates a value used to iteratively write data to the updated records. The Token value of exactly 0x00 is reserved, and indicates an end-of-iteration condition. The structure of a Token field is shown in Table 77. The possible error responses are illustrated in Table 85.

TABLE 86

| Command | Command | | Sequence | |
|---|---|---|---|---|
| Code | Sub-Code | Table ID | ID | Record Number |
| 0x26 | 0x05 | 2 bytes | 1 byte | 2 bytes |

TABLE 87

| Error | | |
|---|---|---|
| Code | Error Name | Reason |
| 0x02 | Invalid | The wrong number of parameter bytes was given |
| | Command | or the Sequence ID is the same value used with |
| | Parameter | the previous same command. |
| 0x04 | Not Found | There is no database table associated with the |
| | | specified table ID |
| 0x08 | Authoriza- | Command was attempted with password protection |
| | tion | engaged and tag in the locked state |
| | Failure | |
| 0x09 | Object is | Table ID is 0x0000, which specifies the read-only |
| | Read-Only | query results table |
| 0x0A | Operation | Database is corrupted, or unable to complete |
| | Failed | record removal |
| 0x41 | Boundary | Record Number is greater than or equal to the |
| | Exceeded | total number of records in the table |

A record can be deleted by sending a Table Delete Record command as illustrated in Table 86 to tag 110. The Table ID field indicates the identifier assigned to the table. The Sequence ID is used to identify unique transactions. For each invocation of the delete record command, interrogator 130 supplies a different value for Sequence ID. If interrogator 130 receives no reply from an invocation of the command (due to a communication error, for example) the interrogator 130 retries the Table Delete Record command using the same Sequence ID as the unsuccessful attempt. Tag 110 verifies that the Sequence ID is different from the value provided with the last successful Table Delete Record command, only then is the table record deleted. The Record Number indicates the index number of the record to delete.

In response to the Table Delete Record command, the tag 110 responds with a point-to-point response message with the command code 0x26 and no data, unless an error is encountered. If tag 110 identifies a request of the Delete Record command to be a retry of the previous command that was successfully executed, tag 110 resends the same response.

The delete record command instructs tag 110 to delete a single record from the Table, renumbering the record numbers of the remaining records in such a way as to keep the record numbers contiguous starting with 0x0000 (zero). Following execution of Table Delete Record, the order of the remaining records in the table is undefined, and may be different than the record order prior to the Table Delete Record command. The Delete Record command invalidates any existing tokens for this Table ID. To read or write data to the database, a new table write command (Table Add Records, Table Update Records, Table Update Fields) or table read command (Table Get Data) can be issued. The Delete Record command also invalidates any Table Query results present in Table 0x0000. The possible error responses are illustrated in Table 87.

TABLE 88

| Command | Command | | Starting | Starting Field |
|---|---|---|---|---|
| Code | Sub-Code | Table ID | Record Number | Number |
| 0x26 | 0x06 | 2 bytes | 2 bytes | 1 byte |

TABLE 89

| Command Code | Token |
|---|---|
| 0x26 | N bytes |

TABLE 90

| Error | | |
|---|---|---|
| Code | Error Name | Reason |
| 0x02 | Invalid | The wrong number of parameter bytes was given |
| | Command | |
| | Parameter | |
| 0x04 | Not Found | There is no database table associated with the |
| | | specified table ID, or Table ID is 0x0000 and |
| | | there is no query result, either because no query |
| | | was executed or the query result has been made |
| | | invalid by an intervening table write command on |
| | | the table that was queried or by starting a new |
| | | query. |
| 0x41 | Boundary | Starting Record Number is greater than or equal to |
| | Exceeded | the total number of records in the table, or |
| | | Starting Field Number is greater than or equal to |
| | | the number of fields in the table |

Data can be retrieved from a table by sending a Table Get Data command as illustrated in Table 88 to tag 110. The Table ID indicates the identifier assigned to the table. The Starting Record Number indicates the first record to begin reading. The Starting Field Number indicates the first field to begin reading.

In response to the Table Get Data command, the tag 110 responds with a point-to-point response message with the command code and data as shown in Table 89. The Token indicates a value used to iteratively read record data. The Token value of exactly 0x00 is reserved, and indicates an end-of-iteration condition. The structure of a Token field is shown in Table 77.

The Table Get Data command instructs the tag 110 to prepare to read data from a database table starting with a specified record and field. A sequence of Table Read Fragment commands performs the actual data reading. Unlike the table write commands Table Add Records, Table Update Records, Table Update Fields, and Table Get Data is an open-ended iteration that terminates either at the application software's choosing or when the end of the table is reached. The Table Get Data tokens, and subsequent tokens returned by Table Read Fragment are invalidated by any of the following commands: Delete Writeable Data, Table Add Records, Table Update Records, Table Update Fields, Table Delete Record and Table Write Fragment, which operate on the same Table ID. The possible error responses are illustrated in Table 90.

TABLE 91

| Command | Command | |
|---|---|---|
| Code | Sub-Code | Table ID |
| 0x26 | 0x07 | 2 bytes |

TABLE 92

| Command | | Maximum Number of | |
|---|---|---|---|
| Code | Total Number of Records | Records | Reserved |
| 0x26 | 2 bytes | 2 bytes | 1 bytes |

TABLE 93

| Error | | |
|---|---|---|
| Code | Error Name | Reason |
| 0x02 | Invalid Command | The wrong number of parameter bytes was |
| | Parameter | given |
| 0x04 | Not Found | There is no database table associated with |
| | | the specified table ID |

To retrieve data about specific tables, a Table Get Properties as illustrated in Table 91 can be sent to tag 110. The Table ID indicates the identifier assigned to the table. The Table Get Properties command retrieves information about the specified table. It retrieves the number of used (filled) records in the table and the maximum number of records defined for the table.

In response to the Table Get Properties command, the tag 110 responds as shown in Table 92. The Total Number of Records indicates total number of records in the table. The Maximum Number of Records indicates the maximum number of records specified for the table as specified at table creation by the Table Create command. The Reserved field is a byte reserved for future use and can have the value 0x00. The possible error responses are illustrated in Table 93.

TABLE 94

| Command | Command Sub- | | Requested |
|---|---|---|---|
| Code | Code | Request Token | Read Length |
| 0x26 | 0x08 | N bytes | 1 byte |

TABLE 95

| Command Code | Response Token | Actual Read Length | Data |
|---|---|---|---|
| 0x26 | N bytes | 1 byte | M bytes |

TABLE 96

| Error | | |
|---|---|---|
| Code | Error Name | Reason |
| 0x02 | Invalid | Request Token is malformed (as defined by the tag |
| | Command | implementation), or Requested Read Length is zero, |
| | Parameter | or the wrong number of parameter bytes was given. |
| | | Request Token is malformed (as defined by the tag |
| | | implementation), or Requested Read Length is zero, |
| | | or the wrong number of parameter bytes was given, |
| | | or the Request Token is 0x00 |
| 0x40 | Stale Token | Request Token is properly formed and not 0x00 but |
| | | is invalid due to an intervening modification of |
| | | the table(s) to which the Request Token applies. |
| | | These modifications include invocations of the |
| | | following commands, associated with the Table |
| | | ID supplied to the commands: Table Add Records, |
| | | Table Update Records, Table Update Fields, and |
| | | Table Delete Record. |
| 0x0A | Operation | Read operation failed or database is corrupted |
| | Failed | |

A table read can be accomplished by sending a Table Read Fragment as illustrated in Table 94 to tag 110. The Request Token is the token from the prior Table Get Data or Table Read Fragment command. The Token value of exactly 0x00 is reserved, and indicates an end-of-iteration condition. The structure of a Token field is shown in Table 77. The Requested Read Length is the requested length of data to return. Valid range is from 1 to 46 bytes.

In response to the Table Read Fragment command, the tag 110 responds with a point-to-point response message with command code and data as shown in Table 95. The Response Token is the resulting new token from a successful Table Read Fragment command. The Token value of exactly 0x00 is reserved, and indicates an end-of-iteration condition. The Actual Read Length is the number of bytes of data actually read, and may be less than or equal to Requested Read Length. The Data is the actual data read from the tag database table and is the Actual Read Length bytes long. If tag 110 identifies a request of this command to be a retry of the previous command that was executed successfully, tag 110 resends the same response from the previous successful command.

The Table Read Fragment command reads a block of data bytes from a database table. The database table contents to be read are inherently identified by the Request Token received from the tag via a prior invocation of the Table Get Data command or a previous invocation of this Table Read Fragment command. The Table Read Fragment command cannot read beyond the last record of a table. If the initial byte to be read by the Table Read Fragment command is within the table, but the Requested Read Length would reach beyond the end of the last record in the table, the command may be considered valid, and will return as Actual Read Length not more than the number of bytes remaining to be read in the table. The possible error responses are illustrated in Table 96.

TABLE 97

| Command | Command Sub- | | | |
|---|---|---|---|---|
| Code | Code | Request Token | Data Length | Data |
| 0x26 | 0x09 | N bytes | 1 byte | N bytes |

TABLE 98

| Command Code | Response Token |
|---|---|
| 0x26 | N bytes |

TABLE 99

| Error | | |
|---|---|---|
| Code | Error Name | Reason |
| 0x02 | Invalid | Request Token is malformed (as defined by the tag |
| | Command | implementation), or Data Length is zero, or the |
| | Parameter | length of the Data parameter does not agree with |
| | | Data Length, or the wrong number of parameter |
| | | bytes was given, or the Request Token is 0x00 |
| 0x08 | Authoriza- | Command was attempted with password protection |
| | tion | engaged and tag in the locked state |
| | Failure | |
| 0x0A | Operation | Write operation failed or database is corrupted |
| | Failed | |
| 0x40 | Stale Token | Request Token is properly formed and not 0x00 |
| | | but is invalid due to an intervening |
| | | modification of the table(s) to which the |
| | | Request Token applies. |
| | | These modifications include invocations of the |
| | | following commands, associated with the Table |
| | | ID supplied to the commands: Table Add Records, |
| | | Table Update Records, Table Update Fields, and |
| | | Table Delete Record. |
| 0x41 | Boundary | The Data Length for this request would exceed |
| | Exceeded | the length declared in the original Table Add |
| | | Records, Table Update Records, or Table Update |
| | | Record Fields command |

Fragments of data can be written by sending a Table Write Fragment the command as illustrated in Table 97 to tag 110. The Request Token is the token from the prior Table Add Records, Table Update Records, Table Update Fields, or Table Write Fragment command. The structure of a Token field is shown in Table 77. The Data Length is the length of data to write. The Valid range of the Data Length is from 1 to 46 bytes. The Data is the data bytes to be written to the tag database table.

In response to the Table Write Fragment command, the tag 110 responds with a point-to-point response message with command code and data as shown in Table 98. The Response Token is the resulting new token from a successful Table Write Fragment command. The Token value of exactly 0x00 is reserved, and indicates an end-of-iteration condition. The structure of a Token field is shown in Table 77. The Table Write Fragment command writes a block of data bytes to a database table. The database table contents to write are inherently identified by the Request Token received from the tag 110 via a prior invocation of the Table Add Records, Table Update Records, or Table Update Fields command or a previous invocation of this Table Write Fragment command. If tag 110 identifies a request of this command to be a retry of the previous command that was executed successfully, the tag 110 resends the same response from the previous successful command.

The Table Write Fragment command invalidates any existing tokens for this Table ID. This command also invalidates any Table Query results present in Table ID 0x0000. The possible error responses are illustrated in Table 99.

TABLE 100

| | | | | Query Elements | | | | |
|---|---|---|---|---|---|---|---|---|
| | | | | | Logical Operand | | | |
| | | | | | | | Compar. | |
| Command | Command | Table | Sequence | Logical | Field | Relat. | Data | Compar. |
| Code | Sub-Code | ID | ID | Operations | Numb. | Operat. | Length | Data |
| 0 × 26 | 0 × 10 | 2 | 1 byte | 1 byte | 1 byte | 1 byte | 1 byte | N bytes |
| | | bytes | | | | | | |

A table query can be performed by sending a Table Query command as illustrated in Table 100 to tag 110. The Table Query command can be sent as either a Broadcast message to all tags 110 simultaneously, or as a Point-to-Point message to a single tag 110. The Table ID indicates the identifier assigned to the table. The Sequence ID identifies a query element among a sequence of query elements. For a sequence of N query elements, the Sequence ID is N−1 for the first query element, N−2 for the second query element, and so forth, down to 0 (zero) for the Nth query element. The tag shall support a minimum of 4 query elements per sequence; Sequence IDs from 3 down to 0. The actual number of query elements supported on a tag 110 can be retrieved through the UDB Element Type 0x15 (Table Query Size). The possible error responses are illustrated in Table 101.

TABLE 101

| Error | | |
|---|---|---|
| Code | Error Name | Reason |
| 0x02 | Invalid | Sequence ID is greater than the maximum number |
| | Command | of query operators that the tag supports; or |
| | Parameter | Sequence ID is not the same as, or one less |
| | | than, that of the previous Table Query command |
| | | AND Logical Operator is not CLEAR; |
| | | or Table ID is not the same as that of the |
| | | previous Table Query command AND Logical |
| | | Operator is not CLEAR; |
| | | or Comparison Data Length, Logical Operator |
| | | or Relational Operator are outside their valid |
| | | range of values; or Data Length is zero; or the |
| | | length of Data does not agree with Data Length, |
| | | or the wrong number of parameter bytes was given |
| 0x04 | Not Found | There is no database table associated with the |
| | | specified Table ID |
| 0x41 | Boundary | Field Number greater than or equal to the number |
| | Exceeded | of fields in the table |

The Logical Operator defines the role of the current query element within the complete query. The possible values of the logical operator are the ISO 8859-1 characters ‘C’ (CLEAR), ‘A’ (AND), or ‘O’ (OR). The Field Number indicates index number of the field to match. The Field Number is less than the number of fields in the table.

The Relational Operator defines the method by which the field contents are compared with Data. The possible values of the relation operator are the ISO 8859-1 characters ‘=’ (EQUAL), ‘<’ (LESS THAN), ‘>’ (GREATER THAN), or ‘!’ (NOT EQUAL).

The Comparison Data Length indicates length of the Comparison Data in bytes. The range of Comparison Data Length is 1 to 32. The Comparison Data specifies the byte array to which the field contents are compared. Comparison Data is Comparison Data Length bytes long, and may include the special ISO/IEC 8859-1 prefix ‘*’, the wildcard character.

The Query Element command defines a query element, one table search criterion among a sequence of such criteria. A complete query conceptually has the form {<query element₁>} {<query element₂>} . . . {<query element_{N}>}. Each <query element>, of which there is at least one, has the form <logical operator> <logical operand>. The <logical operand> has the form <field number> <relational operator> <comparison data>. The Logical Operator, Field Number, Relational Operator, and Comparison Data are fields in the Table Query command format shown in Table 100.

The Logical Operator is one of the ISO/IEC 8859-1 characters ‘C’, ‘A’, or ‘O’, Field Number is a table field, Relational Operator is one of the ISO/IEC 8859-1 characters ‘<’, ‘>’, ‘!’, and Comparison Data is a 1 to 32 byte string of data bytes. The angle brackets (<, >) and curly braces ({, }) in the above syntax serve only as delimiters for the purposes of this discussion and have no syntactic meaning or literal presence in an actual command. A complete query, therefore, is specified as a sequence of Table Query commands.

Query elements within a complete query are related to one another by their logical operators, which specify how those query elements are aggregated into a compound Boolean expression. A logical operator can be a logical AND, a logical OR, or the special case CLEAR. Logicals AND and OR are left-associative binary operators of equal precedence which have their conventional Boolean meanings, while CLEAR merely indicates that the query element is the first element of the complete query. If CLEAR is the logical operator for any query element, any prior set of query elements are discarded and the current query element is to be regarded as the first query element of a new query. Upon receipt of a valid Query containing a CLEAR, any pre-existing results from any previous query are removed; all existing records in Table 0x00 are deleted. The relational operands consist of the database table field identified by the Field Number and the Comparison Data.

A complete query can be interpreted as an expression whose constituents are the logical operator and logical operand of each query element, read left to right. For example, suppose a complete query is composed of four query elements and the logical operands of the first, second, third, and fourth query elements are A, B, C, and D, respectively. The complete query (CLEAR A) (AND B) (OR C) (AND D) is to be interpreted as the Boolean expression CLEAR (((A AND B) OR C) AND D), where for each record of the table being searched each logical operand evaluates to “true” or “false” values as described below. The Boolean operators combine those values into a single “true” or “false” value in the conventional manner for Boolean operators, and the CLEAR operator has no impact on the Boolean value of the entire expression. If the entire expression evaluates to “true” the table record is included in the query results table, also described below.

A logical operand specifies how each record of the table to be searched is to be checked for inclusion in the set of matching records. The field number of the logical operand specifies which field of each record is to be inspected. The comparison data specifies the value to which the field contents are to be compared. And the relational operator specifies the manner in which the field contents and comparison data, the two relational operands of the relational operator, are to be compared. Additionally, the first byte of the comparison data affects the nature of the comparison. If that byte is the ISO/IEC 8859-1 character ‘*’, the comparison is a wildcard comparison; otherwise, the comparison is a full-match comparison.

If the relational operator is ‘=’ for a full-match comparison, the relational operands are compared on a byte-for-byte basis for an exact match. If the bytes at some position in both relational operands do not match, the logical operand evaluates to “false.” If one relational operand is longer than the other, the logical operand evaluates to “false.” Otherwise, the logical operand evaluates to “true.” For example, the following comparison evaluates to “true:” “abc” “abc”. The following comparisons evaluate to “false:” “abc” ‘<’ “abc”; “abdb” ‘<’ “abce”; “abc” ‘>’ “abc”; and “abc” ‘!’ “abc”.

If the Relation Operator is ‘!’ for a full-match comparison, the comparison is handled in the same manner as the ‘=’ relation operator but generates the opposite result. Any comparison in which the ‘=’ operator would result in the “true” condition, the ‘!’ operator results in “false,” and any comparison in which the ‘=’ would result in the “false” condition, the ‘!’ operator results in “true.” The following comparisons evaluate to “true”: “abc” ‘!’ “abcd”; “abc” ‘!’ “ABC”; “abc” ‘!’ “abd”; and “abc” ‘!’ “ab”.

The following comparison results in “false”: “abc” ‘!’ “abc”. If the Relational Operator is ‘<’ or ‘>’ for a full-match comparison, the relational operands are compared on a byte-for-byte basis as for the ‘=’ operator until the first non-matching byte is found. If no non-matching byte is found, the logical operand evaluates to “false.” The non-matching bytes are compared according to the relational operator. If the operator is ‘<’ and the byte from the field contents is less than the byte from the comparison data, the logical operand evaluates to “true.” If the operator is ‘>’ and the byte from the field contents is greater than the byte from the comparison data, the logical operand evaluates to “true.” For the inequality operators ‘<’ and ‘>’, if the length of one relational operand is less than that of the other relational operand, then the shorter operand is considered for the purposes of comparison to contain an additional final byte whose value is less than the minimum possible value for a byte.

Note that because the comparison data is limited to 32 bytes, for fields greater than 32 bytes in length, full-match comparisons with the ‘=’ operator always evaluate to “false,” while full-match comparisons with the ‘!’ operator always evaluate to “true.” For example, the following comparisons evaluate to “true”: “abb” ‘<’ “abc”; “aad” ‘<’ “abc”; “ab” ‘<’ “abc”; “abc” ‘<’ “ad”; “abc” ‘>’ “abb”; “abc” ‘>’ “aad”; “abc” ‘>’ “ab”; “ad” ‘>’ “abc”; “abc” ‘!’ “abd”; and “abc” ‘!’ “ab”. The following comparisons evaluate to “false”: “abc” ‘<’ “abc”; “abdb” ‘<’ “abce”; “abc” ‘>’ “abc”; and “abc” ‘!’ “abc”

For wildcard comparisons with the relational operator ‘=’, the field contents starting with the first byte and the comparison data starting with the byte after ‘*’ are compared on a sliding basis for a match as in a full-match comparison until the end of the field contents is reached. That is, starting from the beginning of the field contents and sliding to the right a byte at a time until the end of the field contents, Comparison Data Length bytes of field data are compared against the Comparison Data Length bytes of Comparison Data bytes looking for a complete match. If a complete match is found, the comparison is discontinued. If a complete match was found and the Relational Operator was ‘=’, the comparison evaluates to a “true”, otherwise it evaluates to a “false”. The results for the ‘!’ operator are “false” if the complete match was found, otherwise it evaluates to a “true”. Wildcard comparisons with the relational operators ‘<’ and ‘>’ are illegal, as are wildcard comparisons for which the comparison data is the single character “*”.

In the following examples, the first item is the field number, and the last item is the Comparison Data. The following comparisons evaluate to “true”: “abcde” ‘=’ “*bcd”; “abcbcde” ‘=’ “*bcd”; and “abcecd” ‘!’ “*bcd”. The following comparisons evaluate to “false”: “abcde” ‘!’ “*bcd”; and “abce” ‘=’ “*bcd”.

Upon receipt of the final Table Query command (which has a Sequence ID of zero), the tag 110 should now have the complete Query criteria. The tag 110 executes the complete query on each record in the table identified by Table ID, beginning with Record Number 0 and incrementing through all the records in the table. The Query Results Table (Table ID 0x0000) contains the complete results of the query operation. The Query Results Table has records with a single two-byte field. Each 2-byte field/record in the Query Results table contains the record number of a matching record in the queried table. The matching record numbers, if any, in the Query Results table increase monotonically. Records in Table 0x0000 are returned in response to Table Get Data and Table Read Fragment commands. The record number of each matching record is returned as individual records in MSB first order.

The Table Query command exists as both a point-to-point command and a broadcast command. The value of the Packet Options field, determines whether the command is broadcast or point-to-point. Tag 110 does not respond with any message to any broadcast Table Query command, even in case of error. For non-final point-to-point Table Query commands, which have a non-zero Sequence ID, the tag 110 verifies it received a valid non-final Table Query command. If the command is a valid initial or intermediate Table Query command, tag 110 responds with a point-to-point response message with the command code 0x26 and no data, unless an error is encountered. This response merely indicates that tag 110 successfully received a valid query element, so no database query operation results are available or expected.

TABLE 102

| | Number of Records | Index of First Matched |
|---|---|---|
| Command Code | Matched | Record |
| 0x26 | 2 bytes | 2 bytes |

Upon completion of the point-to-point query command sequence, the tag 110 responds with a point-to-point response message with command code and data as shown in Table 102. If the query resulted in no records matched, the number of records matching the criteria is zero and the index of the first matched record is zero in response to the final point-to-point Table Query command. The Number of Records Matched contains the number of records found in the queried table, which meet the complete query criteria. This Number of Records field can be formatted as an unsigned 16-bit integer. If no matching records were found, The Number of Records field is 0. The Index of First Matched Record contains the record number of the first matching record of the queried table, which meets the complete query criteria. If no records were found, this field is 0. An Interrogator 130 may follow up a sequence of point-to-point Table Query commands by using the Table Get Data and Table Read Fragment commands to retrieve the results from the Query Results Table (Table 0x0000).

The broadcast Collection with UDB command may be used to retrieve the query results from tags 110 after the complete sequence of Table Query commands has been transmitted. To retrieve the query results, an Interrogator 130 may send the Collection with UDB command with the UDB Type field set to 0x02 (see Table 45). Tags will return their Tag serial number with the Table Query Results element (see Table 45). The Table Query Results element includes the index of the queried table, the number of matching records and the index of the first matching record. If the query resulted in no records matched, the number of matching records shall be zero and the index of the first matched record shall be zero. The Interrogator 130 may then follow up successful query matches by retrieving the records in the Query Results Table (Table 0x0000) with Table Get Data and Table Read Fragment commands.

The results of the Table Query command are written to the query results table (reserved Table ID 0x0000). Any database command that modifies any of the database tables on the tag 110 (Table Add Records, Table Update Records, Table Update Fields, Table Delete Record) can force deletion of all records in the query results table. Any subsequent Table Get Properties commands for the query results table shall return 0 as the number of records currently in the table.

TABLE 103

| Command | Beeper |
|---|---|
| Code | On/Off |
| 0xE1 | 1 byte |

TABLE 104

| Error | | |
|---|---|---|
| Code | Error Name | Reason |
| 0x02 | Invalid | Beeper On/Off parameter is missing or the wrong |
| | Command | length or outside its valid range of values |
| | Parameter | |

The Beep ON/OFF command as illustrated in Table 103 can be sent to tag 110. The Beeper On/Off parameter, when 0x01, will turn tag 110's beeper ON or, when set to 0x00, will turn tag 110's beeper OFF. In response to the Beep ON/OFF command, the tag 110 responds with a point-to-point response message with command code 0xE1 and no data, unless an error is encountered. The Beep ON/OFF command turns the tag 110's beeper on or off. When the tag 110's beeper is turned on, the beeper stays on until explicitly turned off or until the tag 110 returns to the Sleep state. The possible error responses are illustrated in Table 104.

The retrieval and transmission of data and control information related to tag-based sensors can be implemented within this part of ISO/IEC 18000. As shown in FIG. 1B, tag 110 can include sensor inputs 120. Sensor status and data can be added to a returned Universal Data Block using an Application extension block. Sensor data logs and control information can be read and written using the existing database table commands.

Manufacturers can record sensor status in the UDB using the UDB Application Extension Block format. Manufacturers can record sensor status in the UDB using the UDB Application Extension Block format. Depending on the application and the complexity of the sensor implementation, the UDB application extension block provides flexibility on how to report sensor status. Specifically, one or many TLD elements can be defined in the UDB according to the TLD element format.

Sensor data and control information can be stored in database tables. Sensor related data can be stored in either the Solution Table ID space or the Manufacturer/vendor Table ID space depending on the application. The following standard commands can be triggered by the interrogator 130 to retrieve sensor status information in the UDB: Collection with UDB (command code 0x1F); and Read UDB (command code 0x70). Sensor activity logs can be retrieved using the following commands: Table Get Data (command code 0x26+0x06 followed by a Table Read Fragment (command code 0x26+0x08); or Table Query (command code 0x26+0x10). Standard response message formats are sent back to the interrogator with the requested information.

The stored data from the sensor should follow the formats described in IEEE 1451 and ISO/IEC 24753. The physical interface between the sensor and the RF tag should be as described in IEEE 1451.7.

The mode-2 standard also specifies the method by which the interrogator 130 identifies and communicate with one or more tags 110 present in the operating field of the interrogator 130 over a common radio frequency channel. Communications specified include methods to: identify a tag, read data from a tag, write data to a tag and command the tag to perform a specific function. Tags 110 do not transmit unless commanded to do so by the interrogator 130, and an interrogator 130 can communicate with tags 110 individually, or with the tag 110 population as a whole.

In the following discussion, the terms “all tags” and “tag population” refer only to tags 110 within the operating field of the interrogator 130. The tag collection process is used to identify tags 110 in the operating field of the interrogator. This is an iterative process that includes methods for coordinating responses from the tag 110 population.

Tag collection procedure in the Type 2 mode of operation differs from Mode 1 since the MAC layer 216 may be IEEE 802.15.4 based. Depending on the MAC mode of operation (beacon or beaconless) the tags 110 will follow MAC rules and create a network of devices with the interrogator 130. Once the network is formed, the application layer 210 on the interrogator 130 can exchange application layer commands such as a Collection with Universal Data Block, a Read Universal Data Block and a Sleep Command with the tags and collect the tag data, as described above.

The collection process may include following steps:
Interrogator 130 transmits the Wake Up Signal to all tags 110 in the operating field of the interrogator;
Tag 110 wakes up into the ready state and listens for commands from the interrogator 130;
Interrogator 130 transmits a Collection with Universal Data Block command to the tags;
Tag 110, if in the ready state, receives and decodes the Collection with Universal Data Block command;
Tag 110 replies with a response packet that includes it's tag identification and the first portion of the requested UDB type;
Interrogator 130, for each tag 110 from which the interrogator 130 received a valid response message, the interrogator 130 may send point-to-point Read Universal Data Block commands to retrieve any remaining UDB from the tag, and then the interrogator 130 sends a point-to-point Sleep command to the tag 110;
Tag 110 responds to any point-to-point Read Universal Data Block commands, which may be received from the interrogator 130;
Tag 110, on receiving a Sleep Command, leaves the ready state and responds to further commands from the interrogator 130 until after the tag 110 receives a Wake Up Signal.

The following section provides a simple example of a multi-packet UDB Collection. Tables 105 through 108 illustrate the interchange with packets 700. An interrogator 130 initiates the process by transmitting a broadcast Collect with UDB command. Tags 110 that receive the Collect command reply with a response packet that includes their tag identification and the first portion of the requested UDB type. The interrogator 130 can then retrieve the remaining UDB data by sending a point-to-point Read UDB command to each tag 110 identified in the first phase.

TABLE 105

| | | | | | Max | UDB |
|---|---|---|---|---|---|---|
| Application | | Payload | Command | Windows | Packet | Type |
| ID | Options # | Length | Code | Size | Length | Code |
| 0 × 40 | 1 byte | 1 byte | 0 × 1F | 2 bytes | 1 byte | 1 |
| | | | | | | byte |

TABLE 106

| | | | | UDB | | | |
|---|---|---|---|---|---|---|---|
| Application | Tag | Payload | Command | Type | Total UDB | Request | Universal Data |
| ID | Status | Length | Code | code | Length | Offset | Block |
| 0 × 40 | 2 bytes | 1 byte | 0 × 70 | 1 byte | 2 bytes | 2 bytes | N bytes |

TABLE 107

| | | | | UDB | Offset | Max |
|---|---|---|---|---|---|---|
| Application | Options | Payload | Command | Type | into | Packet |
| ID | # | Length | Code | Code | UDB | Length |
| 0 × 40 | 1 byte | 1 byte | 0 × 70 | 1 byte | 2 byte | 1 byte |

TABLE 108

| Application | Tag | Payload | Command | UDB | Total UDB | Request | |
|---|---|---|---|---|---|---|---|
| ID | Status | Length | Code | Type code | Length | Offset | UDB |
| 0 × 40 | 2 | 1 byte | 0 × 70 | 1 byte | 2 bytes | 2 bytes | N bytes |
| | bytes | | | | | | |

Table 105 shows the interrogator 130's Collection with UDB command packet. This is a broadcast packet and all tags 110 that receive the packet will participate in the collection process. Table 106 illustrates a tag 110 response packet to the broadcast Collection with UDB command (command code 0x1F). The reply is in the format of a broadcast response packet.

Table 107 shows the interrogator's Read Universal Data Block command directed to a tag 110 identified during the previous collection. The point-to-point command is directed to a specific tag 110 using the tag identification value discovered in the previous collection. Note that the Offset into UDB field will contain a value equal to the number of bytes of UDB data returned in the Tag's collection response (N in Table 107).

Table 108 illustrates tag 110 reply in response to the interrogator 130's Read UDB command. The reply contains the second part of the UDB message using the point-to-point (directed) packet format.

Particular examples of RFID protocol commands has been provided above. Those examples are, in some cases, specific to the ISO 18000-7 mode 2 protocol. The examples provided above are not to be considered limiting, but to provide examples for embodiments of the present invention.

Embodiments of the invention provided in this disclosure are exemplary only and are not intended to be limiting. One skilled in the art will recognize variations of the invention, each of which should be considered to be within the scope of this disclosure. As such, the invention is limited only by the claims.

We claim:

1. An RFID device, comprising:
a transceiver; and
a processor coupled to the transceiver, the processor operating a Physical (PHY) layer with the transceiver, a Media Access Control (MAC) layer over the PHY layer, and an RFID application layer over the MAC layer, the MAC layer and the PHY layer operating according to a non-RFID wireless protocol.

2. The RFID device of claim 1, further including a network layer over the MAC layer and below the RFID application layer.

3. The RFID device of claim 3, further including a transport layer over the network layer and below the RFID application layer.

4. The RFID device of claim 1, wherein
the PHY layer generates and transmits a PHY packet that includes a PHY header and a PHY payload;
the MAC layer generates a MAC packet that includes a MAC header and a MAC payload, the MAC packet being embedded into the PHY payload; and
the RFID application layer generates an RFID packet that is embedded into the MAC payload.

5. The RFID device of claim 4, wherein the RFID application layer generates an RFID header and an RFID payload.

6. The RFID device of claim 5, wherein the RFID header and the RFID payload are consistent with the ISO 18000-7 mode 2 protocol.

7. The RFID device of claim 5, wherein the wireless protocol is consistent with the IEEE 802.15.4 protocol.

8. The RFID device of claim 5, wherein the wireless protocol is consistent with the IEEE 802.11 protocol.

9. The RFID device of claim 1, wherein the PHY header includes a preamble, the preamble including coded information.

10. The RFID device of claim 1, wherein the MAC header, the MAC protocol, the PHY header, and the PHY protocol also operate according to at least some aspects of an RFID MAC/PHY protocol.

11. The RFID device of claim 10, wherein the RFID MAC/PHY protocol includes a wake-up operation.

12. A method of operating an RFID device, comprising:
generating an RFID application packet with an application header and an application payload consistent with an RFID standard;
generating a MAC packet with a MAC header and a MAC payload, the MAC payload including the RFID application packet;
generating a PHY packet with a PHY header and a PHY payload, the PHY payload including the MAC packet;
transmitting the PHY packet.

13. The method claim 12, further including generating a network packet having a network header and a network payload, the network payload embedding the RFID application packet, the network payload being embedded in the MAC payload.

14. The method of claim 13, including generating a transport packet having a transport header and a transport payload, the transport payload embedding the RFID application packet, the transport payload being embedded in the network payload.

15. The method of claim 12, wherein the RFID Application packet is consistent with the ISO 18000-7 mode 2 protocol.

16. The method of claim 12, wherein the MAC packet and the PHY packet are consistent with the IEEE 802.15.4 protocol.

17. The method of claim 12, wherein the MAC packet and the PHY packet are consistent with the IEEE 802.11 protocol.

18. The method of claim 12, wherein the PHY header includes a preamble, the preamble including coded information.

19. The method of claim 12, further including providing an RFID standard MAC and PHY layers.

20. The RFID device of claim 19, wherein the RFID standard MAC and PHY protocol includes a wake-up operation.
